(19) United States
(12) Patent Application Publication
(10) Pub. No.: US 2026/0036858 A1
(43) Pub. Date: Feb. 5, 2026

(54) OPTICAL UNIT AND IMAGE DISPLAY SYSTEM

(71) Applicant: FUJIFILM Corporation, Tokyo (JP)

(72) Inventor: Hiroshi SATO, Minamiashigara-shi (JP)

(73) Assignee: FUJIFILM Corporation, Tokyo (JP)

(21) Appl. No.: 19/352,496

(22) Filed: Oct. 8, 2025

Related U.S. Application Data
(63) Continuation of application No. PCT/JP2024/015304, filed on Apr. 17, 2024.

(30) Foreign Application Priority Data
Apr. 18, 2023 (JP) 2023-067810

(51) Int. Cl. G02F 1/139; G02F 1/1335; G03H 1/00

(52) U.S. Cl. CPC G02F 1/1398; G02F 1/133504; G02F 1/133541; G02F 1/133553; G03H 1/0005; G02F 2203/01; G03H 2001/0088

(57) ABSTRACT

An optical unit that enables observation of an image with reduced brightness unevenness, and an image display system including the unit, are provided. The optical unit includes first and second partial reflection elements that reflect part of incident light and transmit part of it, and a polarization diffraction element including a liquid crystal layer. The liquid crystal layer has an alignment pattern in which an optical axis orientation continuously rotates in one in-plane direction. Regions of the layer have different single period lengths, where a single period is defined as a 180° rotation of the optical axis. The layer also includes regions where the optical axis is twisted in the thickness direction and regions with different total twisted angles.

### CROSS-REFERENCE TO RELATED APPLICATIONS

This application is a Continuation of PCT International Application No. PCT/JP2024/015304 filed on Apr. 17, 2024, which claims priority under 35 U.S.C. § 119(a) to Japanese Patent Application No. 2023-067810 filed on Apr. 18, 2023. The above applications are hereby expressly incorporated by reference, in their entirety, into the present application.

### BACKGROUND OF THE INVENTION

### 1. Field of the Invention

The present invention relates to an optical unit constituting a folded optical system, and an image display system including the optical unit.

### 2. Description of the Related Art

An image display system which is mounted on a user and guides an image to the user's eyes has been put into practical use in order to experience so-called immersive virtual reality (VR) which does not allow external light of the real world.

In the image display system, for example, a half mirror and a reflective polarizer are used for reflecting an optical path of light (image) emitted from an image display device to the user, so that an optical path length is increased and the user recognizes the sense of perspective of the image.

In addition, in the image display system, for example, a half mirror and a reflective polarizer are attached to a lens such as a convex lens, and light is condensed by the lens to widen a field of view (FOV).

A reduction in thickness is desired for such an image display system. However, it is difficult to reduce the thickness of the image display system using the lens.

On the other hand, WO2021/150510A discloses an image display system in which a liquid crystal diffraction element (hologram) is used instead of the lens. FIG. 16 conceptually shows an example thereof.

In an image display system 100 shown in FIG. 16, light emitted from an image display device 102, that is, a displayed image is converted into, for example, dextrorotatory circularly polarized light by a circular polarizer 104 consisting of a linear polarizer and a λ/4 wavelength plate.

Next, the dextrorotatory circularly polarized light is incident into a half mirror 106, and a part of the dextrorotatory circularly polarized light is transmitted through the half mirror 106. Next, the circularly polarized light transmitted through the half mirror 106 is converted into, for example, linearly polarized light in the up-down direction in the drawing by a λ/4 wavelength plate 108.

Next, the linearly polarized light is incident into a reflective polarizer 110. The reflective polarizer 110 reflects linearly polarized light in the up-down direction in the drawing. Therefore, the incident linearly polarized light in the up-down direction in the drawing is reflected by the reflective polarizer 110. That is, the optical path is folded.

The linearly polarized light in the up-down direction in the drawing, which is reflected by the reflective polarizer 110, that is, in which the optical path is folded is incident into the λ/4 wavelength plate 108 again. As described above, the λ/4 wavelength plate 108 converts the dextrorotatory circularly polarized light into linearly polarized light in the up-down direction in the drawing. Therefore, the linearly polarized light in the up-down direction in the drawing, which incident into the λ/4 wavelength plate 108, is converted into dextrorotatory circularly polarized light.

The dextrorotatory circularly polarized light is incident into the half mirror 106 again, and a part of the dextrorotatory circularly polarized light is reflected by the half mirror 106. The dextrorotatory circularly polarized light is converted into levorotatory circularly polarized light by being reflected by the half mirror 106, and is incident into the λ/4 wavelength plate 108 again.

As described above, the λ/4 wavelength plate 108 converts the dextrorotatory circularly polarized light into linearly polarized light in the up-down direction in the drawing. Therefore, the levorotatory circularly polarized light incident on the λ/4 wavelength plate 108 is converted into linearly polarized light in the direction perpendicular to the paper surface.

Next, the linearly polarized light in the direction perpendicular to the paper surface, which is converted by the λ/4 wavelength plate 108, is incident into the reflective polarizer 110. As described above, the reflective polarizer 110 reflects linearly polarized light in the up-down direction in the drawing. Therefore, the linearly polarized light in the direction perpendicular to the incident paper surface transmits the reflective polarizer 110, and is incident into a λ/4 wavelength plate 114.

For example, the λ/4 wavelength plate 114 converts linearly polarized light in the up-down direction in the drawing into levorotatory circularly polarized light. Accordingly, the linearly polarized light in the up-down direction in the drawing, which is incident into the λ/4 wavelength plate 114, is converted into levorotatory circularly polarized light, and is incident into a liquid crystal diffraction element (hologram) 112.

The liquid crystal diffraction element 112 has, for example, a liquid crystal alignment pattern in which an orientation of an optical axis derived from a liquid crystal compound changes while rotating in one in-plane direction in a radial shape, that is, in a concentric circular shape (refer to FIG. 2). In addition, in the liquid crystal alignment pattern, in a case where a length over which the orientation of the optical axis rotates by 180° is set as a single period, the single period gradually decreases from a center toward an outer direction.

Such a liquid crystal diffraction element (liquid crystal diffractive lens) focuses dextrorotatory circularly polarized light or levorotatory circularly polarized light, and diffuses the other. For example, the liquid crystal diffraction element 112 in the example shown in the drawing focuses levorotatory circularly polarized light, and diffuses dextrorotatory circularly polarized light. Therefore, the levorotatory circularly polarized light incident into the liquid crystal diffraction element 112 is focused by the liquid crystal diffraction element 112, and is observed by the user U.

In the image display system 100, the liquid crystal diffraction element 112 focuses light to realize a wide FOV.

### SUMMARY OF THE INVENTION

The liquid crystal diffraction element 112 is a sheet-like member.

Therefore, the image display system 100 which realizes a wide FOV by focusing light using the liquid crystal diffraction element 112 can achieve reduction in thickness of the system, as compared with an image display system including a folded optical system in the related art, using a convex lens or the like.

Here, as conceptually shown in FIG. 16, in the image display system 100, a deflection angle of the liquid crystal diffraction element 112 increases from the center toward the periphery. In order to realize the wide FOV, it is necessary to increase the deflection angle of light in the peripheral portion.

Therefore, in the image display system 100 in the related art, using the liquid crystal diffraction element 112, diffraction efficiency of the liquid crystal diffraction element 112 is low in the vicinity of the end part. As a result, in the image display system 100 in the related art, using the liquid crystal diffraction element 112, brightness unevenness occurs in the image to be observed in the center and in the vicinity of the end part.

An object of the present invention is to solve the above-described problems of the related art, and to provide an optical unit having less brightness unevenness of an image to be observed in a case of being used in an image display system, and an image display system using the optical unit.

In order to achieve the above-described object, the present invention has the following configurations.
[1] An optical unit comprising, in the following order:
a first partial reflection element;
a second partial reflection element; and
a polarization diffraction element,
in which the first partial reflection element and the second partial reflection element reflect a part of incidence light and allow transmission of a part of the incidence light,
the polarization diffraction element includes a liquid crystal layer formed of a liquid crystal composition containing a liquid crystal compound, and the liquid crystal layer has a liquid crystal alignment pattern in which an orientation of an optical axis derived from the liquid crystal compound changes while continuously rotating in at least one in-plane direction,
in the liquid crystal alignment pattern, in a case where a length over which the orientation of the optical axis derived from the liquid crystal compound rotates by 180° in a plane is set as a single period, the liquid crystal layer has regions having different lengths of the single periods in the plane, and
in the plane, the liquid crystal layer further has regions in which the optical axis derived from the liquid crystal compound is twisted and rotates in a thickness direction, and has regions having different total magnitudes of twisted angles in the thickness direction.
[2] The optical unit according to [1],
in which, in a region in which a length of the single period in the liquid crystal alignment pattern is shorter, the total magnitude of twisted angles in the thickness direction is larger.
[3] The optical unit according to [1] or [2],
in which the liquid crystal layer has a region in which a length of the single period in the liquid crystal alignment pattern is 0.6 μm or less.
[4] The optical unit according to any one of [1] to [3],
in which the polarization diffraction element includes a plurality of the liquid crystal layers, and each of the liquid crystal layers diffracts polarized light in a specific wavelength range and does not diffract polarized light in a wavelength range different from the specific wavelength range.
[5] The optical unit according to any one of [1] to [4],
in which the polarization diffraction element includes a plurality of the liquid crystal layers, and further includes a wavelength selective retardation layer which is disposed between the liquid crystal layers.
[6] The optical unit according to any one of [1] to [5],
in which at least one of the first partial reflection element or the second partial reflection element is a volume hologram.
[7] The optical unit according to any one of [1] to [6], further comprising:
a circular polarizer,
in which the first partial reflection element, the second partial reflection element, the polarization diffraction element, and the circular polarizer are provided in this order.
[8] The optical unit according to any one of [1] to [7], further comprising:
an optical element,
in which the optical element has a function of refracting incidence light and has regions having different refractive indices at different positions in a plane, and
the optical element, the first partial reflection element, the second partial reflection element, and the polarization diffraction element are provided in this order.
[9] The optical unit according to [8],
in which the optical element includes a liquid crystal layer formed of a liquid crystal composition containing a liquid crystal compound, and the liquid crystal layer has a liquid crystal alignment pattern in which an orientation of an optical axis derived from the liquid crystal compound changes while continuously rotating in at least one in-plane direction, and
in the liquid crystal alignment pattern, in a case where a length over which the orientation of the optical axis derived from the liquid crystal compound rotates by 180° in a plane is set as a single period, the liquid crystal layer has regions having different lengths of the single periods in the plane.
[10] An image display system comprising:
the optical unit according to any one of [1] to [9]; and
an image display device.

According to the present invention, there are provided an optical unit which can reduce brightness unevenness of an image to be observed in a case of being used in an image display system, and an image display system using the optical unit, in which brightness unevenness of an image to be observed is small.

### BRIEF DESCRIPTION OF THE DRAWINGS

FIG. 1 is a view conceptually showing an example of an image display system according to an embodiment of the present invention.

FIG. 2 is a plan view conceptually showing an example of a polarization diffraction element.

FIG. 3 is a partial cross-sectional view conceptually showing the polarization diffraction element shown in FIG. 2.

FIG. 4 is a partial cross-sectional view for describing the polarization diffraction element shown in FIG. 2.

FIG. 5 is a plan view for describing the polarization diffraction element shown in FIG. 2.

FIG. 6 is a conceptual view for describing an action of the polarization diffraction element shown in FIG. 2.

FIG. 7 is a conceptual view for describing the action of the polarization diffraction element shown in FIG. 2.

FIG. 8 is a conceptual view for describing the action of the polarization diffraction element shown in FIG. 2.

FIG. 9 is a conceptual view for describing another example of a liquid crystal layer.

FIG. 10 is a view conceptually showing an exposure device which forms a liquid crystal alignment pattern.

FIG. 11 is a conceptual view for describing another example of a liquid crystal layer.

FIG. 12 is a conceptual view for describing the liquid crystal layer shown in FIG. 11.

FIG. 13 is a view conceptually showing another example of the image display system according to the embodiment of the present invention.

FIG. 14 is a view conceptually showing another example of the image display system according to the embodiment of the present invention.

FIG. 15 is a view conceptually showing another example of the image display system according to the embodiment of the present invention.

FIG. 16 is a view conceptually showing another example of the image display system in the related art.

### DESCRIPTION OF THE PREFERRED EMBODIMENTS

Hereinafter, the present invention will be described in detail.

The description of the configuration requirements described below may be made based on representative embodiments and specific examples, but the present invention is not limited to such embodiments.

Any numerical range expressed using “to” in the present specification refers to a range including the numerical values before and after the “to” as a lower limit value and an upper limit value, respectively.

In addition, although not limited thereto, light in a wavelength range of 420 to 490 nm is blue light (B light), light in a wavelength range of 495 to 570 nm is green light (G light), and light in a wavelength range of 620 to 750 nm is red light (R light).

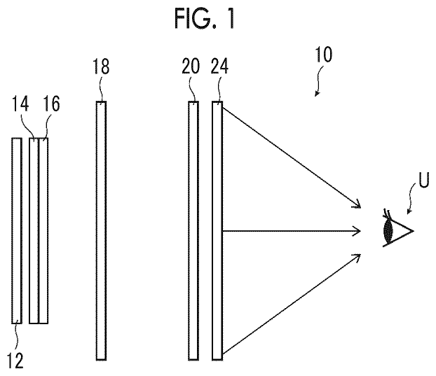

FIG. 1 conceptually shows an example of the image display system according to the embodiment of the present invention, using the optical unit according to the embodiment of the present invention.

An image display system 10 shown in FIG. 1 includes an image display device 12, a circular polarizer consisting of a linear polarizer 14 and a λ/4 wavelength plate 16, a half mirror 18, a circularly reflective polarizer 20, and a polarization diffraction element 24. The image display system 10 is, for example, an image display system (VR system) for experiencing the above-described virtual reality (VR).

In the image display system 10 in the example shown in the drawing, the half mirror 18 is the first partial reflection element in the present invention. In addition, in the image display system 10 in the example shown in the drawing, the circularly reflective polarizer 20 is the second partial reflection element in the present invention. Furthermore, in the image display system 10 in the example shown in the drawing, the polarization diffraction element 24 is the polarization diffraction element in the present invention. Accordingly, in the image display system 10 in the example shown in the drawing, the half mirror 18, the circularly reflective polarizer 20, and the polarization diffraction element 24 constitute the optical unit according to the embodiment of the present invention.

In the image display system 10 shown in FIG. 1, light emitted from the image display device 12, that is, a displayed image is converted into circularly polarized light by the circular polarizer consisting of the linear polarizer 14 and the λ/4 wavelength plate 16. In the present example, for example, the circular polarizer converts the light emitted from the image display device 12 into dextrorotatory circularly polarized light.

Next, the dextrorotatory circularly polarized light is incident into the half mirror 18, and a part of the dextrorotatory circularly polarized light is transmitted through the half mirror 18. Next, the dextrorotatory circularly polarized light transmitted through the half mirror 18 is incident into the circularly reflective polarizer 20.

In the present example, the circularly reflective polarizer 20 is a circularly reflective polarizer which selectively reflects dextrorotatory circularly polarized light and allows transmission of levorotatory circularly polarized light. Therefore, the dextrorotatory circularly polarized light transmitted through the half mirror 18 is reflected from the circularly reflective polarizer 20.

The dextrorotatory circularly polarized light reflected from the circularly reflective polarizer 20 is incident into the half mirror 18 again, and a part of the dextrorotatory circularly polarized light is reflected. That is, an optical path of the light emitted from the image display device 12 is folded. Due to the reflection from the half mirror 18, the dextrorotatory circularly polarized light is converted into levorotatory circularly polarized light.

The levorotatory circularly polarized light reflected from the half mirror 18 is incident into the circularly reflective polarizer 20 again. As described above, the circularly reflective polarizer 20 is a circularly reflective polarizer which selectively reflects dextrorotatory circularly polarized light and allows transmission of levorotatory circularly polarized light. Accordingly, the levorotatory circularly polarized light reflected from the half mirror 18 transmits the circularly reflective polarizer 20, and is incident into the polarization diffraction element 24.

As will be described later, the polarization diffraction element 24 is a transmissive liquid crystal diffraction lens which selectively focuses dextrorotatory circularly polarized light or levorotatory circularly polarized light. In the example shown in the drawing, the polarization diffraction element 24 is, for example, a transmissive liquid crystal diffraction lens which selectively focuses levorotatory circularly polarized light.

Therefore, the levorotatory circularly polarized light incident into the polarization diffraction element 24 is focused by the polarization diffraction element 24, and is observed by the user U.

In the image display system 10, the polarization diffraction element 24 focuses light to realize a wide FOV.

In the image display system 10 according to the embodiment of the present invention, various known image display devices (displays) can be used as the image display device 12.

Examples of the image display device 12 include a liquid crystal display device (LCD), an organic electroluminescent display device (organic light emitting diode; OLED), a cathode-ray tube (CRT), a plasma display device, a light emitting diode (LED) display device, a micro LED display device, a digital light processing (DLP)-type display device, and a micro-electro-mechanical system (MEMS)-type display device. In the present invention, the liquid crystal display device includes liquid crystal on silicon (LCOS).

In the image display system 10 according to the embodiment of the present invention, the linear polarizer 14 and the λ/4 wavelength plate 16 constituting the circular polarizer are not limited, and various known matters can be used.

Therefore, the polarizer may be a reflective polarizer or an absorptive polarizer; and various known linear polarizers such as an iodine-based polarizer, a dye-based polarizer using a dichroic dye, a polyene-based polarizer, a wire grid type polarizer, and a film obtained by stretching a dielectric multi-layer film described in JP2011-053705A can be used.

In addition, as the λ/4 wavelength plate, various known λ/4 wavelength plates such as a stretched polycarbonate film, a stretched norbornene-based polymer film, a transparent film in which inorganic particles having birefringence, such as strontium carbonate, are contained and aligned, a thin film with an inorganic dielectric obliquely deposited on a support, a film in which a polymerizable liquid crystal compound is uniaxially aligned and the alignment is fixed, and a film in which a liquid crystal compound is uniaxially aligned and the alignment is fixed can be used.

In a case where the image display device 12 emits linearly polarized light, such as a liquid crystal display device and an organic electroluminescent display device having an antireflection film, the λ/4 wavelength plate 16 may be disposed without using the linear polarizer 14.

In the image display system 10 according to the embodiment of the present invention, various known half mirrors can also be used as the half mirror 18.

In the image display system 10 according to the embodiment of the present invention, the circularly reflective polarizer 20 is not limited, and various known reflective circular polarizers which reflect dextrorotatory circularly polarized light or levorotatory circularly polarized light and allow transmission of circularly polarized light of which a turning direction is opposite to that of the reflected light can be used.

Preferred examples of the circularly reflective polarizer 20 include a cholesteric liquid crystal layer.

The cholesteric liquid crystal layer is a liquid crystal layer obtained by fixing a liquid crystal phase (cholesteric liquid crystalline phase) consisting of cholesterically aligned liquid crystal compounds.

As is well known, the cholesteric liquid crystal layer has a helical structure in which the liquid crystal compounds are helically turned and stacked. In the helical structure, a configuration in which the liquid crystal compound is helically rotated once (rotated by 360°) and laminated is set as one pitch (helical pitch), and the helically turned liquid crystal compounds are laminated a plurality of pitches.

In addition, as is well known, the cholesteric liquid crystal layer selectively reflects levorotatory circularly polarized light or dextrorotatory circularly polarized light in a specific wavelength range and allows the transmission of the other light depending on a helical turning direction (sense) of the liquid crystal compound.

Specifically, the cholesteric liquid crystal layer selectively reflects light in a specific wavelength range and allows the transmission of light in other wavelength ranges according to the length of one helical pitch. A central wavelength k of selective reflection (selective reflection central wavelength λ) of the cholesteric liquid crystal layer depends on a single helical pitch P of the helical structure in the cholesteric liquid crystalline phase, and follows a relationship λ=n×P with an average refractive index n of the cholesteric liquid crystal structure. The single helical pitch P of the helical structure is a period of the helix, and is a length in a thickness direction in which the liquid crystal compound rotates by 360°.

In addition, depending on the helical turning direction (sense), the cholesteric liquid crystal layer reflects dextrorotatory circularly polarized light and allows transmission of levorotatory circularly polarized light, or reflects levorotatory circularly polarized light and allows transmission of dextrorotatory circularly polarized light. The turning direction of the circularly polarized light reflected by the cholesteric liquid crystal layer matches a helical sense of the cholesteric liquid crystalline phase.

As the cholesteric liquid crystal layer, various known cholesteric liquid crystal layers obtained by fixing the cholesteric liquid crystalline phase can be used.

In addition, the cholesteric liquid crystal layer may be a cholesteric liquid crystal layer having a so-called pitch gradient in which the helical pitch changes in the thickness direction.

As described above, the cholesteric liquid crystal layer selectively reflects light in a specific wavelength range and allows the transmission of light in other wavelength ranges.

Accordingly, in a case where the circularly reflective polarizer 20 is composed of the cholesteric liquid crystal layer, the circularly reflective polarizer 20 may have only one cholesteric liquid crystal layer or may have a plurality of cholesteric liquid crystal layers depending on the display image of the image display device 12.

For example, in a case where the image display device 12 displays a full color image or a black-and-white image, the circularly reflective polarizer 20 may have three cholesteric liquid crystal layers including a cholesteric liquid crystal layer having a selective reflection central wavelength in a wavelength range of the blue light, a cholesteric liquid crystal layer having a selective reflection central wavelength in a wavelength range of the green light, and a cholesteric liquid crystal layer having a selective reflection central wavelength in a wavelength range of the red light.

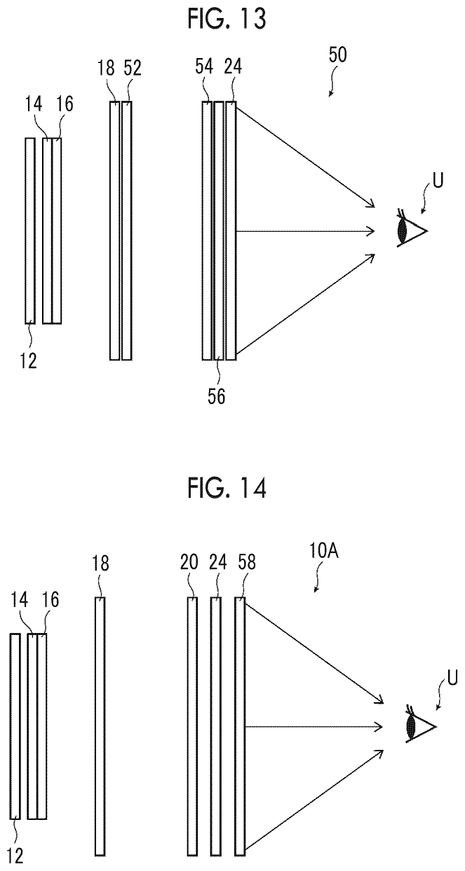

In the present invention, a volume hologram may be used instead of the half mirror 18 as the first partial reflection element. In addition, in the present invention, a volume hologram may be used as the second partial reflection element instead of the circularly reflective polarizer 20 and a reflective polarizer 54 (see FIG. 13) described later.

The volume hologram also reflects a part of the incident light and transmits a part of the incident light.

As the volume hologram, known various volume holograms, for example, various commercially available photopolymer films such as “BAYFOL HX120” and “BAYFOL HX200” (both are trade names) available from Covestro AG, and “LithHolo C-RT20” (trade name) available from Liti Holographic Co., Ltd. can be used.

As described above, the polarization diffraction element 24 is a transmissive liquid crystal diffraction lens which selectively focuses dextrorotatory circularly polarized light or levorotatory circularly polarized light. In the example shown in the drawing, the polarization diffraction element 24 selectively focuses, for example, levorotatory circularly polarized light.

The polarization diffraction element 24 is the polarization diffraction element (liquid crystal polarization diffraction element) in the present invention, and is a characteristic member of the present invention.

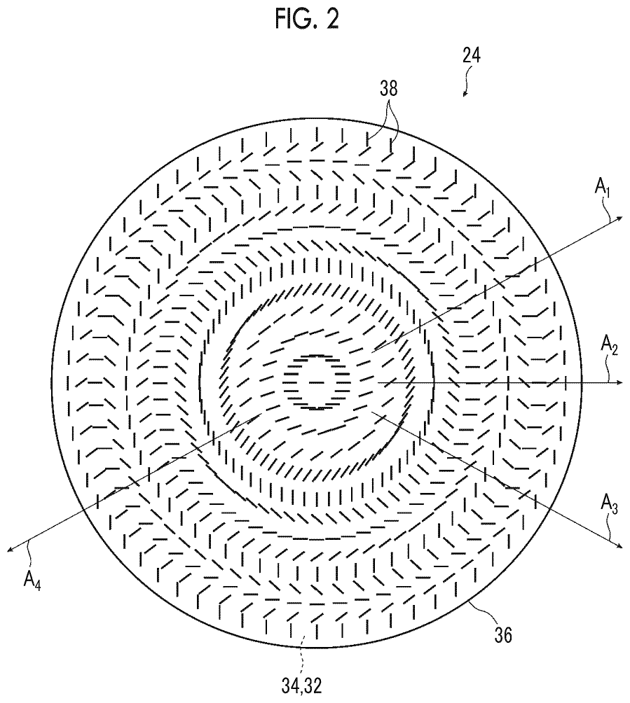

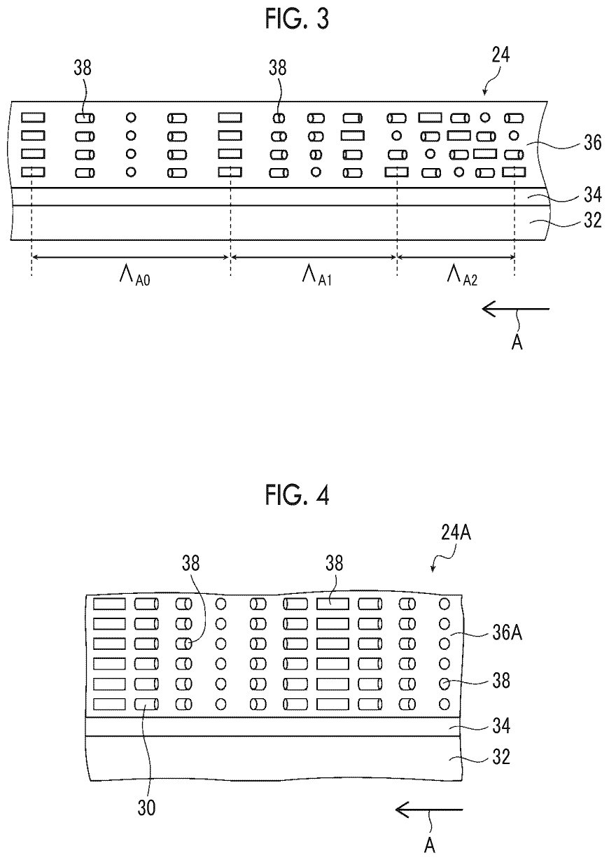

FIGS. 2 and 3 conceptually show an example of the polarization diffraction element 24. FIG. 2 is a plan view of the polarization diffraction element 24, and FIG. 3 is a cross-sectional view in a thickness direction.

As shown in FIGS. 2 and 3, the polarization diffraction element 24 has a liquid crystal layer 36 formed of a liquid crystal composition containing a liquid crystal compound 38.

The liquid crystal layer 36 has a liquid crystal alignment pattern in which an orientation of an optical axis derived from the liquid crystal compound 38 changes while continuously rotating in at least one in-plane direction. In addition, in the liquid crystal alignment pattern, in a case where a length over which the direction of the optical axis derived from the liquid crystal compound 38 rotates by 180° in a plane is set as a single period, the liquid crystal layer 36 has regions having different lengths of the single period in the plane.

Furthermore, in the plane, the liquid crystal layer 36 has regions in which the optical axis derived from the liquid crystal compound 38 is twisted and rotates in a thickness direction of the liquid crystal layer 36, and has regions having different total magnitudes of twisted angles in the thickness direction.

Since the optical unit according to the embodiment of the present invention includes the half mirror 18 (first partial reflection element), the circularly reflective polarizer 20 (second partial reflection element), and the polarization diffraction element 24 in this order, and the polarization diffraction element 24 has the above-described configuration, for example, in a case of being used in an image display system such as a VR system, the optical unit can display an image with less brightness unevenness of an image to be observed.

As shown in FIGS. 2 and 3, the polarization diffraction element 24 includes a substrate 32, an alignment film 34, and a liquid crystal layer 36. In the polarization diffraction element 24, the liquid crystal layer 36 acts as a polarization diffraction element.

Accordingly, the polarization diffraction element 24 may be composed only of the liquid crystal layer 36, may be formed by peeling off the substrate 32 and then including the alignment film 34 and the liquid crystal layer 36, or may be formed by peeling off the substrate 32 and the alignment film 34 from the liquid crystal layer 36 and laminating the liquid crystal layer 36 on another substrate.

In the polarization diffraction element 24 shown in FIGS. 2 and 3, the liquid crystal layer 36 is a liquid crystal layer which is formed on the alignment film 34 using a composition containing the liquid crystal compound 38, in which the liquid crystal compound 38 is aligned and immobilized in the following liquid crystal alignment pattern.

Specifically, the liquid crystal layer 36 has a liquid crystal alignment pattern in which an orientation of an optical axis derived from the liquid crystal compound 38 changes while continuously rotating in one direction in a radial shape from an inner side toward an outer side. That is, the liquid crystal alignment pattern in the liquid crystal layer 36 shown in FIGS. 2 and 3 is a concentric pattern including the one direction in which the orientation of the optical axis derived from the liquid crystal compound 38 changes while continuously rotating in a concentric circular shape from the inner side toward the outer side.

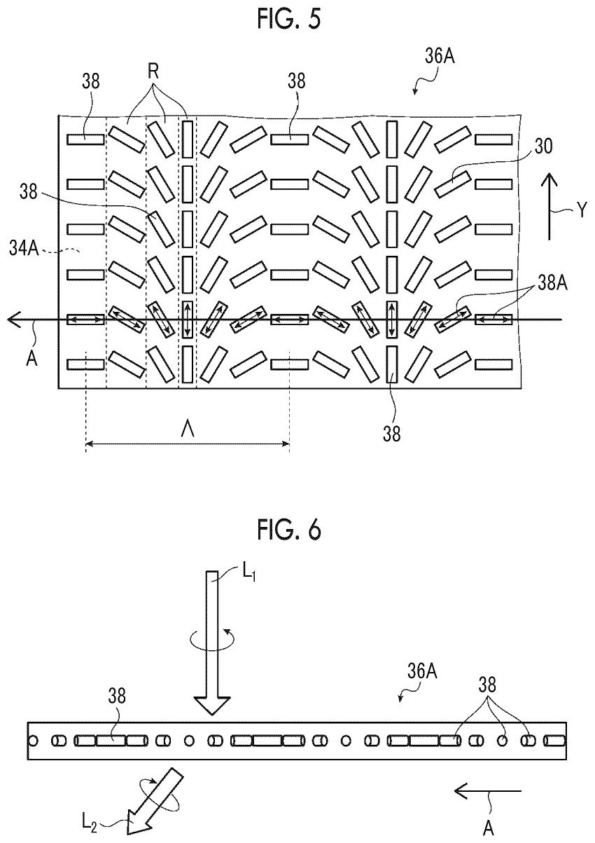

In FIG. 2 and FIG. 5 described later, in order to simplify the drawing and clarify the configuration of the liquid crystal layer 36, only the liquid crystal compound 38 at the interface of the liquid crystal layer 36 on the alignment film 34 side is shown. However, as shown in FIG. 3, the liquid crystal layer 36 has a configuration in which the liquid crystal compounds 38 are laminated in the thickness direction, similarly to a typical liquid crystal layer formed of a composition containing a liquid crystal compound. In addition, in the present invention, as described above, the liquid crystal layer 36 has regions in which the optical axis derived from the liquid crystal compound 38 is twisted and rotates in a thickness direction, and has regions having different total magnitudes of twisted angles in the thickness direction.

Furthermore, in FIGS. 2 and 3, for example, a rod-like liquid crystal compound is exemplified as the liquid crystal compound 38, so that the direction of the optical axis matches with a longitudinal direction of the liquid crystal compound 38.

Specifically, in the liquid crystal layer 36, the orientation of the optical axis of the liquid crystal compound 38 changes while continuously rotating along a plurality of directions from the center, that is, the optical axis of the liquid crystal layer 36 toward the outer side, for example, along a direction indicated by an arrow A₁, a direction indicated by an arrow A₂, a direction indicated by an arrow A₃, a direction indicated by an arrow A₄, and the like.

Accordingly, in the liquid crystal layer 36, the rotation direction of the optical axes of the liquid crystal compounds 38 is the same in all directions (one direction). In the example shown in the drawing, the rotation direction of the optical axes of the liquid crystal compounds 38 is counterclockwise, in all the directions including the direction indicated by the arrow A₁, the direction indicated by the arrow A₂, the direction indicated by the arrow A₃, and the direction indicated by the arrow A₄.

That is, in a case where the arrow A₁ and the arrow A₄ are regarded as one straight line, the rotation direction of the optical axes of the liquid crystal compounds 38 is reversed at the center of the liquid crystal layer 36 on the straight line. For example, the straight line formed by the arrow A₁ and the arrow A₄ is directed in the right direction (arrow A₁ direction) in the drawing. In this case, the optical axis of the liquid crystal compound 38 initially rotates clockwise from the outer side toward the center of the liquid crystal layer 36, the rotation direction is reversed at the center of the liquid crystal layer 36, and then the optical axis of the liquid crystal compound 38 rotates counterclockwise from the center to the outer side of the liquid crystal layer 36. The center of the liquid crystal layer 36 is the optical axis of the polarization diffraction element.

As is well known, the liquid crystal layer having the liquid crystal alignment pattern in which the orientation of the optical axis derived from the liquid crystal compound 38 changes while continuously rotating in the one direction acts as a transmissive liquid crystal diffraction element which diffracts incident circularly polarized light in the one direction and the reverse direction according to the rotation direction of the optical axis and the turning direction of the incident circularly polarized light.

In the liquid crystal layer 36 having the liquid crystal alignment pattern in which the orientation of the optical axis of the liquid crystal compound 38 changes while continuously rotating in the one direction, a diffraction direction (refraction direction) of transmitted light depends on the rotation direction of the optical axes of the liquid crystal compounds 38. That is, in the liquid crystal alignment pattern, in a case where the rotation directions of the optical axes of the liquid crystal compounds 38 in the one direction are opposite to each other, the diffraction direction of transmitted light is opposite to the one direction in which the optical axis rotates.

In addition, in the liquid crystal layer 36 having the liquid crystal alignment pattern in which the orientation of the optical axis of the liquid crystal compound 38 changes while continuously rotating in the one direction, the diffraction direction of transmitted light varies depending on the turning direction of the incident circularly polarized light. That is, in the liquid crystal alignment pattern, the diffraction direction of transmitted light is reversed between a case where the incident light is dextrorotatory circularly polarized light and a case where the incident light is levorotatory circularly polarized light.

Furthermore, in a case where the value of in-plane retardation is set to λ/2, the liquid crystal layer 36 has a function as a typical λ/2 plate, that is, a function of imparting a phase difference of a half wavelength, that is, 180° to a polarized light component incident into the liquid crystal layer. The in-plane retardation is, that is, a retardation in the plane direction.

Accordingly, the circularly polarized light which is incident into and diffracted by the liquid crystal layer 36 has an opposite turning direction. That is, the dextrorotatory circularly polarized light incident into and diffracted by the liquid crystal layer 36 is emitted as levorotatory circularly polarized light; and the levorotatory circularly polarized light is emitted as dextrorotatory circularly polarized light.

In the liquid crystal layer 36 of the polarization diffraction element 24, in the liquid crystal alignment pattern, in a case where the length over which the orientation of the optical axis derived from the liquid crystal compound rotates by 180° in one direction in which the orientation of the optical axis derived from the liquid crystal compound 38 changes while continuously rotating is set as a single period, the length of the single period gradually decreases from the inner side toward the outer side.

Here, in the liquid crystal layer having the liquid crystal alignment pattern in which the orientation of the optical axis of the liquid crystal compound 38 changes while continuously rotating in the one direction, the diffraction angle increases as the length of the single period decreases. Accordingly, in the liquid crystal layer 36 having the concentric circular liquid crystal alignment pattern, the diffraction angle gradually increases from the center of the concentric circle toward the outer direction.

Accordingly, the liquid crystal layer 36 having the concentric circular liquid crystal alignment pattern with the liquid crystal alignment pattern in which the optical axis derived from the liquid crystal compound changes while continuously rotating in a radial shape can transmit incidence light by diverging or focusing the ray depending on the rotation direction of the optical axis of the liquid crystal compound 38 and the turning direction of the incident circularly polarized light.

In other words, the polarization diffraction element 24 including the liquid crystal layer 36 acts as a concave lens in a case where dextrorotatory circularly polarized light is incident and acts as a convex lens in a case where levorotatory circularly polarized light, depending on the turning direction of the incident circularly polarized light. Alternatively, the polarization diffraction element 24 acts as a convex lens in a case where dextrorotatory circularly polarized light is incident, and acts as a concave lens in a case where levorotatory circularly polarized light is incident. In the example shown in the drawing, as described above, the liquid crystal layer 36 acts as a convex lens in a case where levorotatory circularly polarized light is incident, and focuses the levorotatory circularly polarized light.

In order to simplify the drawing to clarify the configuration of the polarization diffraction element 24 in FIG. 2, only the liquid crystal compound 38 (liquid crystal compound molecule) on the surface of the alignment film 34 in the liquid crystal layer 36 is also shown. However, as conceptually shown in FIG. 4, the liquid crystal layer 36 has a structure in which the aligned liquid crystal compounds 38 are stacked in the thickness direction, similarly to a typical liquid crystal layer formed of a composition containing a liquid crystal compound.

Hereinafter, the action of the liquid crystal layer 36 will be described in detail with reference to a liquid crystal layer 36A having a liquid crystal alignment pattern in which an optical axis 38A derived from the liquid crystal compound 38 changes while continuously rotating in one direction indicated by an arrow A as conceptually shown in a plan view of FIG. 5.

Even in the concentric circular liquid crystal alignment pattern shown in FIG. 2 in which the optical axis changes while continuously rotating in one direction in a radial shape from the inner side toward the outer side, the same optical effects as those of the liquid crystal alignment pattern shown in FIG. 5 can be exhibited for the one direction in which the optical axis changes while continuously rotating.

In the following description, the optical axis 38A derived from the liquid crystal compound 38 will also be referred to as “optical axis 38A of the liquid crystal compound 38” or “optical axis 38A”.

In the liquid crystal layer 36A, the liquid crystal compound 38 is two-dimensionally aligned in a plane parallel to the one direction indicated by the arrow A and a Y direction orthogonal to the arrow A direction. In FIGS. 2 and 3 described below, the Y direction is a direction orthogonal to the paper plane.

In the following description, “one direction indicated by the arrow A” will also be simply referred to as “arrow A direction”.

In the liquid crystal layer 36 shown in FIG. 2, a circumferential direction of the concentric circle in the concentric circular liquid crystal alignment pattern corresponds to the Y direction in FIG. 5.

The liquid crystal layer 36A has a liquid crystal alignment pattern in which the orientation of the optical axis 38A derived from the liquid crystal compound 38 changes while continuously rotating in the arrow A direction in a plane of the liquid crystal layer 36A.

Specifically, the “orientation of the optical axis 38A of the liquid crystal compound 38 changes while continuously rotating in the arrow A direction (predetermined one direction)” means that an angle between the optical axis 38A of the liquid crystal compound 38, which is arranged in the arrow A direction, and the arrow A direction varies depending on positions in the arrow A direction, and the angle between the optical axis 38A and the arrow A direction sequentially changes from θ to θ+180° or to θ−180° in the arrow A direction.

Meanwhile, regarding the liquid crystal compound 38 forming the liquid crystal layer 36A, the liquid crystal compounds 38 in which the orientations of the optical axes 38A are the same as one another are arranged at equal intervals in the Y direction orthogonal to the arrow A direction, that is, the Y direction orthogonal to one direction in which the optical axes 38A continuously rotate.

In other words, regarding the liquid crystal compound 38 forming the liquid crystal layer 36, in the liquid crystal compounds 38 arranged in the Y direction, angles between the orientations of the optical axes 38A and the arrow A direction are the same.

In the liquid crystal layer 36 shown in FIG. 2, a region where the orientations of the optical axes 38A are the same is formed in an annular shape where the centers match with each other, and a concentric circular liquid crystal alignment pattern is formed.

In the liquid crystal alignment pattern in which the optical axis 38A continuously rotates in the one direction, the length (distance) over which the optical axis 38A of the liquid crystal compound 38 rotates by 180° is a length of the single period A in the liquid crystal alignment pattern.

That is, in the liquid crystal layer 36A shown in FIG. 5, the length (distance) over which the optical axis 38A of the liquid crystal compound 38 rotates by 180° in the arrow A direction in which the orientation of the optical axis 38A changes while continuously rotating in a plane is set as the single period A in the liquid crystal alignment pattern. In other words, the single period A in the liquid crystal alignment pattern is defined as a distance from θ to θ+180° of the angle between the optical axis 38A of the liquid crystal compound 38 and the arrow A direction.

That is, a distance between centers of two liquid crystal compounds 38 in the arrow A direction is the single period A, the two liquid crystal compounds having the same angle in the arrow A direction. Specifically, as shown in FIG. 5, a distance between centers of two liquid crystal compounds 38 in the arrow A direction, in which the arrow A direction and the direction of the optical axis 38A match with each other, is the single period A.

In the liquid crystal alignment pattern in the liquid crystal layer 36A (liquid crystal layer 36), the single period A is repeated in the arrow A direction, that is, in one direction in which the orientation of the optical axis 38A changes while continuously rotating.

As described above, the liquid crystal layer 36A having such a liquid crystal alignment pattern is also a transmissive liquid crystal diffraction element, and the single period A is the period (single period) of the diffraction structure.

In the liquid crystal layer 36A, the liquid crystal compounds arranged in the Y direction have the same angle between the optical axis 38A and the arrow A direction. A region where the liquid crystal compounds 38 in which the angles between the optical axes 38A and the arrow A direction are the same are arranged in the Y direction will be referred to as a region R.

In this case, it is preferable that a value of in-plane retardation (Re) each of the regions R is a half wavelength, that is, λ/2. The in-plane retardation is calculated from a product of a difference in refractive index Δn due to refractive index anisotropy of the region R and a thickness of the liquid crystal layer. Here, the difference in refractive index due to the refractive index anisotropy of the regions R in the liquid crystal layer is defined by a difference between a refractive index of a direction of an in-plane slow axis of the region R and a refractive index of a direction orthogonal to the direction of the slow axis. That is, the difference Δn in refractive index due to the refractive index anisotropy of the regions R is the same as a difference between a refractive index of the liquid crystal compound 38 in the direction of the optical axis 38A and a refractive index of the liquid crystal compound 38 in a direction perpendicular to the optical axis 38A in a plane of the region R. That is, the above-described difference in refractive index Δn is the same as the difference in refractive index of the liquid crystal compound.

In the polarization diffraction element 24 having the concentric circular liquid crystal alignment pattern with the liquid crystal alignment pattern in which the optical axis 38A continuously rotates in one direction in a radial shape, regions where the orientations of the optical axes 38A are the same and that are formed in an annular shape where the centers match with each other correspond to the region R in FIG. 5.

In a case where circularly polarized light is incident into the liquid crystal layer 36A, the light is diffracted and a direction of the circularly polarized light is changed.

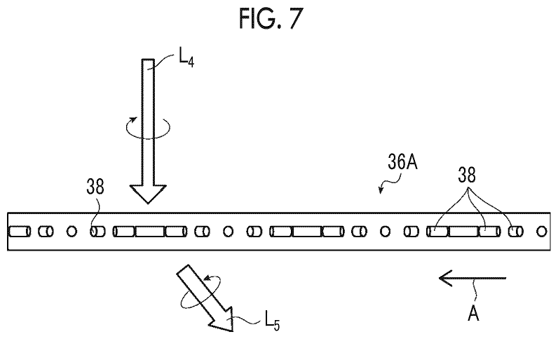

The action is conceptually shown in FIGS. 6 and 7. In the liquid crystal layer 36A, the value of the product of the difference in refractive index of the liquid crystal compound and the thickness of the liquid crystal layer is λ/2.

As described above, the action is also the same in the polarization diffraction element 24 having the concentric circular liquid crystal alignment pattern with the liquid crystal alignment pattern in which the optical axis 38A continuously rotates in the one direction in a radial shape.

As shown in FIG. 6, in a case where the value of the product of the difference in refractive index of the liquid crystal compound of the liquid crystal layer 36 and the thickness of the liquid crystal layer 36 is λ/2, and an incidence ray L₁ as levorotatory circularly polarized light is incident into the liquid crystal layer 36, the incidence ray L₁ transmits the liquid crystal layer 36A to be imparted with a retardation of 180°, and thus is converted into a transmitted ray L₂ as dextrorotatory circularly polarized light.

In addition, the liquid crystal alignment pattern formed in the liquid crystal layer 36 is a pattern which is periodic in the arrow A direction, so that the transmitted ray L₂ travels in a direction different from a traveling direction of the incidence ray L₁. In this way, the incidence ray L₁ of the levorotatory circularly polarized light is converted into the transmitted ray L₂ of the dextrorotatory circularly polarized light, which is tilted by a predetermined angle in the arrow A direction with respect to an incidence direction.

On the other hand, as conceptually shown in FIG. 7, in a case where the value of the product of the difference in refractive index of the liquid crystal compound of the liquid crystal layer 36A and the thickness of the liquid crystal layer 36A is λ/2, and an incidence ray L₄ as dextrorotatory circularly polarized light is incident into the liquid crystal layer 36A, the incidence ray L₄ transmits the liquid crystal layer 36 to be imparted with a retardation of 180°, and thus is converted into a transmitted ray L₅ as levorotatory circularly polarized light.

In addition, the liquid crystal alignment pattern formed in the liquid crystal layer 36A is a pattern which is periodic in the arrow A direction, so that the transmitted ray L₅ travels in a direction different from a traveling direction of the incidence ray L₄. In this case, the transmitted ray L₅ travels in a direction different from the transmitted ray L₂, that is, in a direction opposite to the arrow A direction with respect to the incidence direction. In this way, the incidence ray L₄ is converted into the transmitted ray L₅ of the levorotatory circularly polarized light, which is tilted by a predetermined angle in the arrow A direction with respect to the incidence direction.

In the liquid crystal layer 36A, it is preferable that the in-plane retardation value of the plurality of the regions R is a half wavelength, and it is preferable that an in-plane retardation Re(550)=Δn₅₅₀×d of the plurality of the regions R of the liquid crystal layer 36A with respect to an incidence ray having a wavelength of 550 nm is in a range defined by the following expression (1). Here, Δn₅₅₀ is a difference in refractive index due to the refractive index anisotropy of the region R in a case where the wavelength of the incidence light is 550 nm, and d represents a thickness of the liquid crystal layer 36A.

$$200 nm \leq Δ {n}_{550} \times d \leq 350 nm \qquad ( 1 )$$

That is, in a case where the “in-plane retardation Re(550)=Δn₅₅₀×d” of the plurality of the regions R of the liquid crystal layer 36A satisfies the expression (1), a sufficient amount of circularly polarized light components of light which has been incident into the liquid crystal layer 36A can be converted into circularly polarized light traveling in a direction tilted in a forward or backward direction with respect to the arrow A direction. It is more preferable that the in-plane retardation Re(550)=Δn₅₅₀×d is 225 nm≤Δn₅₅₀×d≤340 nm, and it is still more preferable that the in-plane retardation Re(550)=Δn₅₅₀×d is 250 nm≤Δn₅₅₀×d≤330 nm.

The above expression (1) is a range with respect to the incident light having a wavelength of 550 nm, but an in-plane retardation Re(λ)=Δn_{λ}×d of the plurality of the regions R of the liquid crystal layer with respect to incidence light having a wavelength of λ nm is preferably in a range defined by the following expression (1-2), and can be appropriately set.

$$0.7 \times ( λ / 2 ) nm \leq Δ {n}_{λ} \times d \leq 1.3 \times ( λ / 2 ) nm \qquad ( 1 - 2 )$$

In addition, a value of the in-plane retardation of the plurality of the regions R of the liquid crystal layer 36A in a range outside the range of the above expression (1) can also be used. Specifically, by adopting Δn₅₅₀×d<200 nm or 350 nm<Δn₅₅₀×d, light can be classified into light which travels in the same direction as a traveling direction of the incidence ray and light which travels in a direction different from a traveling direction of the incidence ray. In a case where Δn₅₅₀×d approaches 0 nm or 550 nm, the light component traveling in the same direction as the traveling direction of the incidence ray increases, and the light component traveling in a direction different from the traveling direction of the incidence ray decreases.

Furthermore, it is preferable that an in-plane retardation Re(450)=Δn₄₅₀×d of each of the regions R of the liquid crystal layer 36A with respect to incident light having a wavelength of 450 nm and the in-plane retardation Re(550)=Δn₅₅₀×d of each of the regions R of the liquid crystal layer 36A with respect to incident light having a wavelength of 550 nm satisfy the following expression (2). Here, Δn₄₅₀ represents a difference in refractive index due to the refractive index anisotropy of the region R in a case where the wavelength of the incidence ray is 450 nm.

$$( Δ {n}_{450} \times d ) / ( Δ {n}_{550} \times d ) < 1. \qquad ( 2 )$$

The expression (2) represents that the liquid crystal compound 38 contained in the liquid crystal layer 36A has reverse dispersibility. That is, by satisfying the expression (2), the liquid crystal layer 36A can respond to incident light having a wide wavelength range.

By changing the single period A of the liquid crystal alignment pattern formed in the liquid crystal layer 36A, diffraction angles of the transmitted rays L₂ and L₅ can be adjusted. Specifically, as the single period A of the liquid crystal alignment pattern decreases, light transmitted through the liquid crystal compounds 38 adjacent to each other more strongly interfere with each other, so that the transmitted rays L₂ and L₅ can be more largely diffracted.

In addition, in the liquid crystal layer 36A, by reversing the rotation direction of the optical axes 38A of the liquid crystal compounds 38 which rotate in the arrow A direction, the diffraction direction of the transmitted light can be reversed.

Furthermore, in the liquid crystal layer 36A, the diffraction direction of the transmitted light is reversed depending on the turning direction of the incident circularly polarized light. That is, in the liquid crystal layer 36A, the diffraction directions of the transmitted light are opposite to each other between the dextrorotatory circularly polarized light and the levorotatory circularly polarized light.

Regarding the above points, the same applies to the liquid crystal layer 36 having the concentric circular liquid crystal alignment pattern as described above.

Furthermore, the liquid crystal layer 36 has regions in which the optical axis is twisted and rotates in a thickness direction of the liquid crystal layer 36, and has regions having different twisted angles in the thickness direction. This point will be described below.

The liquid crystal layer 36 is formed of a liquid crystal composition containing a rod-like liquid crystal compound or a disk-like liquid crystal compound, and has a liquid crystal alignment pattern in which optical axes of the rod-like liquid crystal compounds or the disk-like liquid crystal compounds are aligned as described above.

By forming, on the substrate 32, the alignment film 34 having the alignment pattern corresponding to the above-described liquid crystal alignment pattern and applying the liquid crystal composition onto the alignment film 34, and curing the applied liquid crystal composition, the liquid crystal layer 36 including the cured layer of the liquid crystal composition can be formed.

The liquid crystal composition for forming the liquid crystal layer 36 contains a rod-like liquid crystal compound or a disk-like liquid crystal compound, and may further contain other components such as a leveling agent, an alignment control agent, a polymerization initiator, and an alignment assistant.

In addition, it is preferable that the liquid crystal layer 36 has a wide range for the wavelength of incidence light, and is formed of a liquid crystal material having a reverse birefringence index dispersion. In addition, it is also preferable that the liquid crystal layer 36 can be made to have a substantially wide range for the wavelength of incidence light by imparting a torsion component to the liquid crystal composition or by laminating different retardation layers. For example, in the liquid crystal layer 36, a method of realizing a λ/2 plate having a wide-range pattern by laminating two liquid crystal layers having different twisted directions is described in, for example, JP2014-089476A and can be preferably used in the present invention.

### —Rod-Like Liquid Crystal Compound—

As the rod-like liquid crystal compound, azomethines, azoxys, cyano biphenyls, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolanes, and alkenylcyclohexylbenzonitriles are preferably used. In addition to the above-described low-molecular-weight liquid crystal molecules, a high-molecular-weight liquid crystal molecular can also be used.

In the liquid crystal layer 36, it is preferable that the alignment of the rod-like liquid crystal compound is fixed by polymerization; and examples of the polymerizable rod-like liquid crystal compound include compounds described in Makromol. Chem., (1989), Vol. 190, p. 2255, Advanced Materials (1993), Vol. 5, p. 107, U.S. Pat. No. 4,683,327A, 5,622,648A, U.S. Pat. No. 5,770,107A, WO95/22586A, WO95/24455A, WO97/00600A, WO98/23580A, WO98/52905A, JP1989-272551A (JP-H1-272551A), JP1994-16616A (JP-H6-16616A), JP1995-110469A (JP-H7-110469A), JP1999-80081A (JP-H11-80081A), and JP2001-64627A. Furthermore, as the rod-like liquid crystal compound, for example, compounds described in JP1999-513019A (JP-H11-513019A) and JP2007-279688A can also be preferably used.

### —Disk-Like Liquid Crystal Compound—

As the disk-like liquid crystal compound, for example, compounds described in JP2007-108732A, JP2010-244038A, and the like can be preferably used.

In a case where the disk-like liquid crystal compound is used in the liquid crystal layer, the liquid crystal compound 38 rises in the thickness direction in the liquid crystal layer, and the optical axis 38A derived from the liquid crystal compound is defined as an axis perpendicular to a disc plane, that is, a so-called fast axis.

### —Photoreactive Chiral Agent—

The liquid crystal composition for forming the liquid crystal layer 36 may contain a photoreactive chiral agent.

The photoreactive chiral agent contains, for example, a compound represented by General Formula (I), and has properties capable of controlling an aligned structure of the liquid crystal compound and changing a helical pitch of the liquid crystal compound, that is, a helical twisting power (HTP) of a helical structure during light irradiation. That is, the photoreactive chiral agent is a compound which causes a helical twisting power of a helical structure derived from a liquid crystal compound, preferably, a nematic liquid crystal compound to change during light irradiation (ultraviolet rays to visible rays to infrared rays), and includes a chiral portion and a portion in which a structural change occurs during the light irradiation as required portions (molecular structural units). Moreover, the photoreactive chiral agent represented by General Formula (I) can significantly change the HTP of liquid crystal molecules.

The above-described HTP represents a helical twisting power of a helical structure of liquid crystals, that is, HTP=1/(Pitch×Concentration of chiral agent [mass fraction]). For example, the HTP can be obtained by measuring a helical pitch (single period of the helical structure; m) of a liquid crystal molecule at a certain temperature and converting the measured value into a value [μm⁻¹] in terms of the concentration of the chiral agent. In a case where a selective reflection color is formed by the photoreactive chiral agent depending on irradiation with light, a rate of change in HTP (=HTP before irradiation/HTP after irradiation) is preferably 1.5 or more and more preferably 2.5 or more in a case where the HTP decreases after the irradiation, and is preferably 0.7 or less and more preferably 0.4 or less in a case where the HTP increases after the irradiation.

Next, the compound represented by General Formula (I) will be described.

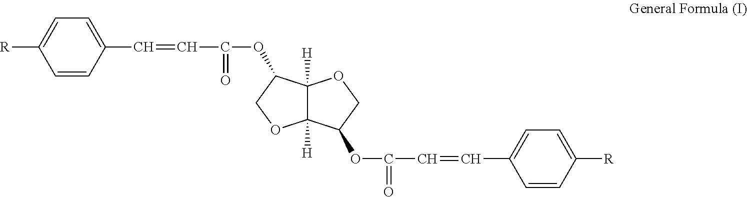

In the formula, R represents a hydrogen atom, an alkoxy group having 1 to 15 carbon atoms, an acryloyloxyalkyloxy group having 3 to 15 carbon atoms in total, or a methacryloyloxyalkyloxy group having 4 to 15 carbon atoms in total.

Examples of the above-described alkoxy group having 1 to 15 carbon atoms include a methoxy group, an ethoxy group, a propoxy group, a butoxy group, a hexyloxy group, and a dodecyloxy group; and among these, an alkoxy group having 1 to 12 carbon atoms is preferable, and an alkoxy group having 1 to 8 carbon atoms is more preferable.

Examples of the above-described acryloyloxyalkyloxy group having 3 to 15 carbon atoms in total include an acryloyloxyethyloxy group, an acryloyloxybutyloxy group, and an acryloyloxydecyloxy group; and among these, an acryloyloxyalkyloxy group having 5 to 13 carbon atoms is preferable, and an acryloyloxyalkyloxy group having 5 to 11 carbon atoms is more preferable.

Examples of the above-described methacryloyloxyalkyloxy group having 4 to 15 carbon atoms in total include a methacryloyloxyethyloxy group, a methacryloyloxybutyloxy group, and a methacryloyloxydecyloxy group; and among these, a methacryloyloxyalkyloxy group having 6 to 14 carbon atoms is preferable, and a methacryloyloxyalkyloxy group having 6 to 12 carbon atoms is more preferable.

A molecular weight of the photoreactive chiral agent represented by General Formula (I) is preferably 300 or more. In addition, a photoreactive optically active compound having high solubility in the liquid crystal compound, which will be described later, is preferable, and a photoreactive optically active compound having a solubility parameter SP value close to that of the liquid crystal compound is more preferable.

Hereinafter, specific examples (exemplary compounds (1) to (15)) of the compound represented by General Formula (I) are shown below, but the present invention is not limited thereto.

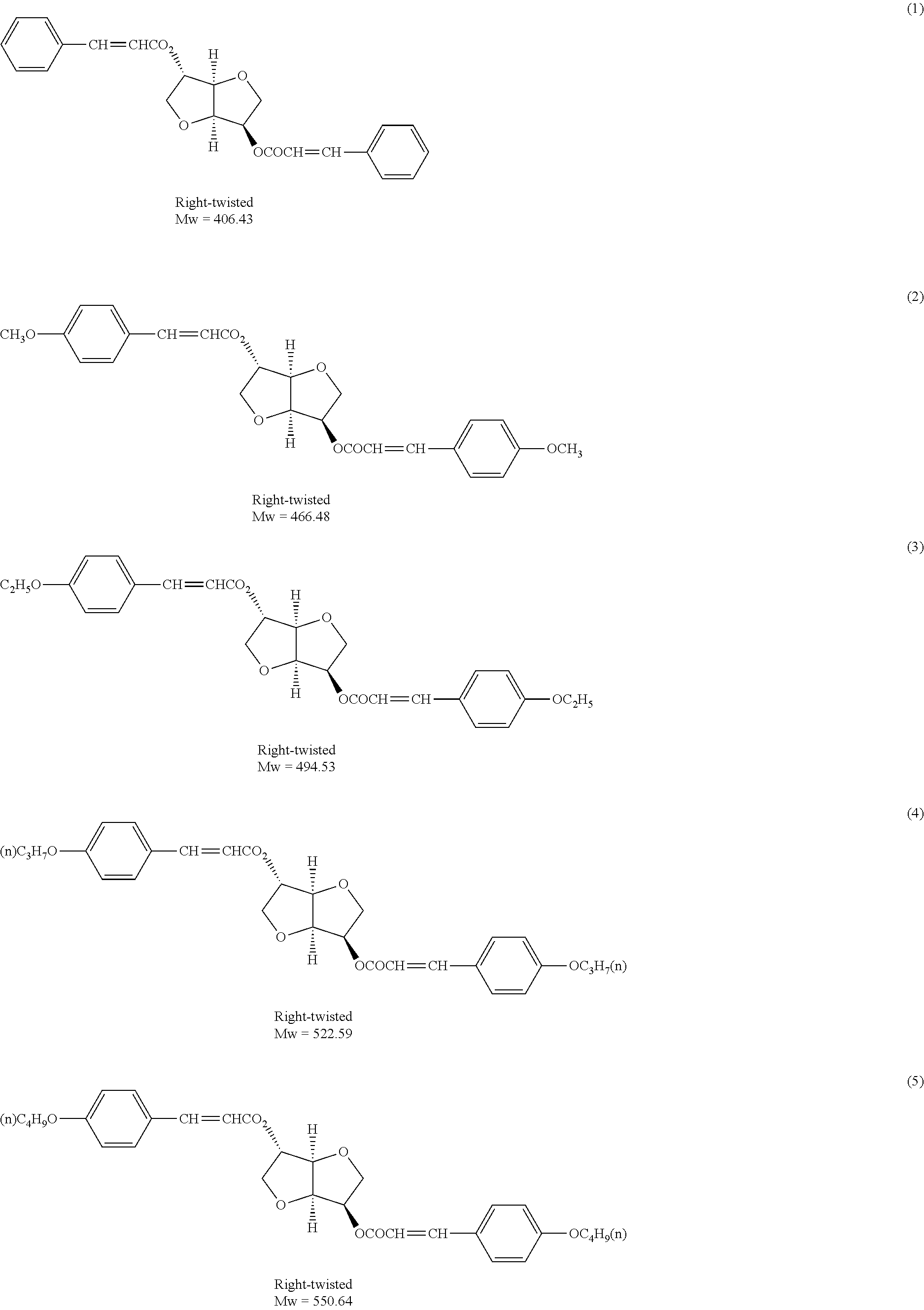

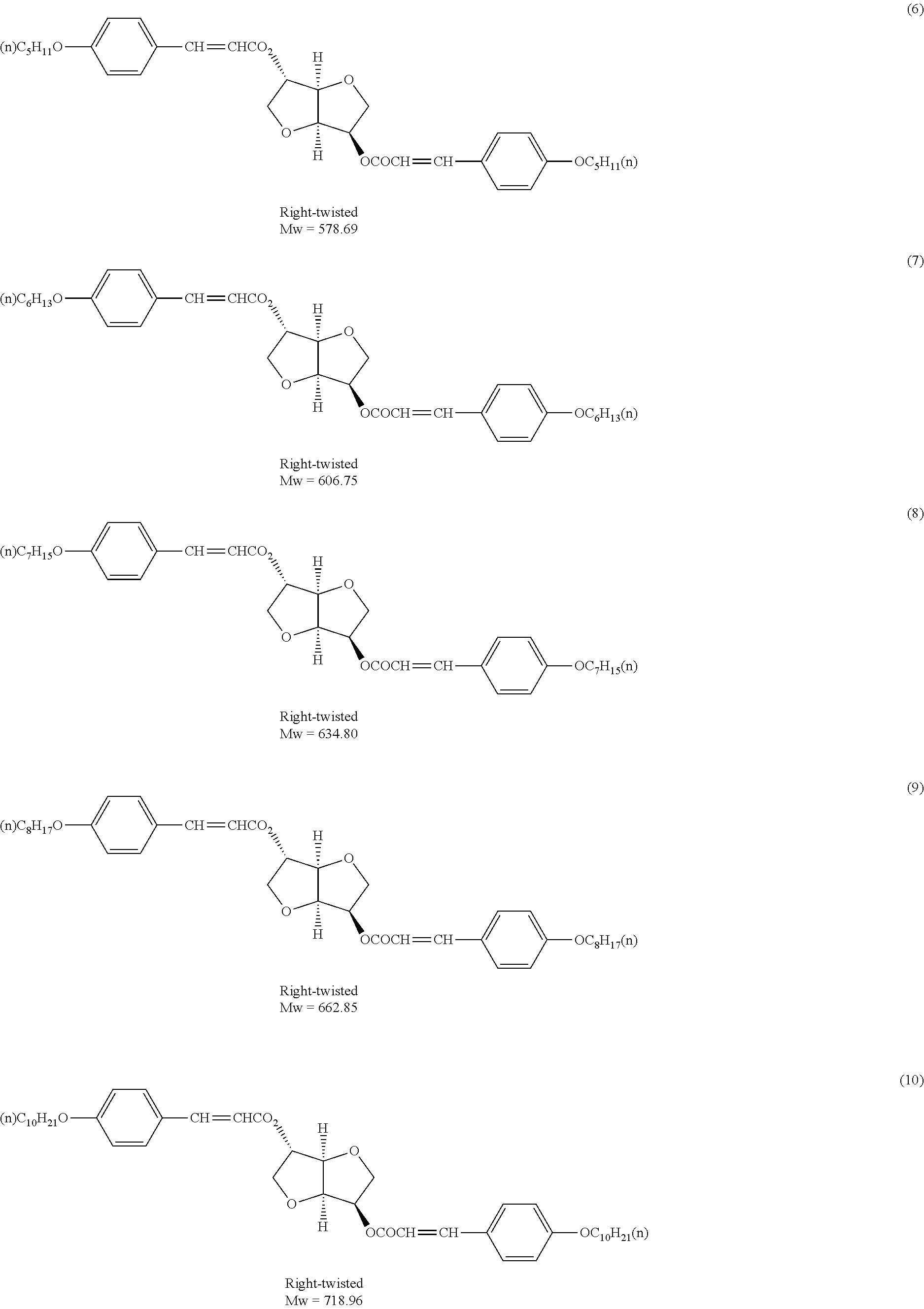

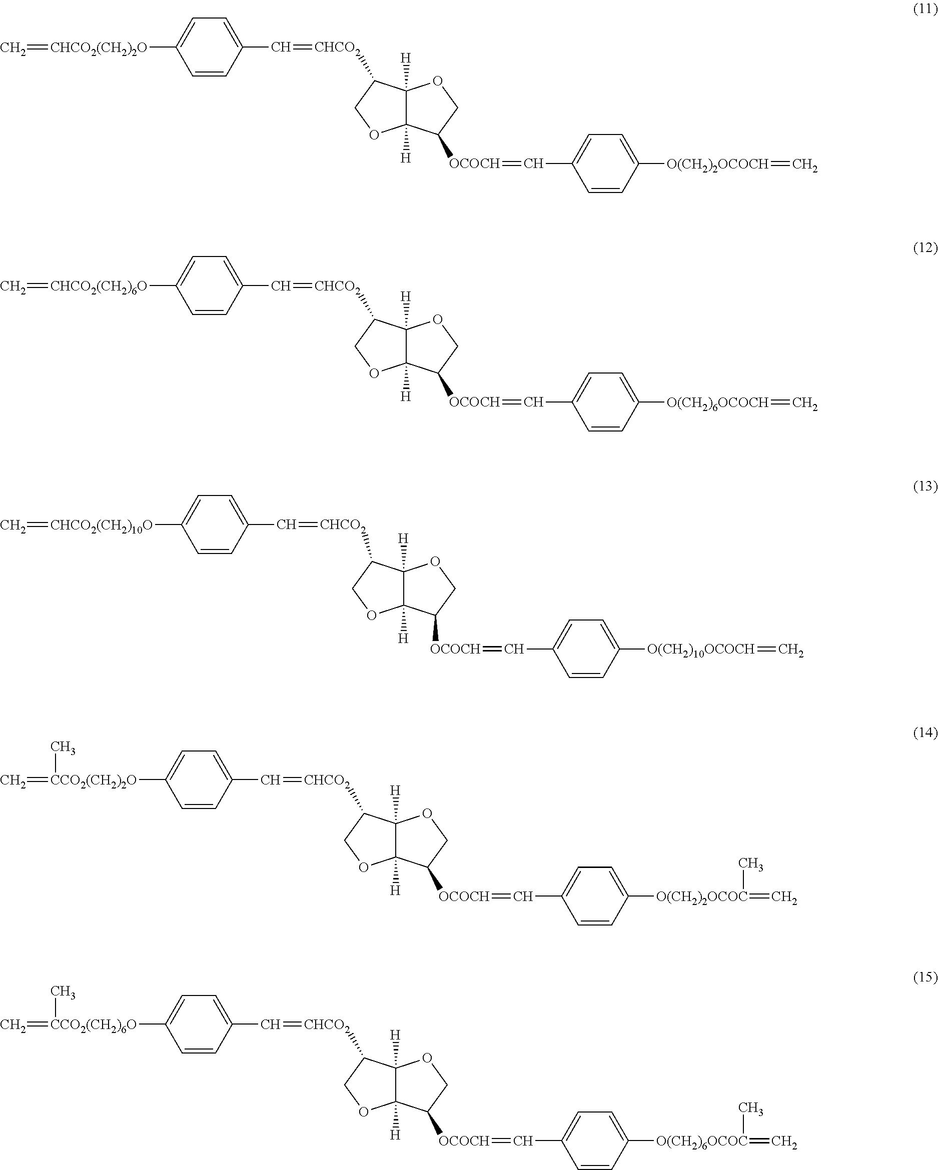

In the present invention, as the photoreactive chiral agent, for example, a photoreactive optically active compound represented by General Formula (II) is also used.

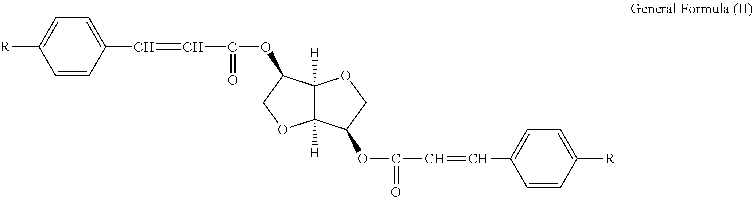

In the formula, R represents a hydrogen atom, an alkoxy group having 1 to 15 carbon atoms, an acryloyloxyalkyloxy group having 3 to 15 carbon atoms in total, or a methacryloyloxyalkyloxy group having 4 to 15 carbon atoms in total.

Examples of the above-described alkoxy group having 1 to 15 carbon atoms include a methoxy group, an ethoxy group, a propoxy group, a butoxy group, a hexyloxy group, an octyloxy group, and a dodecyloxy group; and among these, an alkoxy group having 1 to 10 carbon atoms is preferable, and an alkoxy group having 1 to 8 carbon atoms is more preferable.

Examples of the above-described acryloyloxyalkyloxy group having 3 to 15 carbon atoms in total include an acryloyloxy group, an acryloyloxyethyloxy group, an acryloyloxypropyloxy group, an acryloyloxyhexyloxy group, an acryloyloxybutyloxy group, and an acryloyloxydecyloxy group; and among these, an acryloyloxyalkyloxy group having 3 to 13 carbon atoms is preferable, and an acryloyloxyalkyloxy group having 3 to 11 carbon atoms is more preferable.

Examples of the above-described methacryloyloxyalkyloxy group having 4 to 15 carbon atoms in total include a methacryloyloxy group, a methacryloyloxyethyloxy group, and a methacryloyloxyhexyloxy group; and among these, a methacryloyloxyalkyloxy group having 4 to 14 carbon atoms is preferable, and a methacryloyloxyalkyloxy group having 4 to 12 carbon atoms is more preferable.

A molecular weight of the photoreactive optically active compound represented by General Formula (II) is preferably 300 or more. In addition, a photoreactive optically active compound having high solubility in the liquid crystal compound, which will be described later, is preferable, and a photoreactive optically active compound having a solubility parameter SP value close to that of the liquid crystal compound is more preferable.

Hereinafter, specific examples (exemplary compounds (21) to (32)) of the photoreactive optically active compound represented by General Formula (II) are shown below, but the present invention is not limited thereto.

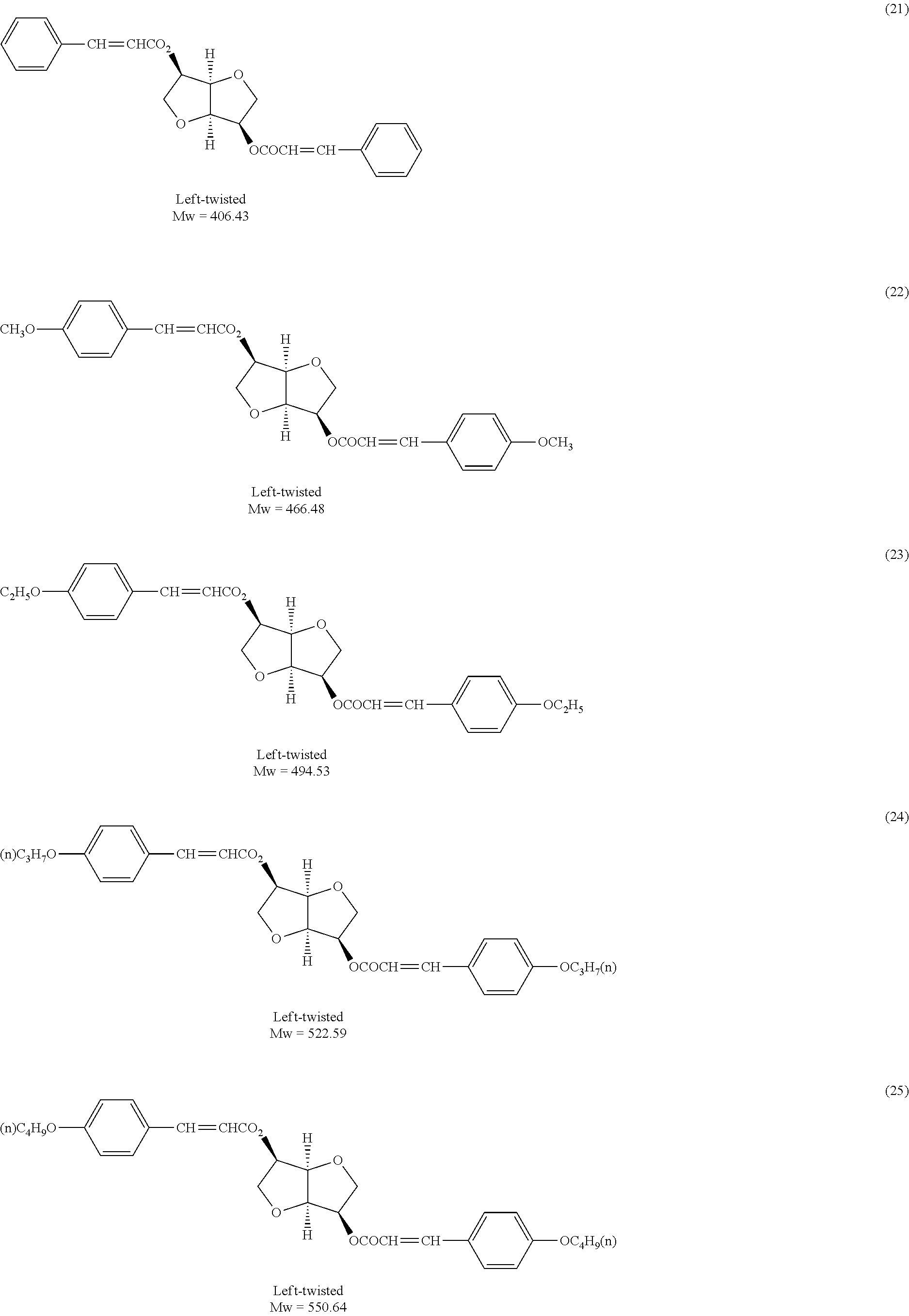

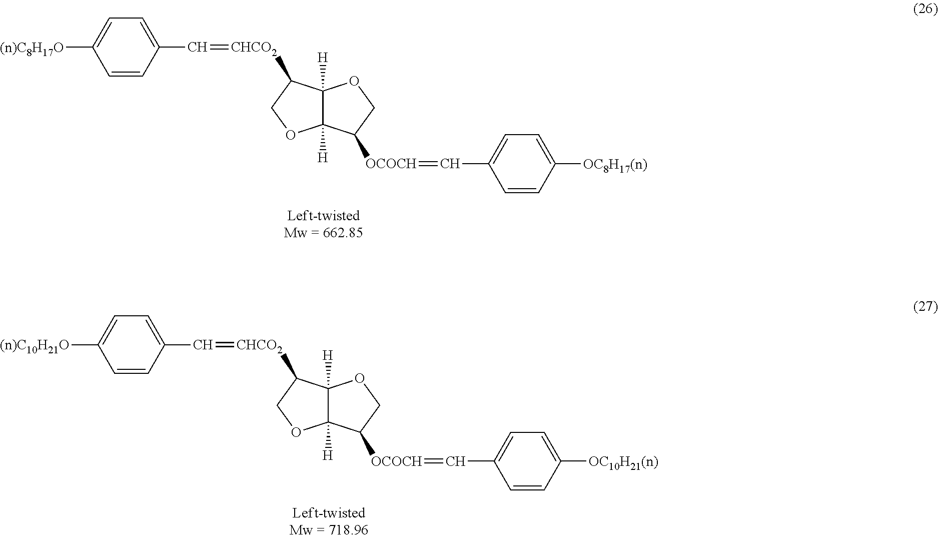

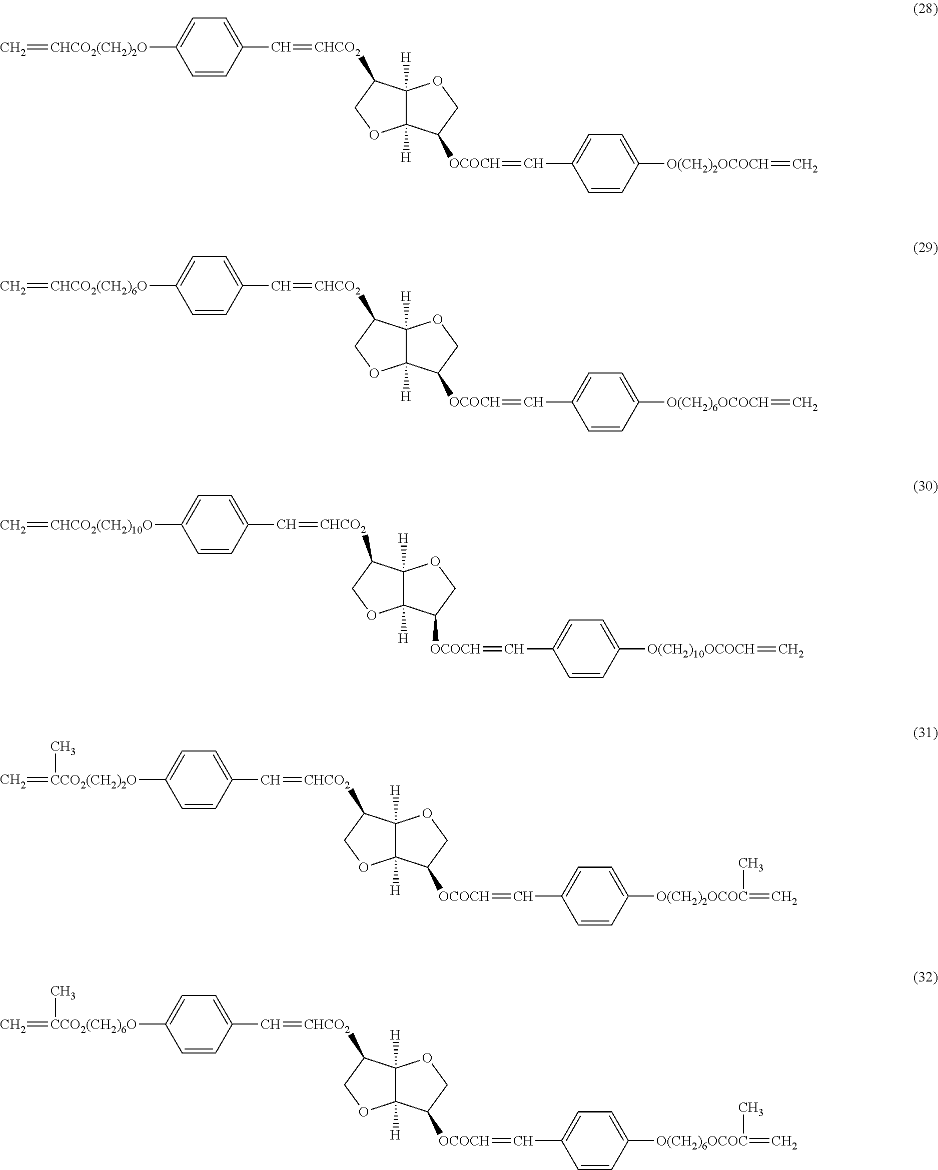

In addition, the photoreactive chiral agent can also be used in combination with a chiral agent having no photoreactivity, such as a chiral compound having a large temperature dependence of the helical twisting power. Examples of known chiral agents having no photoreactivity include chiral agents described in JP2000-44451A, JP1998-509726A (JP-H10-509726A), WO98/00428A, JP2000-506873A, JP1997-506088A (JP-H9-506088A), Liquid Crystals (1996, 21, 327), Liquid Crystals (1998, 24, 219), and the like.

Hereinafter, the action of the polarization diffraction element (liquid crystal layer) will be described.

As described above, in the liquid crystal layer which is formed of the composition containing the liquid crystal compound and has the liquid crystal alignment pattern in which the direction of the optical axis 38A rotates in the arrow A direction, circularly polarized light is refracted, and as the single period A of the liquid crystal alignment pattern decreases, the refraction (diffraction) angle increases.

Therefore, for example, in a case where a pattern is formed such that the single periods A of the liquid crystal alignment patterns are different from each other in different in-plane regions, light which is incident into the different in-plane regions and refracted at different angles such that the brightness of the transmitted light varies depending on the refraction angles. In particular, in a case where the refraction angle is large, the brightness of the transmitted light is low.

On the other hand, in the optical unit according to the embodiment of the present invention, the liquid crystal layer 36 constituting the polarization diffraction element 24 has the liquid crystal alignment pattern in which the orientation of the optical axis derived from the liquid crystal compound rotates in one direction, and further has regions in which the optical axis is twisted and rotates in the thickness direction of the liquid crystal layer and regions having different total magnitudes of twisted angles of rotation in the thickness direction in the plane. The structure in which the optical axis of the liquid crystal compound is twisted and rotates in the thickness direction of the liquid crystal layer can be formed by adding the above-described chiral agent to the liquid crystal composition. In addition, the configuration in which the in-plane regions have different twisted angles in the thickness direction can be formed by adding the above-described photoreactive chiral agent to the liquid crystal composition, and irradiating each region with light at different irradiation amounts. With the polarization diffraction element including such a liquid crystal layer, refractive angle dependence of the amount of transmitted light in the plane is small; and for example, in a case where light incident in different regions in the plane is refracted at different angles, brightness of transmitted light can be increased.

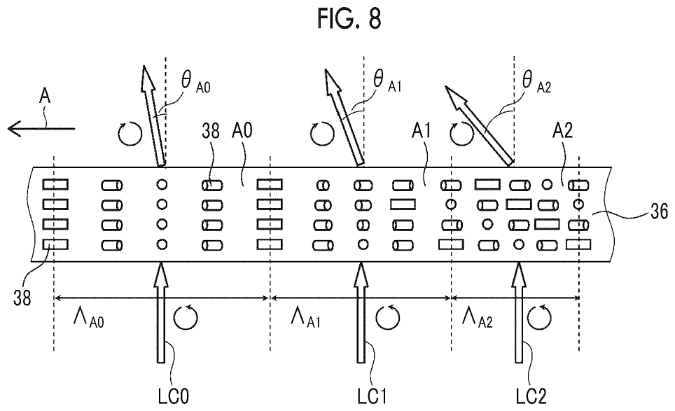

Hereinafter, the action of the polarization diffraction element 24 will be described in detail with reference to the conceptual views of FIG. 8.

In the polarization diffraction element 24, basically, only the liquid crystal layer exhibits the optical action. Therefore, in order to simplify the drawing and to clarify the configuration and the effects, FIG. 8 only shows the liquid crystal layer 36 in the polarization diffraction element 24.

As described above, the liquid crystal layer 36 of the polarization diffraction element 24 refracts incidence light in a predetermined direction to transmit circularly polarized light. In FIG. 8, the incidence light is levorotatory circularly polarized light.

In the portion shown in FIG. 8, the liquid crystal layer 36 has three regions A0, A1, and A2 in order from the left side in FIG. 8, and the respective regions have different lengths A of single periods. Specifically, the length of the single period A decreases in order of the regions A0, A1, and A2. In addition, the regions A1 and A2 have a structure in which the optical axis is twisted and rotates in the thickness direction of the liquid crystal layer. In the following description, the structure in which the optical axis is twisted and rotates in the thickness direction of the liquid crystal layer will also be referred to as “twisted structure”.

The twisted angle of the region A1 in the thickness direction is smaller than the twisted angle of the region A2 in the thickness direction. The region A0 is a region which does not have the twisted structure. That is, the region A0 is a region where the twisted angle is 0°.

The twisted angle is a twisted angle in the entire thickness direction.

In a polarization diffraction element 24A, in a case where levorotatory circularly polarized light LC1 is incident into the in-plane region A1 of the liquid crystal layer 36, as described above, the levorotatory circularly polarized light LC1 is refracted and transmitted at a predetermined angle in the arrow A direction with respect to the incident direction, that is, in the one direction in which the direction of the optical axis of the liquid crystal compound changes while continuously rotating. Similarly, in a case where levorotatory circularly polarized light LC2 is incident into the in-plane region A2 of the liquid crystal layer 36, the levorotatory circularly polarized light LC2 is refracted and transmitted at a predetermined angle in the arrow A direction with respect to the incident direction. Similarly, in a case where levorotatory circularly polarized light LC0 is incident into the in-plane region A0 of the liquid crystal layer 36, the levorotatory circularly polarized light LC0 is refracted and transmitted at a predetermined angle in the arrow A direction with respect to the incident direction.

Regarding the refraction angles by the liquid crystal layer 36, since a single period Λ_{A2} of the liquid crystal alignment pattern in the region A2 is shorter than a single period Λ_{A1} of the liquid crystal alignment pattern in the region A1, as shown in FIG. 8, a refraction angle θ_{A2} of transmitted light in the region A2 with respect to the incidence light is more than a refraction angle θ_{A1} of transmitted light in the region A1 with respect to the incidence light. In addition, since a single period Λ_{A0} of the liquid crystal alignment pattern in the region A0 is longer than the single period Λ_{A1} of the liquid crystal alignment pattern in the region A1, as shown in FIG. 6, a refraction angle θ_{A0} of transmitted light in the region A0 with respect to the incidence light is less than the refraction angle θ_{A1} of transmitted light in the region A1 with respect to the incidence light.

Here, in the diffraction of light by the liquid crystal layer having the liquid crystal alignment pattern in which the orientation of the optical axis of the liquid crystal compound changes while continuously rotating in a plane, there is a problem in that, in a case where the diffraction angle increases, the diffraction efficiency decreases, that is, the intensity of diffracted light decreases.

Therefore, in a case where the liquid crystal layer has regions having different lengths of the single periods, over which the orientation of the optical axis of the liquid crystal compound rotates by 180° in a plane, the diffraction angle varies depending on an incidence position of light, so that the amount of diffracted light varies depending on the incidence position in the plane. That is, a region where the transmitted and diffracted light is dark is provided depending on the incidence position in the plane.

On the other hand, in the present invention, the liquid crystal layer of the polarization diffraction element has a region where the liquid crystal layer is twisted and rotates in the thickness direction, and has regions where the magnitudes of the twisted angles are different in the thickness direction.

In the example shown in FIG. 8, a twisted angle φ_{A2} of the region A2 of the liquid crystal layer 36 in the thickness direction is larger than a twisted angle φ_{A1} of the region A1 in the thickness direction. In addition, the region A0 does not have the twisted structure in the thickness direction.

As a result, a decrease in the diffraction efficiency of refracted light can be suppressed.

In the example shown in FIG. 8, by imparting the twisted structure to the regions A1 and A2 in which the diffraction angle is more than that of the region A0, a decrease in amount of light refracted from the regions A1 and A2 can be suppressed. In addition, the twisted angle of the twisted structure of the region A2 in which the diffraction angle is more than that of the region A1 is adjusted to be more than that of the region A1 such that the decrease in amount of light refracted from the region A2 can be suppressed. As a result, the amounts of light transmitted through the incidence positions in the plane can be made to be uniform.

In the present invention, as described above, in the in-plane region where the refraction by the liquid crystal layer is large, the incidence light is refracted by being transmitted through the layer having a large twisted angle in the thickness direction. On the other hand, in the in-plane region where the refraction by the liquid crystal layer is small, the incidence light is refracted by being transmitted through the layer having a small twisted angle in the thickness direction.

That is, in the liquid crystal layer 36, by setting the twisted angle in the thickness direction in the plane according to the magnitude of refraction by the liquid crystal layer, the brightness of the transmitted light with respect to the incidence light can be increased.

Therefore, with the optical unit according to the embodiment of the present invention, refractive angle dependence of the amount of transmitted light in the plane of the polarization diffraction element 24 can be reduced. That is, with the optical unit of the embodiment of the present invention, the brightness unevenness of the polarization diffraction element 24 in the plane can be reduced. Accordingly, with the optical unit of the embodiment of the present invention, for example, in a case of being used in an image display system such as a VR system, an image with less brightness unevenness of the image to be observed can be displayed.

As described above, the angle of the refracted light in the plane of the liquid crystal layer 36 increases as the single period A of the liquid crystal alignment pattern decreases.

In addition, in the liquid crystal alignment pattern, with regard to the twisted angle of the liquid crystal compound 38 in the thickness direction in the plane of the liquid crystal layer 36, a region with a short single period A over which the orientation of the optical axis 38A rotates 180° in the arrow A direction has a larger area than a region with a long single period A. In the liquid crystal layer 36 in the example shown in the drawing, as an example, as shown in FIG. 8, the single period Λ_{A2} of the liquid crystal alignment pattern in the region A2 of the liquid crystal layer 36 is shorter than the single period Λ_{A1} of the liquid crystal alignment pattern in the region A1, and the twisted angle φ_{A2} in the thickness direction is large. That is, the region A2 side of the liquid crystal layer 36 on the light incidence side largely refracts light.

Accordingly, by setting the twisted angle ϕ in the thickness direction in the plane with respect to the single period A of the liquid crystal alignment pattern as a target, the brightness of transmitted light refracted from different in-plane regions at different angles can be suitably increased.

That is, in the present invention, it is preferable that, in the liquid crystal layer 36, in a region in which the single period in the liquid crystal alignment pattern is shorter, the twisted angle of the liquid crystal compound 38 in the thickness direction (total twisted angles in the thickness direction) is larger.

In the liquid crystal layer 36 in the example shown in the drawing, the single period A of the liquid crystal alignment pattern gradually decreases from the center toward the outer direction. Therefore, it is preferable that the twisted angle of the liquid crystal compound 38 in the thickness direction gradually increases from the center toward the outer direction.

The change in single period Λ and/or the change in twisted angle of the liquid crystal compound 38 in the thickness direction may be stepwise or continuous.

As described above, in the present invention, as the single period Λ of the liquid crystal alignment pattern in the liquid crystal layer 36 is shorter, the refraction angle increases. Therefore, the twisted angle in the thickness direction can be increased in the region where the single period Λ of the liquid crystal alignment pattern decreases, and thus the brightness of transmitted light can be increased.

Therefore, in the optical unit according to the embodiment of the present invention, in regions having different lengths of single periods of the liquid crystal alignment pattern, it is preferable that a permutation of the lengths of the single periods and a permutation of the magnitudes of the twisted angles in the thickness direction are different from each other.

However, the present invention is not limited thereto, and the liquid crystal layer 36 may have regions in which the permutation of the lengths of the single periods and the permutation of the magnitudes of the twisted angles in the thickness direction match each other in the regions where the lengths of the single periods of the liquid crystal alignment pattern are different from each other. In the optical unit according to the embodiment of the present invention, the twisted angle in the thickness direction has a preferred range and may be appropriately set according to the single period Λ of the liquid crystal alignment pattern in the plane.

In the present invention, it is preferable that the liquid crystal layer 36 of the polarization diffraction element 24 has a region where the magnitude of the twisted angle in the thickness direction is 100 to 360°.

In addition, in the present invention, the twisted angle of the liquid crystal layer 36 of the polarization diffraction element 24 in the thickness direction may be appropriately set according to the single period Λ of the liquid crystal alignment pattern in the plane.

Furthermore, in the present invention, the single period Λ of the liquid crystal alignment pattern in the liquid crystal layer 36 may be appropriately set according to the refraction (diffraction) angle required for the polarization diffraction element 24. Here, it is preferable that the liquid crystal layer 36 has a region where the length of the single period is 0.6 μm or less. With such a configuration, the refraction angle of the liquid crystal layer 36 can be increased, a suitable wide FOV can be realized; and according to the present invention, even in a case where the refraction angle is large, a decrease in brightness can be prevented, and brightness unevenness of an image to be observed can be suppressed.

The configuration in which the liquid crystal layer 36 has regions having different twisted angles of the twisted structure in the plane can be formed by using a liquid crystal composition containing a liquid crystal compound and the above-described photoreactive chiral agent in which a helical twisting power (HTP) of a helical structure changes upon irradiation of light, and irradiating each region with light having a wavelength at which the HTP of the chiral agent changes before or during the curing of the liquid crystal composition for forming the liquid crystal layer 36 while changing the irradiation amount.

For example, by using a photoreactive chiral agent in which the HTP decreases upon irradiation of light, the HTP of the chiral agent decreases upon irradiation of light. Here, by changing the irradiation amount of light depending on the regions, for example, in a region where the irradiation amount is high, the decrease in HTP is large, the induction of helix is small, and thus the twisted angle of the twisted structure decreases. On the other hand, in a region where the irradiation amount is small, the decrease in HTP is small, and thus the twisted angle of the twisted structure increases.

The method of changing the irradiation amount of light depending on the regions is not particularly limited, and various methods such as a method of irradiating light through a gradation mask, a method of changing the irradiation time depending on the regions, and a method of changing the irradiation intensity depending on the regions can be used.

The gradation mask refers to a mask in which a transmittance with respect to light for irradiation changes in a plane.

In the present invention, the liquid crystal layer of the polarization diffraction element may have regions where the directions in which the liquid crystal layer is twisted and rotates in the thickness direction (orientations of the twisted angle) are different from each other.

For example, the liquid crystal layer may have a liquid crystal alignment pattern in which the orientation of the optical axis rotates in one direction, may have regions in which the optical axis is twisted and rotates in the thickness direction of the liquid crystal layer, may have the regions have different twisted angles of rotation in a plane, and may have regions in which the directions of twisting and rotation are different from each other in the thickness direction.

In this way, by having regions where the directions of twisting and rotation are different in the thickness direction, in the region having the twisted angle in the thickness direction, transmitted light for incidence light in various polarized states can be efficiently refracted.

In a cross-sectional image obtained by observing a cross section of the liquid crystal layer having the above-described liquid crystal alignment pattern with a scanning electron microscope (SEM) in a thickness direction along a direction in which the optical axis continuously rotates, the liquid crystal layer has bright portions and dark portions, which extend from one surface to the other surface.

In the bright portions and the dark portions, tilt directions and tilt angles vary depending on the presence or absence of the twist of the liquid crystal compound 38 in the thickness direction, the twisted direction, the twisted angle, and the single period of the liquid crystal alignment pattern.

For example, in a case where the liquid crystal compound 38 is not twisted and rotates in the thickness direction as in the above-described region A0, the liquid crystal layer has the bright portions and the dark portions extending in the thickness direction.

In addition, in a case where the liquid crystal compound 38 is twisted and rotates in the thickness direction as in the above-described region A1 and region A2, the liquid crystal layer has the bright portions and the dark portions, which are tilted with respect to the thickness direction. Here, in a case where the twisted direction (rotation direction) of the liquid crystal compound is opposite to each other, the tilt directions of the bright portions and the dark portions are opposite to each other.

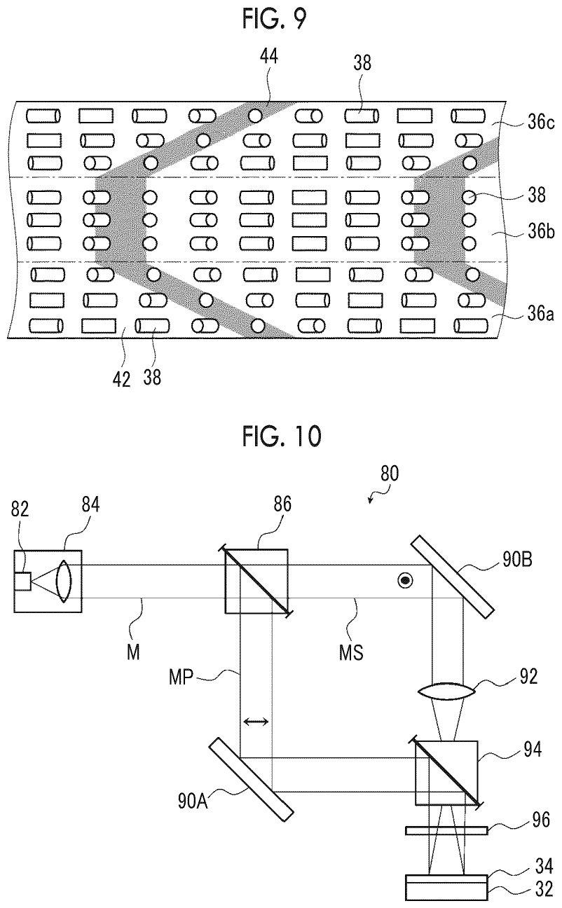

As the liquid crystal layer, for example, as in a liquid crystal layer conceptually shown in FIG. 9, a configuration is exemplified in which a region 36a and a region 36c, in which a twisted direction of the liquid crystal compound 38 in the thickness direction is opposite to each other, sandwich a region 36b in which the liquid crystal compound 38 is not twisted in the thickness direction, to sandwich a region having the bright portion 42 and the dark portion 44 extending in the thickness direction in the regions in which the tilt directions of the bright portion 42 and the dark portion 44 are opposite to each other.

In addition, in the present invention, the configuration in which the liquid crystal layer has a plurality of regions having different twisted directions of the liquid crystal compound 38 is not limited to the regions shown in FIG. 9, and various configurations can be used.

That is, in the present invention, various configurations can be used as the liquid crystal layer, for example, a configuration consisting of two regions of the region 36a in which the twisted directions of the liquid crystal compound 38 in the thickness direction are opposite to each other, and the region 36b; a configuration consisting of four regions in which two of the two regions are laminated; a configuration consisting of two regions of the region 36a and the region 36b in which the liquid crystal compound 38 is not twisted in the thickness direction; a configuration having a plurality of regions in which the tilt directions of the dark portions are the same and the tilt angles, that is, the twisted angles of the liquid crystal compounds are different; and a configuration in which the region 36b in which the liquid crystal compound 38 is not twisted is further laminated on the three regions shown in FIG. 9.

In a case where the liquid crystal layer has the plurality of regions having different twisted directions of the liquid crystal compound 38 as shown in FIG. 9, the twisted angle of the liquid crystal compound 38 in the liquid crystal layer is the sum of magnitudes of the twisted angles of the respective regions.

For example, in the example shown in FIG. 9, in a case where the twisted angle of the liquid crystal compound 38 in the region 36a is 80°, the twisted angle of the liquid crystal compound 38 in the middle region 36b is 0°, and the twisted angle of the liquid crystal compound 38 in the region 36c is −80°, the twisted angle of the liquid crystal compound 38 in the liquid crystal layer is 0° which is “(80°)+(0°)+(−80°)”.

According to the study by the present inventor, even in the liquid crystal layer having the plurality of regions, it is preferable that the absolute value of the sum of the twisted angles of the liquid crystal compound 38 increases toward the peripheral portion.

As described above, the polarization diffraction element 24 includes the substrate 32, the alignment film 34, and the above-described liquid crystal layer 36.

As the substrate 32 constituting the polarization diffraction element 24, various sheet-like materials can be used as long as they can support the alignment film 34 and the liquid crystal layer 36 described below.

As the substrate 32, a transparent support is preferable, and examples thereof include a polyacrylic resin film such as polymethyl methacrylate, a cellulose resin film such as cellulose triacetate, a cycloolefin polymer film (for example, trade name “ARTON”, manufactured by JSR Corporation; or trade name “ZEONOR”, manufactured by Zeon Corporation), polyethylene terephthalate (PET), polycarbonate, and polyvinyl chloride.

The alignment film 34 is formed on the surface of the substrate 32.

The liquid crystal alignment pattern in the liquid crystal layer 36 follows the alignment pattern formed on the alignment film 34. Accordingly, the same alignment pattern as the liquid crystal alignment pattern in the liquid crystal layer 36 is formed in the alignment film 34 for forming the liquid crystal layer having the liquid crystal alignment pattern.

FIG. 10 conceptually shows an example of an exposure device in which the coating film serving as the alignment film 34 (photo-alignment film) for forming the liquid crystal layer 36 is exposed to form an alignment pattern corresponding to the concentric circular liquid crystal alignment pattern in which the optical axis changes while continuously rotating in a radial shape.

An exposure device 80 shown in FIG. 10 includes a light source 84 which includes a laser 82, a polarization beam splitter 86 which splits a laser light M emitted from the laser 82 into an S-polarized light MS and a P-polarized light MP, a mirror 90A which is disposed on an optical path of the P-polarized light MP and a mirror 90B which is disposed on an optical path of the S-polarized light MS, a lens 92 which is disposed on the optical path of the S-polarized light MS, a beam splitter 94, and a λ/4 plate 96.

The P-polarized light MP which is split by the polarization beam splitter 86 is reflected from the mirror 90A to be incident into the beam splitter 94. On the other hand, the S-polarized light MS which is split by the polarization beam splitter 86 is reflected from the mirror 90B and is focused by the lens 92 to be incident into the beam splitter 94.

The P polarized light MP and the S polarized light MS are combined by the beam splitter 94, are converted into dextrorotatory circularly polarized light and levorotatory circularly polarized light by the λ/4 plate 96 depending on the polarization direction, and are incident into the alignment film 34 on the substrate 32.

Due to interference between the dextrorotatory circularly polarized light and the levorotatory circularly polarized light, the polarization state of light with which the alignment film 34 is irradiated periodically changes according to interference fringes. An intersecting angle between dextrorotatory circularly polarized light and levorotatory circularly polarized light changes from the inside to the outside of the concentric circle, so that an exposure pattern in which the pitch (single period) changes from the inner side toward the outer side can be obtained. Accordingly, a radial (concentric) alignment pattern in which the alignment states periodically change is obtained in the alignment film 34.

In the exposure device 80, the single period Λ of the liquid crystal alignment pattern in which the optical axis of the liquid crystal compound 38 continuously rotates by 180° in the one direction can be controlled by changing a focal power of the lens 92, the focal length of the lens 92, the distance between the lens 92 and the alignment film 34, and the like.

In addition, by adjusting the focal power of the lens 92 (F number of the lens 92), the length of the single period of the liquid crystal alignment pattern in which the optical axis continuously rotates in the one direction can be changed.

Specifically, the length of the single period in the liquid crystal alignment pattern in which the optical axis continuously rotates in the one direction can be changed depending on a light spread angle at which light is spread by the lens 92 due to interference with parallel light. More specifically, in a case where the focal power of the lens 92 is decreased, the light is close to the parallel light, so that the length of the single period Λ in the liquid crystal alignment pattern is gradually decreased from the inner side toward the outer side. Conversely, in a case where the focal power of the lens 92 is stronger, the length of the single period Λ in the liquid crystal alignment pattern rapidly decreases from the inner side toward the outer side.

That is, by adjusting the refractive index of the lens 92, the refractive index of the polarization diffraction element 24 (liquid crystal layer 36) can be adjusted to act as a concave lens or a convex lens depending on the turning direction of the incident circularly polarized light.

The liquid crystal composition containing the liquid crystal compound and the photoreactive chiral agent, which is used for forming the above-described liquid crystal layer 36, is applied onto the exposed alignment film 34 formed as described above, dried, exposed using the above-described gradation mask, and cured by ultraviolet irradiation or the like as necessary.

As a result, the liquid crystal layer 36 having the above-described concentric circular liquid crystal alignment pattern, having regions in which the length of the single period of the liquid crystal alignment pattern varies in the plane, having regions in which the liquid crystal compound is twisted and rotates in the thickness direction in the plane, and having regions in which the total magnitudes of the twisted angles are different can be formed, and the polarization diffraction element 24 as shown in FIGS. 2 and 3 can be produced.

Preferable examples of the compound having a photo-aligned group, that is, a photo-alignment material used in a photo-alignment film include: an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking ester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-12823A.

Among these, an azo compound, a photocrosslinking polyimide, a photocrosslinking polyamide, a photocrosslinking ester, a cinnamate compound, or a chalcone compound is suitability used.

The above-described polarization diffraction element 24 includes only one liquid crystal layer 36, but the present invention is not limited thereto.

That is, in the optical unit according to the embodiment of the present invention, the polarization diffraction element may include a plurality of the liquid crystal layers.

For example, a polarization diffraction element including a plurality of the liquid crystal layers and a wavelength selective retardation layer provided between the liquid crystal layers is exemplified.

The wavelength selective retardation layer is a member which converts circularly polarized light in a specific wavelength range into circularly polarized light having an opposite turning direction.

In addition, in the configuration, it is preferable that at least one liquid crystal layer has a single period different from that of other liquid crystal layers, and it is more preferable that all the liquid crystal layers have different single periods A.

The liquid crystal layer having the above-described liquid crystal alignment pattern refracts and transmits circularly polarized light, but a refractive index thereof varies depending on a wavelength of transmitted light. That is, in the red light, the green light, and the blue light, the refractive index (refraction angle) of the red light having the longest wavelength is the highest, and the refractive index of the blue light having the shortest wavelength is the lowest.

Accordingly, in a case where the red light, the green light, and the blue light corresponding to a full color image are incident on one liquid crystal layer, the refractive index, that is, the degree of focusing is different for each light, and there is a possibility that color shift occurs in the image to be observed.

On the other hand, by providing the polarization diffraction element with a plurality of liquid crystal layers and a wavelength selective retardation layer between the liquid crystal layers, the refractive indices of the red light, the green light, and the blue light in the polarization diffraction element, that is, the refraction angles can be made to substantially coincide with each other.

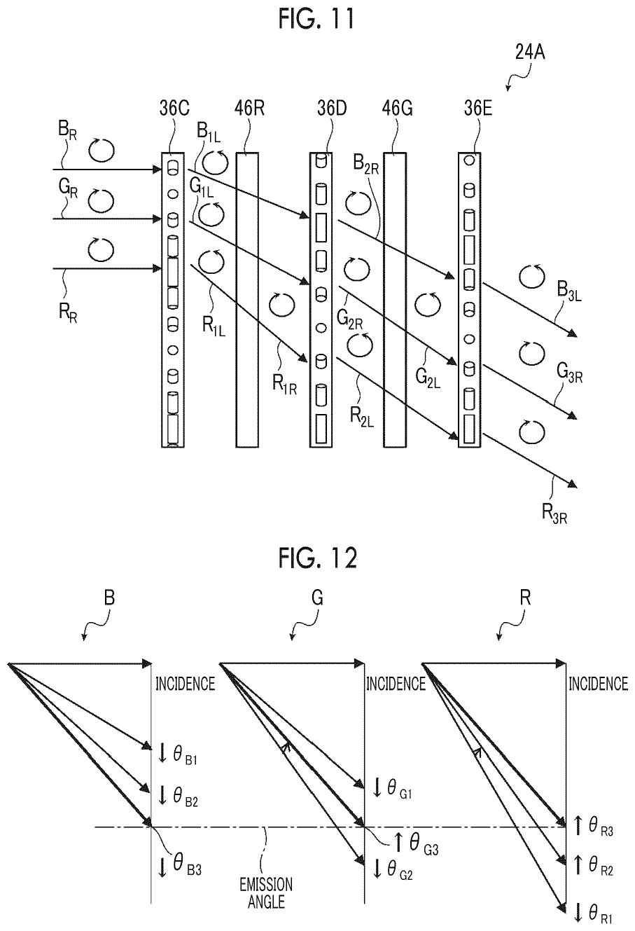

FIG. 11 conceptually shows an example thereof. In order to simplify the drawing, FIG. 11 shows the polarization diffraction element only by the liquid crystal layers and the wavelength selective retardation layer.

In FIG. 11, a polarization diffraction element 24A includes a first liquid crystal layer 36C, a second liquid crystal layer 36D, and a third liquid crystal layer 36E in this order in the traveling direction of light. The single period Λ in the liquid crystal alignment pattern is the shortest in the first liquid crystal layer 36C and the longest in the second liquid crystal layer 36D. Furthermore, in the polarization diffraction element 24A, rotation directions of optical axes of the first liquid crystal layer 36C and the third liquid crystal layer 36E in one direction (arrow A direction) are the same, and a rotation direction of optical axes of the second liquid crystal layer 36D is opposite to that of the first liquid crystal layer 36C and the third liquid crystal layer 36E.

In addition, the polarization diffraction element 24A includes a wavelength selective retardation layer 46R between the first liquid crystal layer 36C and the second liquid crystal layer 36D, and includes a wavelength selective retardation layer 46G between the second liquid crystal layer 36D and the third liquid crystal layer 36E. The wavelength selective retardation layer 46R is a retardation layer which selectively converts a turning direction of circularly polarized light of the red light. On the other hand, the wavelength selective retardation layer 46G is a retardation layer which selectively converts a turning direction of circularly polarized light of the green light.

In the present example, the circularly polarized light incident into the polarization diffraction element 24A is dextrorotatory circularly polarized light. Therefore, the light is refracted in a direction opposite to the levorotatory circularly polarized light described above.

In the polarization diffraction element 24A, in a case where dextrorotatory circularly polarized light R_{R} of the red light, dextrorotatory circularly polarized light G_{R} of the green light, and dextrorotatory circularly polarized light B_{R} of the blue light are incident into the first liquid crystal layer 36C, as described above, they are refracted and converted into levorotatory circularly polarized light R_{1L} of the red light, levorotatory circularly polarized light G_{1L} of the green light, and levorotatory circularly polarized light B_{1L} of the blue light.

Here, as described above, regarding the refraction angle by the first liquid crystal layer 36C, the angle of red light having the longest wavelength is the largest, and the angle of blue light having the shortest wavelength is the smallest. Accordingly, regarding the refraction angle with respect to the incidence light, as shown in FIG. 12, an angle θ_{R1} of red light (R) is the largest, an angle θ_{G1} Of green light (G) is intermediate, and an angle θ_{B1} of blue light (B) is the smallest. In addition, since the single period Λ of the liquid crystal layer is the shortest in the first liquid crystal layer 36C, the refraction angle of each light is the largest in a case of transmitting the first liquid crystal layer 36C.

Next, the levorotatory circularly polarized light R_{1L} of the red light, the levorotatory circularly polarized light G_{1L} of the green light, and the levorotatory circularly polarized light B_{1L} of the blue light, transmitted through the first liquid crystal layer 36C, are incident into the wavelength selective retardation layer 46R.

The wavelength selective retardation layer 46R converts only the circularly polarized light of the red light into circularly polarized light having an opposite turning direction, and allows transmission (passage) of the other light as it is.

Accordingly, in a case where the levorotatory circularly polarized light R_{1L} of the red light, the levorotatory circularly polarized light G_{1L} of the green light, and the levorotatory circularly polarized light B_{1L} of the blue light are incident into and transmitted through the wavelength selective retardation layer 46R, the levorotatory circularly polarized light G_{1L} of the green light and the levorotatory circularly polarized light B_{1L} of the blue light are transmitted through the wavelength selective retardation layer 46R as it is. On the other hand, the levorotatory circularly polarized light R_{1L} of the red light is converted into dextrorotatory circularly polarized light R_{1R} of the red light.

Next, the dextrorotatory circularly polarized light R_{1R} of the red light, the levorotatory circularly polarized light G_{1L} of the green light, and the levorotatory circularly polarized light B_{1L} of the blue light, transmitted through the wavelength selective retardation layer 46R, are incident into the second liquid crystal layer 36D.

In the same manner, the dextrorotatory circularly polarized light R_{1R} of the red light, the levorotatory circularly polarized light G_{1L} of the green light, and the levorotatory circularly polarized light B_{1L} of the blue light, which are incident into the second liquid crystal layer 36D, are also refracted and converted into circularly polarized light having an opposite turning direction such that levorotatory circularly polarized light R_{2L} of the red light, dextrorotatory circularly polarized light G_{2R} of the green light, and dextrorotatory circularly polarized light B_{2R} of the blue light are emitted.

Here, both the green light and the blue light incident into the second liquid crystal layer 36D are levorotatory circularly polarized light. On the other hand, the red light incident into the second liquid crystal layer 36D is dextrorotatory circularly polarized light having a different direction of circularly polarized light, which is converted by the wavelength selective retardation layer 46R, from the green light and the blue light.

In addition, as described above, the rotation directions of the optical axes 30A of the liquid crystal compounds 38 in the first liquid crystal layer 36C and the second liquid crystal layer 36D are opposite to each other.

Therefore, levorotatory circularly polarized light G_{2L} of the green light and levorotatory circularly polarized light B_{2L} of the blue light, which are incident into the second liquid crystal layer 36D, are further refracted in the same direction as above, and are emitted at an angle θ_{G2} and an angle θ_{B2} with respect to the incidence light (the dextrorotatory circularly polarized light G_{R} of the green light and the dextrorotatory circularly polarized light B_{R} of the blue light) as shown in FIG. 12.

On the other hand, as shown on the right side of FIG. 12, the dextrorotatory circularly polarized light R_{1R} of the red light, which is incident into the second liquid crystal layer 36D and having an opposite turning direction, is refracted in a direction opposite to the first liquid crystal layer 36C such that the refraction is returned. As a result, the levorotatory circularly polarized light R_{2L} of the red light, emitted from the second liquid crystal layer 36D, is emitted at an angle θ_{R2} smaller than the angle θ_{R1} with respect to the incidence light (dextrorotatory circularly polarized light R_{R} of red light).

In addition, since the single period Λ of the second liquid crystal layer 36 is the longest, the refraction angle of each light is the smallest in a case of transmitting the second liquid crystal layer 36D.

Next, the levorotatory circularly polarized light R_{2L} of the red light, the dextrorotatory circularly polarized light G_{2R} of the green light, and the dextrorotatory circularly polarized light B_{2R} of the blue light, transmitted through the second liquid crystal layer 36D, are incident into the wavelength selective retardation layer 46R.

The wavelength selective retardation layer 46G converts only green circularly polarized light into circularly polarized light having an opposite turning direction, and allows transmission of the other light as it is.

Accordingly, in a case where the levorotatory circularly polarized light R_{2L} of the red light, the dextrorotatory circularly polarized light G_{2R} of the green light, and the dextrorotatory circularly polarized light B_{2R} of the blue light are incident into and transmitted through the wavelength selective retardation layer 46G, the levorotatory circularly polarized light R_{2L} of the red light and the levorotatory circularly polarized light B_{2R} of the blue light are transmitted through the wavelength selective retardation layer 46G as it is. On the other hand, the dextrorotatory circularly polarized light G_{2R} of the green light is converted into levorotatory circularly polarized light G_{2L} of the green light.

Next, the levorotatory circularly polarized light R_{2L} of the red light, the levorotatory circularly polarized light G_{2L} of the green light, and the dextrorotatory circularly polarized light B_{2R} of the blue light, transmitted through the wavelength selective retardation layer 46G, are incident into the third liquid crystal layer 36E.

In the same manner, the levorotatory circularly polarized light R_{2L} of the red light, the dextrorotatory circularly polarized light G_{2L} of the green light, and the levorotatory circularly polarized light B_{2R} of the blue light, which are incident into the second liquid crystal layer 36D, are also refracted and converted into circularly polarized light having an opposite turning direction such that dextrorotatory circularly polarized light R_{3R} of the red light, dextrorotatory circularly polarized light G_{3R} of the green light, and levorotatory circularly polarized light B_{3L} of the blue light are emitted.

Here, the blue light incident into the third liquid crystal layer 36E is the dextrorotatory circularly polarized light B_{2R} of the blue light. In addition, since the direction of circularly polarized light of the red light is previously converted by the wavelength selective retardation layer 46R, the red light incident into the third liquid crystal layer 36E is the levorotatory circularly polarized light R_{2L} of the red light, which has a direction of circularly polarized light which is different from that of blue light. Furthermore, the green light incident into the third liquid crystal layer 36E is the levorotatory circularly polarized light G_{2L} of the green light, in which the direction of circular polarization is converted by the wavelength selective retardation layer 46G.

That is, the blue light incident into the third liquid crystal layer 36E is dextrorotatory circularly polarized light, and the red light and the green light incident into the third liquid crystal layer 36E are levorotatory circularly polarized light having a direction of circularly polarized light, which is converted by the wavelength selective retardation layer.

In addition, as described above, the rotation directions of the optical axes 30A of the liquid crystal compounds 38 in the second liquid crystal layer 36D and the third liquid crystal layer 36E are opposite to each other.

Therefore, as shown in FIGS. 11 and 12, the dextrorotatory circularly polarized light B_{2R} of the blue light, incident into the third liquid crystal layer 36E, is further refracted in the same direction and is emitted at an angle θ_{B3} with respect to the incidence light (dextrorotatory circularly polarized light B_{R} of blue light) as shown in FIG. 10.

On the other hand, in a case where the levorotatory circularly polarized light R_{2L} of the red light, having an opposite direction of circular polarization, is incident into the third liquid crystal layer 36E, the levorotatory circularly polarized light R_{2L} is further refracted to be returned. As a result, the dextrorotatory circularly polarized light R_{3R} of the red light, emitted from the third liquid crystal layer 36E, is emitted at an angle θ_{R3} smaller than the above angle θ_{R2} with respect to the incidence light (dextrorotatory circularly polarized light R_{R} of red light).

Similarly, in a case where the levorotatory circularly polarized light G_{2L} of the green light, which is opposite in circular polarization to the blue light, is incident into the third liquid crystal layer 36E, the levorotatory circularly polarized light G_{2L} is refracted to be returned to the opposite direction as shown in the center of FIG. 7. As a result, the dextrorotatory circularly polarized light G_{3R} of the green light, emitted from the third liquid crystal layer 36E, is emitted at an angle θ_{G3} smaller than the above angle θ_{G2} with respect to the incidence light (dextrorotatory circularly polarized light G_{R} of green light).

That is, in the polarization diffraction element 24A, red light having the longest wavelength range and the largest refraction by the liquid crystal layer is refracted by the first liquid crystal layer 36C, and then is refracted twice in a direction opposite to the first liquid crystal layer 36C by the second liquid crystal layer 36D and the third liquid crystal layer 36E.

In addition, the green light having the second longest wavelength range and the second largest refraction by the liquid crystal layer is refracted in the same direction by the first liquid crystal layer 36C and the second liquid crystal layer 36D, and then is refracted once in the opposite direction by the third liquid crystal layer 36E.

Furthermore, the blue light having the shortest wavelength range and the lowest refraction by the liquid crystal layer is refracted three times in the same direction by the first liquid crystal layer 36C, the second liquid crystal layer 36D, and the third liquid crystal layer 36E.

In this way, in the polarization diffraction element 24A, initially, all the light components are largely refracted in the same direction. Thereafter, in accordance with the magnitude of refraction by the liquid crystal layer depending on the wavelength, the light having the longest wavelength is refracted the most multiple times so as to return to a direction opposite to the initial refraction direction. As the wavelength of light decreases, the number of times of refraction which returns to the direction opposite to the initial refraction direction is reduced. Regarding the light having the shortest wavelength, the number of times of refraction which returns to the direction opposite to the initial refraction direction is the smallest. As a result, the refraction angle θ_{R3} of the red light, the refraction angle θ_{G3} of the green light, and the refraction angle θ_{B3} of the blue light, with respect to the incidence light, can be made to be very close to each other.

Therefore, with the polarization diffraction element 24A including the plurality of liquid crystal layers and the wavelength selective retardation layer, incident red light, blue light, and green light can be refracted at substantially the same angle and emitted in substantially the same direction.

In a case where light components having three wavelength ranges are targets as in the polarization diffraction element 24A of the example shown in the drawing, a designed wavelength of light having the longest wavelength is denoted by λa, a designed wavelength of light having the intermediate wavelength is denoted by λb, a designed wavelength of light having the shortest wavelength is denoted by λc (λa>λb>λc), the single period of the liquid crystal alignment pattern in the first liquid crystal layer is denoted by Λ₁, the single period of the liquid crystal alignment pattern in the second liquid crystal layer is denoted by Λ₂, and the single period of the liquid crystal alignment pattern in the liquid crystal layer is denoted by Λ₃, emission directions of light components having two wavelength ranges can be made to be substantially the same by satisfying the following expressions.

$${Λ}_{2} = [ ( λ a + λ c ) λ b / ( λ a - λ b ) λ c ] {Λ}_{1} ,$$

$${Λ}_{3} = [ ( λ a + λ c ) λ b / ( λ b - λ c ) λ a ] {Λ}_{1}$$

In the expression, any one of the first liquid crystal layer or the third liquid crystal layer may be the first layer.

In the present invention, as described above, the wavelength selective retardation layer is a member which converts circularly polarized light in a specific wavelength range into circularly polarized light having an opposite turning direction.

In other words, the wavelength selective retardation layer shifts only a phase in a specific wavelength range by π. The wavelength selective retardation layer will also be referred to as, for example, a λ/2 plate which acts only in a specific wavelength range.

The wavelength selective retardation layer can be produced, for example, by laminating a plurality of phase difference plates having different phase differences.

As the wavelength selective retardation layer, for example, a wavelength selective retardation layer described in JP2000-510961A, SID 99 DIGEST, pp. 1072 to 1075, or the like can be used.

In the wavelength selective retardation layer, a plurality of phase difference layers (retardation layers) having different slow axis angles (slow axis directions) are laminated such that linearly polarized light in a specific wavelength range into linearly polarized light having an opposite turning direction. The plurality of phase difference plates are not limited to the configuration in which all the slow axis angles are different from each other; and for example, a slow axis angle of at least one phase difference plate may be different from that of another phase difference plate.

It is preferable that at least one phase difference plate has normal dispersibility. In a case where at least one phase difference plate has normal dispersibility, by laminating a plurality of phase difference plates at different slow axis angles, λ/2 plate which acts only in a specific wavelength range can be realized.

On the other hand, the wavelength selective retardation layer described in JP2000-510961A, SID 99 DIGEST, pp. 1072 to 1075, or the like can selectively convert linearly polarized light into linearly polarized light having an opposite turning direction.

Here, in the present invention, the wavelength selective retardation layer is a layer which converts circularly polarized light in a specific wavelength range into circularly polarized light having an opposite turning direction. Therefore, it is preferable that a V/4 plate is provided on both surfaces of the wavelength selective retardation layer described in JP2000-510961A, SID 99 DIGEST, pp. 1072 to 1075, or the like for use.

As the λ/4 plate, various phase difference plates, for example, a cured layer, a structural birefringence layer, or the like of a polymer or a liquid crystal compound can be used.

It is preferable that the λ/4 plate has reverse dispersibility. In a case where the λ/4 plate has reverse dispersibility, incidence light in a wide wavelength range can be handled. As the λ/4 plate, a retardation layer in which a plurality of phase difference plates are laminated to actually function as a λ/4 plate are preferably used. For example, a broadband λ/4 plate described in WO2013/137464A, in which a λ/2 plate and a λ/4 plate are used in combination, can handle with incidence light in a wide wavelength range and can be preferably used.

Examples of another configuration in which the polarization diffraction element includes a plurality of liquid crystal layers include a configuration in which a plurality of liquid crystal layers are used to diffract polarized light in a specific wavelength range and not diffract polarized light in a wavelength range different from the specific wavelength range.

For example, a red liquid crystal layer which diffracts only red light and does not diffract light in other wavelength ranges, a green liquid crystal layer which diffracts only green light and does not diffract light in other wavelength ranges, and a blue liquid crystal layer which diffracts only blue light and does not diffract light in other wavelength ranges are used, and refractive indices (refraction angles) of corresponding light components are made to match with each other in the red liquid crystal layer, the green liquid crystal layer, and the blue liquid crystal layer.

As a result, the refractive indices of the red light, the green light, and the blue light, which are incident into and refracted by the polarization diffraction element, can be made to match each other, and thus the three colors of light can be focused in the same manner.

The liquid crystal layer which diffracts polarized light in a specific wavelength range and does not diffract polarized light in a wavelength range different from the specific wavelength range can be produced, for example, by laminating a plurality of liquid crystal layers having different twisted angles and/or film thicknesses.

As an example, a configuration using a plurality of liquid crystal layers, described in Proc. SPIE 11472, Liquid Crystals XXIV, 1147219, and the like, can be used.

The polarization diffraction element diffracts polarized light in a specific wavelength range and does not diffract polarized light in a wavelength range different from the specific wavelength range, by laminating a plurality of liquid crystal layers having different twisted angles and/or film thicknesses. For example, in Proc. SPIE 11472, Liquid Crystals XXIV, 1147219, the polarization diffraction element which diffracts polarized light in a specific wavelength range is achieved by alternately laminating a liquid crystal layer without twist and a liquid crystal layer with twist, and appropriately setting a film thickness of each liquid crystal layer.

In the optical unit and the image display system 10 shown in FIG. 1, the circularly reflective polarizer 20 is used as the second partial reflection element, but the present invention is not limited thereto.

That is, in the optical unit (image display system) according to the embodiment of the present invention, a reflective polarizer which reflects linearly polarized light in a predetermined direction and allows transmission of the other may be used as the second partial reflection element.

FIG. 13 conceptually shows an example thereof. In an image display system 50 shown in FIG. 13, the same members as those of the image display system 10 described above are widely used, so that the same members are represented by the same reference numerals, and different members will be mainly described below.

An optical unit 50 shown in FIG. 13 includes the image display device 12, the circular polarizer consisting of the linear polarizer 14 and the λ/4 wavelength plate 16, the half mirror 18, a λ/4 wavelength plate 52, a reflective polarizer 54, a λ/4 wavelength plate 56, and the polarization diffraction element 24.

Even in the present example, the half mirror 18 is the first partial reflection element in the present invention, and the polarization diffraction element 24 is the polarization diffraction element in the present invention. In addition, as described above, the reflective polarizer 54 is the second partial reflective element in the present invention. Accordingly, in the image display system 50 in the example shown in the drawing, the half mirror 18, the reflective polarizer 54, and the polarization diffraction element 24 constitute the optical unit according to the embodiment of the present invention.

In the image display system 50 shown in FIG. 13, light emitted from the image display device 12, that is, a displayed image is converted into, for example, dextrorotatory circularly polarized light by the circular polarizer consisting of the linear polarizer 14 and the λ/4 wavelength plate 16.

Next, the dextrorotatory circularly polarized light is incident into the half mirror 18, and a part of the dextrorotatory circularly polarized light is transmitted through the half mirror 18. Next, the dextrorotatory circularly polarized light transmitted through the half mirror 18 is converted into, for example, linearly polarized light in the up-down direction in the drawing by the λ/4 wavelength plate 52. As the λ/4 wavelength plate 52 and the λ wavelength plate 56, various known wavelength plates can be used as in the λ/4 wavelength plate 16.

Next, the linearly polarized light is incident into the reflective polarizer 54. The reflective polarizer 54 reflects linearly polarized light in the up-down direction in the drawing, and allows the transmission of other light. Therefore, the incident linearly polarized light in the up-down direction in the drawing is reflected by the reflective polarizer 54. That is, the optical path is folded.

The linearly polarized light in the up-down direction in the drawing, which is reflected by the reflective polarizer 54, that is, in which the optical path is folded is incident into the λ/4 wavelength plate 52 again. As described above, the λ/4 wavelength plate 52 converts the dextrorotatory circularly polarized light into linearly polarized light in the up-down direction in the drawing. Therefore, the linearly polarized light in the up-down direction in the drawing, which incident into the λ/4 wavelength plate 52, is converted into dextrorotatory circularly polarized light.

The dextrorotatory circularly polarized light is incident into the half mirror 18 again, and a part of the dextrorotatory circularly polarized light is reflected by the half mirror 18. In addition, due to the reflection, the dextrorotatory circularly polarized light is converted into levorotatory circularly polarized light.

The levorotatory circularly polarized light reflected by the half mirror 18 is incident into the λ/4 wavelength plate 52 again.

As described above, the λ/4 wavelength plate 52 converts the dextrorotatory circularly polarized light into linearly polarized light in the up-down direction in the drawing. Therefore, the levorotatory circularly polarized light incident on the λ/4 wavelength plate 52 is converted into linearly polarized light in the direction perpendicular to the paper surface. Next, the linearly polarized light in the direction perpendicular to the paper surface, which is converted by the λ/4 wavelength plate 52, is incident into the reflective polarizer 54. As described above, the reflective polarizer 54 reflects linearly polarized light in the up-down direction in the drawing. Therefore, the linearly polarized light in the direction perpendicular to the incident paper surface transmits the reflective polarizer 54, and is incident into the polarization diffraction element 24.

Next, the linearly polarized light in the direction perpendicular to the paper surface, which has been incident into the polarization diffraction element 24, is incident into the λ/4 wavelength plate 56. For example, the/4 wavelength plate 56 converts linearly polarized light in the direction perpendicular to the paper surface into levorotatory circularly polarized light.

Accordingly, the linearly polarized light in the direction perpendicular to the paper surface converts the light into levorotatory circularly polarized light, and the levorotatory circularly polarized light is incident into the polarization diffraction element 24.

As described above, the polarization diffraction element 24 focuses the levorotatory circularly polarized light and diffuses the dextrorotatory circularly polarized light. Therefore, in the same manner as above, the levorotatory circularly polarized light incident into the polarization diffraction element 24 is focused by the polarization diffraction element 24, and is observed by the user U.

Even in the image display system 50, the polarization diffraction element 24 focuses light to realize a wide FOV.

As the reflective polarizer 54, a known reflective polarizer (reflective linear polarizer) can be used as long as it selectively reflects linearly polarized light in a certain direction in a visible light wavelength range and allows transmission of the other light.

Examples of the reflective polarizer 54 include a film obtained by stretching a dielectric multi-layer film, as described in JP2011-053705A, and a wire grid type polarizer.

In addition, as the reflective polarizer 54, a commercially available product can be suitably used. Examples of the commercially available product of the reflective type polarizer include a reflective type polarizer (trade name: APF) manufactured by 3M and a wire grid type polarizer (trade name: WGF) manufactured by AGC Inc.

The optical unit according to the embodiment of the present invention may further include a circularly polarizing plate in addition to the first partial reflection element, the second partial reflection element, and the polarization diffraction element. In this configuration, the first partial reflection element, the second partial reflection element, the polarization diffraction element, and the circularly polarizing plate are provided in this order.

FIG. 14 conceptually shows an example thereof.

FIG. 14 shows an example in which the configuration including the circularly polarizing plate is applied to the image display system 10 shown in FIG. 1, but the same configuration can also be used in the image display system 50 shown in FIG. 13.

An image display system 10A shown in FIG. 14 further includes a circularly polarizing plate 58 downstream of the polarization diffraction element 24, that is, between the polarization diffraction element 24 and the user U, in the image display system 10 shown in FIG. 1.

The circularly polarizing plate has a linear polarizer and a λ/4 wavelength plate, similar to the circularly polarizing plate disposed downstream of the image display device 12.

As described above, in the image display system 10, the circularly reflective polarizer 20 is a circularly reflective polarizer which selectively reflects dextrorotatory circularly polarized light and allows transmission of levorotatory circularly polarized light. Here, in the image display system 10, all of dextrorotatory circularly polarized light transmitted through the half mirror 18 may not be reflected by the circularly reflective polarizer 20, and a part of the dextrorotatory circularly polarized light may be unnecessarily transmitted.

The dextrorotatory circularly polarized light unnecessarily transmitted through the circularly reflective polarizer 20 in this way is focused by the polarization diffraction element 24 with appropriate light, is observed by the user U as leakage light (ghost), and thus causes a decrease in image quality.

On the other hand, in the image display system 10A (optical unit) shown in FIG. 14, the circularly polarizing plate 58 is provided downstream of the polarization diffraction element 24.

Therefore, the dextrorotatory circularly polarized light unnecessarily transmitted through the circularly reflective polarizer 20 can be converted into linearly polarized light which is not transmitted through the linear polarizer by the λ/4 wavelength plate, and thus can be shielded, preferably absorbed, by the linear polarizer.

Therefore, in the image display system 10A including the circularly polarizing plate 58 downstream of the polarization diffraction element 24, the circularly polarized light unnecessarily transmitted through the circularly reflective polarizer 20 is prevented from being observed by the user U as the leakage light, and a high-quality image can be displayed.

The circularly polarizing plate 58 for preventing the leakage light may be provided between the circularly reflective polarizer 20 and the polarization diffraction element 24.

In this case, the circularly polarizing plate 58 is provided downstream of the circularly reflective polarizer 20, and the λ/4 wavelength plate for converting the linearly polarized light into levorotatory circularly polarized light is provided downstream of the circularly polarizing plate 58.

The circularly polarizing plate for preventing the leakage light may be provided on both the downstream side of the polarization diffraction element and between the circularly reflective polarizer 20 and the polarization diffraction element 24.

The optical unit according to the embodiment of the present invention may further include an optical element in addition to the first partial reflection element, the second partial reflection element, and the polarization diffraction element. In this configuration, the optical element, the first partial reflection element, the second partial reflection element, and the polarization diffraction element are provided in this order.

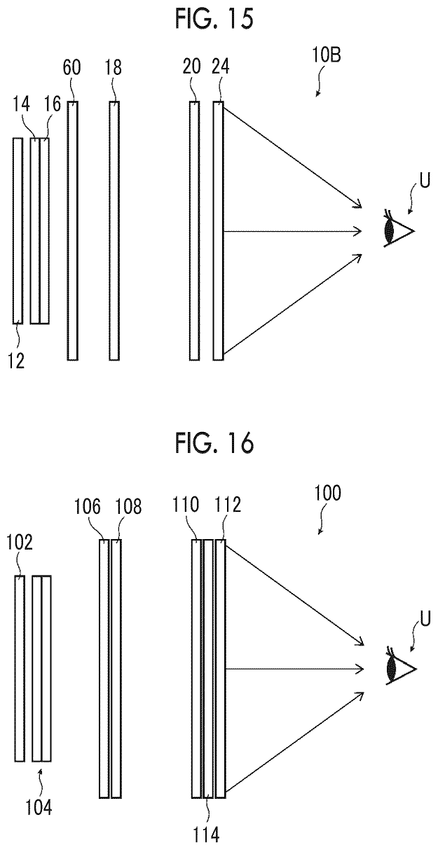

FIG. 15 conceptually shows an example thereof.

FIG. 15 shows an example in which the configuration including the optical element is applied to the image display system 10 shown in FIG. 1, but the same configuration can also be used in the image display system 50 shown in FIG. 13.

An image display system 10B shown in FIG. 15 further includes an optical element 60 upstream of the half mirror 18, that is, between the image display device 12 (circularly polarizing plate) and the half mirror 18 in the image display system 10 shown in FIG. 1.

The optical element 60 has a function of refracting incidence light and has regions having different refractive indices at different positions in a plane.

It is preferable that the optical element 60 includes a liquid crystal layer formed of a liquid crystal composition containing a liquid crystal compound, the liquid crystal layer has a liquid crystal alignment pattern in which an orientation of an optical axis derived from the liquid crystal compound changes while continuously rotating in at least one in-plane direction, and in the liquid crystal alignment pattern, in a case where a length over which the orientation of the optical axis derived from the liquid crystal compound rotates by 180° in a plane is set as a single period, the liquid crystal layer has regions having different lengths of the single periods in the plane.

That is, the optical element 60 is preferably an optical element in which the polarization diffraction element of the present invention described above does not have a region where the orientation of the optical axis derived from the liquid crystal compound is twisted in the thickness direction and rotates, and is a so-called general liquid crystal diffraction lens.

In the image display system, in order to widen FOV, it is necessary to deflect light passing through an end part side of the optical unit more greatly. Therefore, there is a concern that the brightness decreases toward the end part side of the displayed image.

On the other hand, by providing the optical element 60 at the uppermost stream of the optical unit, that is, between the image display device 12 (circularly polarizing plate) and the half mirror 18 (first partial reflection element), the light emitted from the image display device 12 is given directivity according to the in-plane position, and the brightness on the end part side of the displayed image can be improved to make the brightness distribution uniform.

In the optical unit (image display system) according to the embodiment of the present invention, the position of the optical element 60 is not limited to the position shown in FIG. 15. For example, in a case where the image display device 12 is a liquid crystal display device, the optical element 60 may be disposed between a backlight unit and a liquid crystal display panel. Even with this configuration, the light emitted from the image display device 12 can be made to have directivity; and similarly, the brightness on the end part side of the displayed image can be improved to make the brightness distribution uniform.

In addition, the optical unit (image display system) according to the embodiment of the present invention may include only one of the circularly polarizing plate 58 or the optical element 60, or may include both the circularly polarizing plate 58 and the optical element 60.

The optical unit and image display system according to the embodiment of the present invention have been described in detail above, but the present invention is not limited to the above-described examples, and various improvements and changes may be made without departing from the spirit of the present invention.

### EXAMPLES

Hereinafter, the characteristics of the present invention will be described in detail by Examples. Materials, chemicals, used amounts, material amounts, ratios, treatment details, treatment procedures, and the like shown in the following examples can be appropriately changed within a range not departing from the scope of the present invention. Therefore, the scope of the present invention should not be construed as being limited to the following specific examples.

### Comparative Example 1

### <Production of Polarization Diffraction Element>

### (Support)

A glass substrate was used as a support.

### (Formation of Alignment Film)

The following coating liquid for forming an alignment film was applied onto the support by spin coating. The support on which the coating film of the alignment film-forming coating liquid was formed was dried using a hot plate at 60° C. for 60 seconds. As a result, an alignment film was formed.

Alignment film-forming coating liquid

| | |
|---|---|
| Material A for photo-alignment | 1.00 part by mass |
| Water | 16.00 parts by mass |
| Butoxyethanol | 42.00 parts by mass |
| Propylene glycol monomethyl ether | 42.00 parts by mass |

Material A for photo-alignment

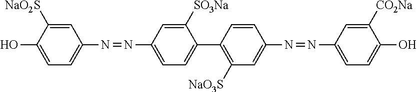

### (Exposure of Alignment Film)

The alignment film was exposed using the exposure device shown in FIG. 10 to form an alignment film P-1 having a concentric circular alignment pattern.

In the exposure device, a laser which emits laser beam having a wavelength (355 nm) was used as the laser. An exposure amount of the interference light was set to 1,000 mJ/cm².

### (Formation of Liquid Crystal Layer)

As a liquid crystal composition forming a first liquid crystal layer (first region), the following composition A-1 was prepared.

Composition A-1

| | |
|---|---|
| Liquid crystal compound L-1 | 10.00 parts by mass |
| Liquid crystal compound L-2 | 90.00 parts by mass |
| Chiral agent C1 | 0.73 parts by mass |
| Polymerization initiator (manufactured by BASF, Irgacure OXE 01) | 1.00 part by mass |
| Surfactant F1 | 0.30 parts by mass |
| Methyl ethyl ketone | 550.00 parts by mass |
| Cyclopentanone | 550.00 parts by mass |

[]Liquid crystal compound L-1 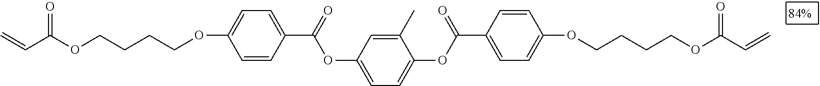 [SMILES: C=CC(=O)OCCCCOc1ccc(C(=O)Oc2ccc(OC(=O)c3ccc(OCCCCOC(=O)C=C)cc3)c(C)c2)cc1] 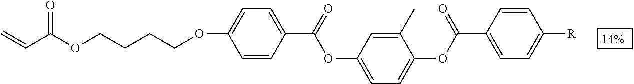 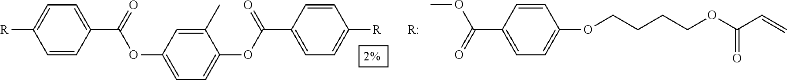
Liquid crystal compound L-2 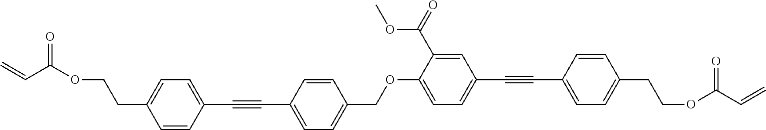 [SMILES: C=CC(=O)OCCc1ccc(C#Cc2ccc(COc3ccc(C#Cc4ccc(CCOC(=O)C=C)cc4)cc3C(=O)OC)cc2)cc1]
Chiral agent C1 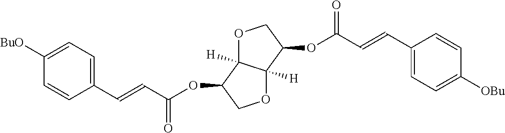
Surfactant F1

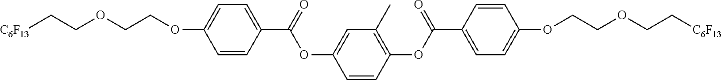

A liquid crystal layer was formed by applying the composition A-1 onto the alignment film P-1 in multiple layers.

The application in multiple layers refers to repetition of processes including producing a first liquid crystal immobilized layer by applying the first layer-forming composition A-1 onto the alignment film, heating the composition A-1, and irradiating the composition A-1 with ultraviolet light for curing; and producing a second or subsequent liquid crystal immobilized layer by applying the second or subsequent layer-forming composition A-1 onto the formed liquid crystal immobilized layer, heating the composition A-1, and irradiating the composition A-1 with ultraviolet light for curing as described above. Even in a case where the liquid crystal layer was formed by the application of the multiple layers such that the total thickness of the liquid crystal layer was large, the alignment direction of the alignment film was reflected from a lower surface of the liquid crystal layer to an upper surface thereof.

Regarding a first layer, the above-described composition A-1 was applied onto the alignment film P-1 to form a coating film, the coating film was heated to 80° C. on a hot plate, the coating film was irradiated with ultraviolet rays having a wavelength of 365 nm at an irradiation amount of 300 mJ/cm² using a high-pressure mercury lamp in a nitrogen atmosphere, thereby fixing the alignment of the liquid crystal compound.

Regarding the second or subsequent layer, the composition was applied onto the liquid crystal immobilized layer, and heated, and cured with ultraviolet rays under the same conditions as described above to produce a liquid crystal immobilized layer. In this way, by repeating the application multiple times until the total thickness reached a desired film thickness, the liquid crystal layer was formed.

A birefringence index Δn of the cured layer of the liquid crystal composition A-1 was obtained by applying the liquid crystal composition A-1 onto a support with an alignment film for retardation measurement, which was prepared separately, aligning a director of the liquid crystal compound to be parallel to the base material, irradiating the liquid crystal composition A-1 with ultraviolet rays for immobilization to obtain a liquid crystal immobilized layer (cured layer), and measuring a retardation value and a film thickness of the liquid crystal immobilized layer. An could be calculated by dividing the retardation value by the film thickness. The retardation value was measured by measuring a desired wavelength using Axoscan (manufactured by Axometrix, inc.) and measuring the film thickness using a SEM.

In the liquid crystal layer, Δn₅₅₀×thickness (Re(550)) of the liquid crystals was finally 150 nm, and it was confirmed using a polarization microscope that periodic alignment occurred on the surface. In addition, in the liquid crystal layer, a twisted angle of the liquid crystal compound in the thickness direction was −83°. In the liquid crystal alignment pattern of the liquid crystal layer, regarding a single period over which the optical axis of the liquid crystal compound rotated by 180°, a single period of a portion at a distance of 4 mm from the center was 1.74 μm; a single period of a portion at a distance of 15 mm from the center was 0.64 μm; a single period of a portion at a distance of 18 mm from the center was 0.59 μm; and the single period decreased toward the outer direction.

As a liquid crystal composition forming a second liquid crystal layer (second region), the following composition A-2 was prepared.

Composition A-2

| | | |
|---|---|---|
| Liquid crystal compound L-1 | 10.00 | parts by mass |
| Liquid crystal compound L-2 | 90.00 | parts by mass |
| Chiral agent C1 | 0.02 | parts by mass |
| Polymerization initiator (manufactured by | 1.00 | part by mass |
| BASF, Irgacure OXE01) | | |
| Surfactant F1 | 0.30 | parts by mass |
| Methyl ethyl ketone | 550.00 | parts by mass |
| Cyclopentanone | 550.00 | parts by mass |

A second liquid crystal layer was formed by the same method as that of the first liquid crystal layer, except that the composition A-2 was used and the film thickness of the liquid crystal layer was adjusted.

In the liquid crystal layer, Δn₅₅₀×thickness (Re(550)) of the liquid crystals was finally 335 nm, and it was confirmed using a polarization microscope that periodic alignment occurred on the surface. In addition, in the liquid crystal layer, a twisted angle of the liquid crystal compound in the thickness direction was −5°. In the liquid crystal alignment pattern of the liquid crystal layer, regarding a single period over which the optical axis of the liquid crystal compound rotated by 180°, a single period of a portion at a distance of 4 mm from the center was 1.74 μm; a single period of a portion at a distance of 15 mm from the center was 0.64 μm; a single period of a portion at a distance of 18 mm from the center was 0.59 μm; and the single period decreased toward the outer direction.

As a liquid crystal composition forming a third liquid crystal layer (third region), the following composition A-3 was prepared.

Composition A-3

| | |
|---|---|
| Liquid crystal compound L-1 | 10.00 parts by mass |
| Liquid crystal compound L-2 | 90.00 parts by mass |
| Chiral agent C2 | 0.57 parts by mass |
| Polymerization initiator (manufactured by BASF, Irgacure OXE01) | 1.00 part by mass |
| Surfactant F1 | 0.30 parts by mass |
| Methyl ethyl ketone | 550.00 parts by mass |
| Cyclopentanone | 550.00 parts by mass |

Chiral agent C2

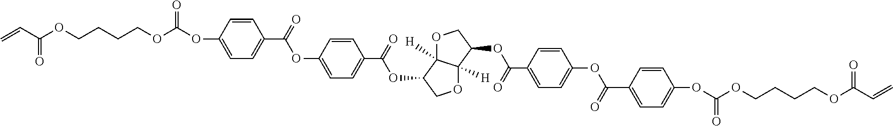 [SMILES: C=CC(=O)OCCCCOC(=O)Oc1ccc(C(=O)Oc2ccc(C(=O)O[C@H]3CO[C@H]4[C@@H]3OC[C@H]4OC(=O)c3ccc(OC(=O)c4ccc(OC(=O)OCCCCOC(=O)C=C)cc4)cc3)cc2)cc1]

A second liquid crystal layer was formed by the same method as that of the first liquid crystal layer, except that the composition A-3 was used and the film thickness of the liquid crystal layer was adjusted, thereby obtaining a polarization diffraction element 1.

In the liquid crystal layer, Δn₅₅₀×thickness (Re(550)) of the liquid crystals was finally 170 nm, and it was confirmed using a polarization microscope that periodic alignment occurred on the surface. In addition, in the liquid crystal layer, a twisted angle of the liquid crystal compound in the thickness direction was 78°. In the liquid crystal alignment pattern of the liquid crystal layer, regarding a single period over which the optical axis of the liquid crystal compound rotated by 180°, a single period of a portion at a distance of 4 mm from the center was 1.74 μm; a single period of a portion at a distance of 15 mm from the center was 0.64 μm; a single period of a portion at a distance of 18 mm from the center was 0.59 μm; and the single period decreased toward the outer direction.

In the formed first to third liquid crystal layers, the total value of the twisted angles of the liquid crystal compounds in the thickness direction was −10° at a distance of 4 mm from the center, −10° at a distance of 15 mm from the center, and −10° at a distance of 18 mm from the center.

### [Production of Circularly Reflective Polarizer]

### [Preparation of Coating Liquid for Reflective Layer]

### <Coating Liquid R-1 for Reflective Layer>

A composition shown below was stirred and dissolved in a container held at 70° C. to prepare a coating liquid R-1 for a reflective layer. Here, R represents a coating liquid containing a rod-like liquid crystal compound.

Coating liquid R-1 for reflective layer

| | |
|---|---|
| Methyl ethyl ketone | 120.9 parts by mass |
| Cyclohexanone | 21.3 parts by mass |
| Rod-like liquid crystal compound L-1 | 100.0 parts by mass |
| Photopolymerization initiator B | 1.00 part by mass |
| Chiral agent A | 3.45 parts by mass |
| Surfactant F1 | 0.067 parts by mass |
| Surfactant F2 | 0.027 parts by mass |

Chiral agent A 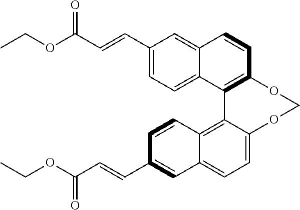
Surfactant F2 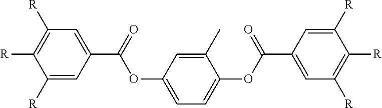 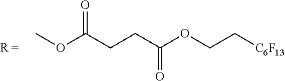
Photopolymerization initiator B

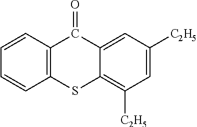 [SMILES: CCc1cc(CC)c2sc3ccccc3c(=O)c2c1]

The chiral agent A was a chiral agent in which helical twisting power (HTP) was reduced by light.

### <Coating Liquid R-2 to R-4 for Reflective Layer>

A coating liquid was prepared in the same manner as in the coating liquid R-1 for a reflective layer, except that the amount of the chiral agent A added was changed as shown in Table 1 below.

### <<Amount of Chiral Agent in Coating Liquid Containing Rod-Like Liquid Crystal Compound>>

TABLE 1

| | Amount of chiral amount |
|---|---|
| Coating liquid name | (part by mass) |
| Liquid R-1 | 3.45 |
| Liquid R-2 | 3.05 |

### <Coating Liquid D-1 for Reflective Layer>

A composition shown below was stirred and dissolved in a container held at 50° C. to prepare a coating liquid D-1 for a reflective layer. Here, D represents a coating liquid containing a disk-like liquid crystal compound.

Coating liquid D-1 for reflective layer

| | |
|---|---|
| Disk-like liquid crystal compound (A) | 80 parts by mass |
| Disk-like liquid crystal compound (B) | 20 parts by mass |
| Polymerizable monomer E1 | 10 parts by mass |
| Surfactant F4 | 0.3 parts by mass |
| Photopolymerization initiator (manufactured by | 3 parts by mass |
| BASF, IRGACURE 907) | |
| Chiral agent A shown above | 4.48 parts by mass |
| Methyl ethyl ketone | 290 parts by mass |
| Cyclohexanone | 50 parts by mass |

Disk-like liquid crystal compound (A) 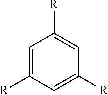 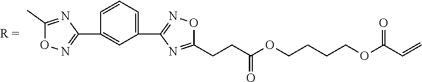 [SMILES: C=CC(=O)OCCCCOC(=O)CCc1nc(-c2cccc(-c3noc(C)n3)c2)no1]
Disk-like liquid crystal compound (B) 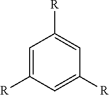 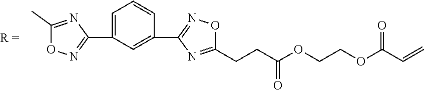 [SMILES: C=CC(=O)OCCOC(=O)CCc1nc(-c2cccc(-c3noc(C)n3)c2)no1]
Polymerizable monomer E1 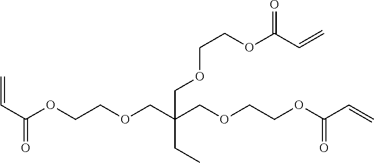 [SMILES: C=CC(=O)OCCOCC(CC)(COCCOC(=O)C=C)COCCOC(=O)C=C]
Surfactant F4

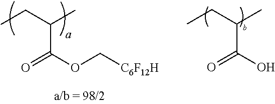

### <Coating Liquid D-2 to D-4 for Reflective Layer>

Coating liquid D-2 to D-4 for a reflective layer were prepared in the same manner as in the coating liquid D-1 for a reflective layer, except that the amount of the chiral agent A added was changed as shown in Table 2.

### <<Amount of Chiral Agent in Coating Liquid Containing Disk-Like Liquid Crystal Compound>>

TABLE 2

| | Amount of chiral amount |
|---|---|
| Coating liquid name | (part by mass) |
| Liquid D-1 | 4.48 |
| Liquid D-2 | 5.31 |

### [Production of Circularly Reflective Polarizer 1]

A polyethylene terephthalate (PET) film (A4100 manufactured by Toyobo Co., Ltd.) having a thickness of 50 μm was prepared as a temporary support. The PET film had an easy adhesion layer on one surface.

A surface of the PET film, which was not provided with the easy adhesion layer, was subjected to a rubbing treatment, coated with the coating liquid R-1 for a reflective layer prepared above using a wire bar coater, and dried at 110° C. for 120 seconds. Thereafter, the surface was irradiated with light using a metal halide lamp at 100° C., an illuminance of 80 mW/cm², and an irradiation amount of 500 mJ/cm² in a low oxygen atmosphere (100 ppm or less), thereby curing the coating liquid to form a yellow light reflecting layer (first light reflecting layer) consisting of a cholesteric liquid crystal layer. The irradiation with light was performed from the side of the cholesteric liquid crystal layer in all cases. Here, the coating thickness was adjusted so that the film thickness of the cured yellow light reflecting layer was 2.5 μm.

Next, the surface of the yellow light reflecting layer was subjected to a corona treatment at a discharge amount of 150 W·min/m², and the surface subjected to the corona treatment was coated with the coating liquid D-1 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a green light reflecting layer (second light reflecting layer) on the yellow light reflecting layer. The irradiation with light was performed from the side of the cholesteric liquid crystal layer in all cases. Here, the coating thickness was adjusted so that the film thickness of the cured green light reflecting layer was 2.4 μm.

Next, the green light reflecting layer was coated with the coating liquid R-2 for a reflective layer using a wire bar coater and dried at 110° C. for 120 seconds. Thereafter, the surface was irradiated with light using a metal halide lamp at 100° C., an illuminance of 80 mW, and an irradiation amount of 500 mJ/cm² in a low oxygen atmosphere (100 ppm or less), thereby curing the coating liquid to form a red light reflecting layer (third light reflecting layer) on the green light reflecting layer. The irradiation with light was performed from the side of the cholesteric liquid crystal layer in all cases. Here, the coating thickness was adjusted so that the film thickness of the cured red light reflecting layer was 2.4 μm.

Next, the surface of the red light reflecting layer was subjected to a corona treatment at a discharge amount of 150 W·min/m², and the surface subjected to the corona treatment was coated with the coating liquid D-2 for a reflective layer using a wire bar coater. Subsequently, the coating film was dried at 70° C. for 2 minutes and heat-aged at 115° C. for 3 minutes after the solvent was vaporized, thereby obtaining a uniform alignment state. Thereafter, the coating film was kept at 45° C. and irradiated with ultraviolet rays (300 mJ/cm²) using a metal halide lamp in a nitrogen atmosphere, thereby curing the coating film to form a blue light reflecting layer (fourth light reflecting layer) on the red light reflecting layer. The irradiation with light was performed from the side of the cholesteric liquid crystal layer in all cases. Here, the coating thickness was adjusted so that the film thickness of the cured blue light reflecting layer was 2.6 μm.

In this manner, a circularly reflective polarizer 1 was produced. Coating liquids for a reflective layer used for producing the circularly reflective polarizer 1, the reflection center wavelength, and the film thickness are shown in Table 3.

TABLE 3

| | Type of | Reflection central | Film |
|---|---|---|---|
| | coating | wavelength | thickness |
| | liquid | (nm) | (μm) |
| Fourth layer | Liquid D-2 | 459 | 2.6 |
| Third layer | Liquid R-2 | 644 | 2.4 |
| Second layer | Liquid D-1 | 539 | 2.4 |
| First layer | Liquid R-1 | 576 | 2.5 |

### [Production of Laminated Optical Body 1]

The transfer of the circularly reflective polarizer 1 was carried out by the following procedure.

The obtained circularly reflective polarizer 1 was transferred to a surface side of an antireflection layer of a glass substrate forming the antireflection layer. In this case, the fourth light reflecting layer of the circularly reflective polarizer 1 was bonded with a pressure-sensitive adhesive layer such that the fourth light reflecting layer was on the glass substrate side, the layer (first light reflecting layer) on the temporary support side was exposed, and then the liquid crystal diffraction element 1 produced as described above was bonded through a pressure-sensitive adhesive layer. The liquid crystal diffraction element was once transferred to a temporary support having a pressure-sensitive adhesive layer, peeled off from a glass substrate and an alignment film, and bonded to the circularly reflective polarizer 1, and then the temporary support was peeled off to expose the liquid crystal diffraction element. Next, the antireflection film was bonded to the surface of the liquid crystal diffraction element 1 to obtain a laminated optical body 1.

### [Production of Optical Unit]

### [Formation of Half Mirror]

Aluminum was vapor-deposited on a side of the glass substrate forming the antireflection layer opposite to the antireflection layer to form a half mirror having a reflectivity of 40%.

The half mirror produced as described above was disposed to face the laminated optical body 1. The aluminum vapor-deposited surface of the half mirror was disposed on a side facing the laminated optical body 1. In addition, the laminated optical body 1 was disposed in the order of the half mirror, the circularly reflective polarizer 1, and the liquid crystal diffraction element 1, and the distance between the aluminum vapor-deposited surface and the liquid crystal diffraction element was set to 4 mm to produce an optical unit 1.

### Example 1

### <Production of Polarization Diffraction Element>

### (Formation of Alignment Film)

An alignment film P-1 was formed in the same manner as in Comparative Example 1.

### (Formation of Liquid Crystal Layer)

As a liquid crystal composition forming a first liquid crystal layer (first region), the following composition B-1 was prepared.

Composition B-1

| | |
|---|---|
| Liquid crystal compound L-1 | 10.00 parts by mass |
| Liquid crystal compound L-2 | 90.00 parts by mass |
| Chiral agent C3 | 0.25 parts by mass |
| Chiral agent C4 | 0.85 parts by mass |
| Polymerization initiator (manufactured by BASF, Irgacure OXE01) | 1.00 part by mass |
| Surfactant F1 | 0.30 parts by mass |
| Methyl ethyl ketone | 550.00 parts by mass |
| Cyclopentanone | 550.00 parts by mass |

Chiral agent C3 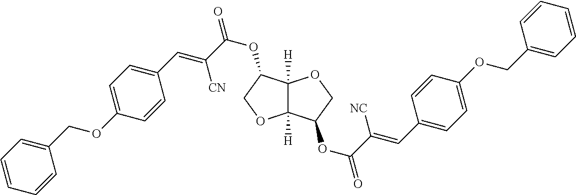 [SMILES: N#C/C(=C\c1ccc(OCc2ccccc2)cc1)C(=O)O[C@H]1CO[C@H]2[C@@H]1OC[C@H]2OC(=O)/C(C#N)=C/c1ccc(OCc2ccccc2)cc1]
Chiral agent C4

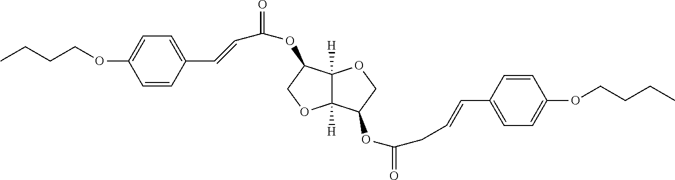 [SMILES: CCCCOc1ccc(/C=C/CC(=O)O[C@@H]2CO[C@H]3[C@@H]2OC[C@H]3OC(=O)/C=C/c2ccc(OCCCC)cc2)cc1]

A liquid crystal layer was formed by applying the composition B-1 onto the alignment film P-1 in multiple layers in the same manner as above.

First, in order to form the first layer, the composition B-1 was applied onto the alignment film P-1, the coating film was heated to 80° C. on a hot plate, and the coating film was irradiated with ultraviolet light having a wavelength of 365 nm using a LED-UV exposure device. At this time, the coating film was irradiated while changing the irradiation amount of ultraviolet rays in a plane. Specifically, the coating film was irradiated by changing the irradiation amount in the plane such that the irradiation amount increased from the center portion toward the end part.

Thereafter, the coating film was heated using a hot plate at 80° C., and then irradiated with ultraviolet rays having a wavelength of 365 nm at an irradiation amount of 300 mJ/cm² using a high-pressure mercury lamp in a nitrogen atmosphere. As a result, the alignment of the liquid crystal compound was fixed.

Regarding the second or subsequent layer, the composition was applied onto the liquid crystal immobilized layer, and heated, and cured with ultraviolet rays under the same conditions as described above to produce a liquid crystal immobilized layer. In this way, by repeating the application multiple times until the total thickness reached a desired film thickness, the liquid crystal layer was formed.

In the liquid crystal layer, Δn₅₅₀×thickness (Re(550)) of the liquid crystals was finally 150 nm, and it was confirmed using a polarization microscope that periodic alignment occurred on the surface.

In the liquid crystal alignment pattern of the liquid crystal layer, regarding a single period over which the optical axis of the liquid crystal compound rotated by 180°, a single period of a portion at a distance of 4 mm from the center was 1.74 μm; a single period of a portion at a distance of 15 mm from the center was 0.64 μm; a single period of a portion at a distance of 18 mm from the center was 0.59 μm; and the single period decreased toward the outer direction. In addition, in the liquid crystal layer, regarding the twisted angle of the liquid crystal compound in the thickness direction, the twisted angle at a position at a distance of 4 mm from the center was −83°, the twisted angle at a position at a distance of 15 mm from the center was −110°, and the twisted angle at a position at a distance of 18 mm from the center was −115°.

As a liquid crystal composition forming a second liquid crystal layer (second region), the following composition B-2 was prepared.

Composition B-2

| | | |
|---|---|---|
| Liquid crystal compound L-1 | 10.00 | parts by mass |
| Liquid crystal compound L-2 | 90.00 | parts by mass |
| Chiral agent C3 | 0.55 | parts by mass |
| Chiral agent C4 | 0.68 | parts by mass |
| Polymerization initiator (manufactured by | 1.00 | part by mass |
| BASF, Irgacure OXE01) | | |
| Surfactant F1 | 0.30 | parts by mass |
| Methyl ethyl ketone | 550.00 | parts by mass |
| Cyclopentanone | 550.00 | parts by mass |

Next, the second liquid crystal layer was formed by applying the composition B-2 onto the first liquid crystal layer in multiple layers.

The composition B-2 was applied onto the first liquid crystal layer, and the liquid crystal layer was formed by the same method as that of the first liquid crystal layer of Example 1, except that the irradiation amount of ultraviolet rays with which the coating film was irradiated changed from the center portion toward the end part (the irradiation amount increased from the center portion toward the end part) such that the total thickness was a desired film thickness.

Regarding the second or subsequent layer, the composition was applied onto the liquid crystal immobilized layer, and then subjected to the same operation under the above conditions to produce a liquid crystal immobilized layer. In this way, by repeating the application multiple times until the total thickness reached a desired film thickness, the second liquid crystal layer was formed.

In the liquid crystal layer, Δn₅₅₀×thickness (Re(550)) of the liquid crystals was finally 335 nm, and it was confirmed using a polarization microscope that periodic alignment occurred on the surface.

In the liquid crystal alignment pattern of the liquid crystal layer, regarding a single period over which the optical axis of the liquid crystal compound rotated by 180°, a single period of a portion at a distance of 4 mm from the center was 1.74 μm; a single period of a portion at a distance of 15 mm from the center was 0.64 μm; a single period of a portion at a distance of 18 mm from the center was 0.59 μm; and the single period decreased toward the outer direction. In addition, in the liquid crystal layer, regarding the twisted angle of the liquid crystal compound in the thickness direction, the twisted angle at a position at a distance of 4 mm from the center was −5°, the twisted angle at a position at a distance of 15 mm from the center was −75°, and the twisted angle at a position at a distance of 18 mm from the center was −85°.

As a liquid crystal composition forming a third liquid crystal layer (third region), the following composition B-3 was prepared.

Composition B-3

| | | |
|---|---|---|
| Liquid crystal compound L-1 | 10.00 | parts by mass |
| Liquid crystal compound L-2 | 90.00 | parts by mass |
| Chiral agent C3 | 0.50 | parts by mass |
| Polymerization initiator (manufactured by | 1.00 | part by mass |
| BASF, Irgacure OXE01) | | |
| Surfactant F1 | 0.30 | parts by mass |
| Methyl ethyl ketone | 550.00 | parts by mass |
| Cyclopentanone | 550.00 | parts by mass |

Next, the third liquid crystal layer was formed by applying the composition B-3 onto the second liquid crystal layer in multiple layers.

The composition B-3 was applied onto the second liquid crystal layer, and the liquid crystal layer was formed by the same method as that of the first region of Example 1, except that the irradiation amount of ultraviolet rays with which the coating film was irradiated changed from the center portion toward the end part (the irradiation amount increased from the center portion toward the end part) such that the total thickness was a desired film thickness.

Regarding the second or subsequent layer, the composition was applied onto the liquid crystal immobilized layer, and then subjected to the same operation under the above conditions to produce a liquid crystal immobilized layer. In this way, by repeating the application multiple times until the total thickness reached a desired film thickness, the third liquid crystal layer was formed to obtain a polarization diffraction element 2.

In the liquid crystal layer, Δn₅₅₀×thickness (Re(550)) of the liquid crystals was finally 170 nm, and it was confirmed using a polarization microscope that periodic alignment occurred on the surface.

In the liquid crystal alignment pattern of the liquid crystal layer, regarding a single period over which the optical axis of the liquid crystal compound rotated by 180°, a single period of a portion at a distance of 4 mm from the center was 1.74 km; a single period of a portion at a distance of 15 mm from the center was 0.64 km; a single period of a portion at a distance of 18 mm from the center was 0.59 km; and the single period decreased toward the outer direction. In addition, in the liquid crystal layer, regarding the twisted angle of the liquid crystal compound in the thickness direction, the twisted angle at a position at a distance of 4 mm from the center was 78°, the twisted angle at a position at a distance of 15 mm from the center was 45°, and the twisted angle at a position at a distance of 18 mm from the center was 40°.

In the formed first to third liquid crystal layers (first region to third region), the total value of the twisted angles of the liquid crystal compounds in the thickness direction was −10° at a distance of 4 mm from the center, −140° at a distance of 15 mm from the center, and −160° at a distance of 18 mm from the center.

### [Production of Laminated Optical Body 2]

A laminated optical body 2 was produced in the same manner as in the production of the laminated optical body 1 of Comparative Example 1, except that the polarization diffraction element 2 produced in Example 1 was used.

### [Production of Optical Unit]

An optical unit 2 was produced in the same manner as in the production of the optical unit 1 of Comparative Example 1, except that the laminated optical body 2 was used instead of the laminated optical body 1.

### <Production of Circularly Polarizing Plate>

### <<Production of λ/4 Plate 1>>

### (Production of Positive A-Plate 1)

A cellulose acylate film “Z-TAC”, including an alignment film and a liquid crystal layer, was obtained using the same method as a positive A-plate described in paragraphs 0102 to 0126 of JP2019-215416A.

The liquid crystal layer was a positive A-plate (phase difference plate) having reverse wavelength dispersibility, and a thickness of the positive A-plate was controlled such that Re(550) was set to 138 nm.

### (Production of Positive C-Plate 1)

A positive C-plate 1 was formed by applying the following composition QC-1 onto the positive A-plate produced as described above. The coating film was heated using a hot plate at 70° C., cooled to 65° C., and then irradiated with ultraviolet rays having a wavelength of 365 nm at an irradiation amount of 500 mJ/cm² using a high-pressure mercury lamp in a nitrogen atmosphere. As a result, the alignment of the liquid crystal compound was fixed. In this manner, a λ/4 plate 1 was obtained.

The obtained positive C-plate 1 had a thickness direction retardation Rth (550) of −69 nm.

Composition QC-1

| | |
|---|---|
| Liquid crystal compound L-1 | 34.00 parts by mass |
| Liquid crystal compound L-3 | 44.00 parts by mass |
| Liquid crystal compound L-4 | 22.00 parts by mass |
| Polymerization initiator PI-1 | 1.50 parts by mass |
| Surfactant T-2 | 0.40 parts by mass |
| Surfactant T-3 | 0.20 parts by mass |
| Compound S-1 | 0.50 parts by mass |
| Compound M-1 | 14.00 parts by mass |
| Methyl ethyl ketone | 248.00 parts by mass |

Liquid crystal compound L-3 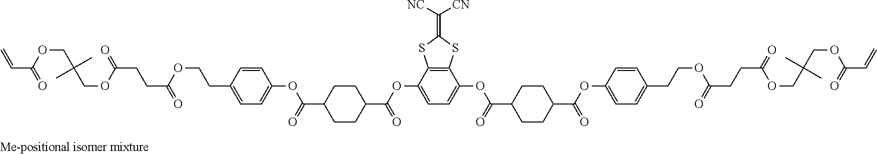 [SMILES: C=CC(=O)OCC(C)(C)COC(=O)CCC(=O)OCCc1ccc(OC(=O)C2CCC(C(=O)Oc3ccc(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]
Liquid crystal compound L-4 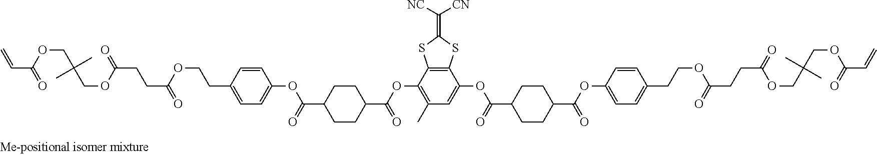 [SMILES: C=CC(=O)OCC(C)(C)COC(=O)CCC(=O)OCCc1ccc(OC(=O)C2CCC(C(=O)Oc3cc(C)c(OC(=O)C4CCC(C(=O)Oc5ccc(CCOC(=O)CCC(=O)OCC(C)(C)COC(=O)C=C)cc5)CC4)c4c3SC(=C(C#N)C#N)S4)CC2)cc1]
Surfactant T-2 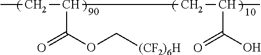
Surfactant T-3 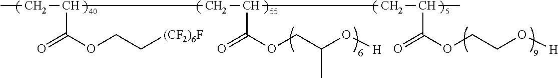
Compound S-1 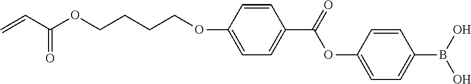 [SMILES: C=CC(=O)OCCCCOc1ccc(C(=O)Oc2ccc(B(O)O)cc2)cc1]
Compound M-1

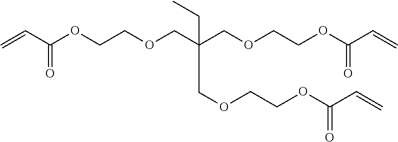 [SMILES: C=CC(=O)OCCOCC(CC)(COCCOC(=O)C=C)COCCOC(=O)C=C]

### <<Production of Linear Polarizer>>

### <<<Production of Cellulose Acylate Film 1>>>

### (Production of Core Layer Cellulose Acylate Dope)

The following composition was put into a mixing tank and stirred to dissolve each component, thereby preparing a cellulose acetate solution used as a core layer cellulose acylate dope.

Core layer cellulose acylate dope

| | |
|---|---|
| Cellulose acetate having acetyl substitution degree | 100 parts by mass |
| of 2.88 | |
| Polyester compound B described in Examples of | 12 parts by mass |
| JP2015-227955A | |
| Compound F shown below | 2 parts by mass |
| Methylene chloride (first solvent) | 430 parts by mass |
| Methanol (second solvent) | 64 parts by mass |

Compound F

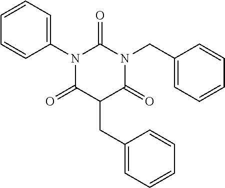 [SMILES: O=C1C(Cc2ccccc2)C(=O)N(c2ccccc2)C(=O)N1Cc1ccccc1]

### (Production of Outer Layer Cellulose Acylate Dope)

10 parts by mass of the following matting agent solution was added to 90 parts by mass of the above-described core layer cellulose acylate dope to prepare a cellulose acetate solution used as an outer layer cellulose acylate dope.

Matting agent solution

| | | |
|---|---|---|
| Silica particles having an average particle diameter | 2 | parts by mass |
| of 20 nm (AEROSIL R972, manufactured by | | |
| Nippon Aerosil Co., Ltd.) | | |
| Methylene chloride (first solvent) | 76 | parts by mass |
| Methanol (second solvent) | 11 | parts by mass |
| Core layer cellulose acylate dope described above | 1 | part by mass |

### (Production of Cellulose Acylate Film 1)

The core layer cellulose acylate dope and the outer layer cellulose acylate dope were filtered through filter paper having an average hole diameter of 34 μm and a sintered metal filter having an average pore size of 10 μm, and three layers which were the core layer cellulose acylate dope and the outer layer cellulose acylate dopes provided on both sides of the core layer cellulose acylate dope were simultaneously cast from a casting port onto a drum at 20° C. (band casting machine).

Next, the film was peeled off in a state where the solvent content was approximately 20% by mass, both ends of the film in the width direction were fixed by tenter clips, and the film was dried while being stretched at a stretching ratio of 1.1 times in the lateral direction.

Thereafter, the film was further dried by being transported between the rolls of the heat treatment device to prepare an optical film having a thickness of 40 μm, and the optical film was used as a cellulose acylate film 1. The in-plane retardation of the obtained cellulose acylate film 1 was 0 nm.

### <Formation of Photoalignment Layer PA1>

The cellulose acylate film 1 was continuously coated with a coating liquid S-PA-1 for forming an alignment layer described below with a wire bar. The support on which the coating film was formed was dried with hot air at 140° C. for 120 seconds, and the coating film was irradiated with polarized ultraviolet rays (10 mJ/cm², using an ultra-high pressure mercury lamp) to form a photoalignment layer PAL. A film thickness thereof was 0.3 μm.

(Coating liquid S-PA-1 for forming alignment layer)

| | |
|---|---|
| Polymer M-PA-1 shown below | 100.00 parts by mass |
| Acid generator PAG-1 shown below | 5.00 parts by mass |
| Acid generator CPI-110F shown below | 0.005 parts by mass |
| Xylene | 1220.00 parts by mass |
| Methyl isobutyl ketone | 122.00 parts by mass |

Polymer M-PA-1 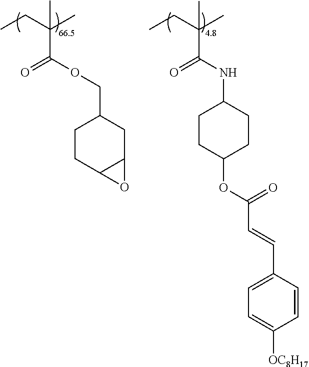 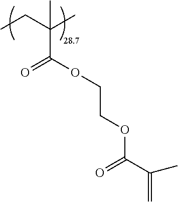
Acid generator PAG-1 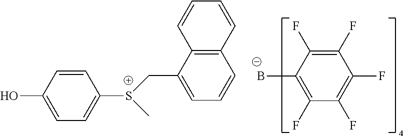
Acid generator CPI-110F

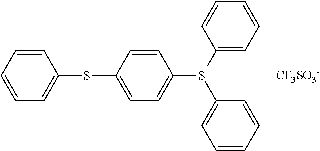

### <Formation of Light Absorption Anisotropic Layer P1>

The obtained alignment layer PA1 was continuously coated with the following coating liquid S-P-1 for forming a light absorption anisotropic layer with a wire bar. Next, the coating layer P1 was heated at 140° C. for 30 seconds and cooled to room temperature (23° C.). Next, the coating layer P1 was heated at 90° C. for 60 seconds and cooled to room temperature again. Thereafter, the coating layer P1 was irradiated with an LED lamp (central wavelength of 365 nm) for 2 seconds under an irradiation condition of an illuminance of 200 mW/cm², thereby forming a light absorption anisotropic layer P1 on the alignment layer PA1. A film thickness thereof was 1.6 μm.

Composition of coating liquid S-P-1 for forming light absorption anisotropic layer

| | |
|---|---|
| Dichroic substance D-1 shown below | 0.25 parts by mass |
| Dichroic substance D-2 shown below | 0.36 parts by mass |
| Dichroic substance D-3 shown below | 0.59 parts by mass |
| Polymer liquid crystal compound M-P-1 shown below | 2.21 parts by mass |
| Low-molecular-weight liquid crystal compound M-1 | 1.36 parts by mass |
| Polymerization initiator (IRGACURE OXE 02 (manufactured by BASF)) | 0.200 parts by mass |
| Surfactant FP-1 shown below | 0.026 parts by mass |
| Cyclopentanone | 46.00 parts by mass |
| Tetrahydrofuran | 46.00 parts by mass |
| Benzyl alcohol | 3.00 parts by mass |

Dichroic substance D-1 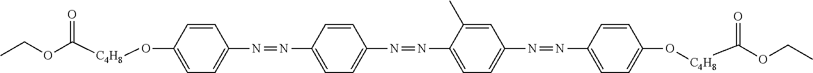
Dichroic substance D-2 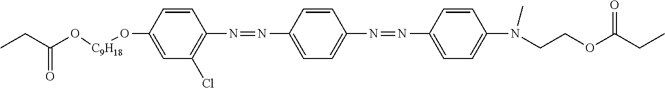
Dichroic substance D-3 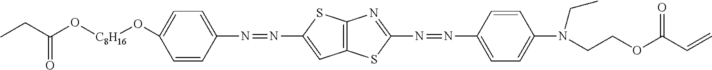
Polymer liquid crystal compound M-P-1 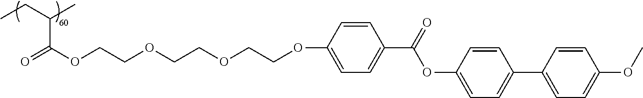 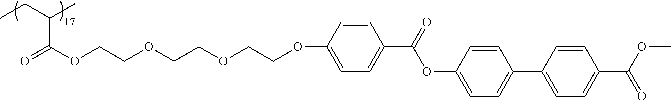 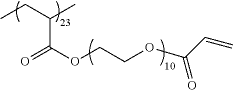
Low-molecular-weight liquid crystal compound M-1 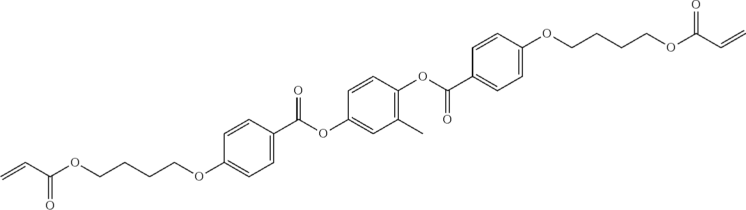 [SMILES: C=CC(=O)OCCCCOc1ccc(C(=O)Oc2ccc(OC(=O)c3ccc(OCCCCOC(=O)C=C)cc3)c(C)c2)cc1]
Surfactant FP-1

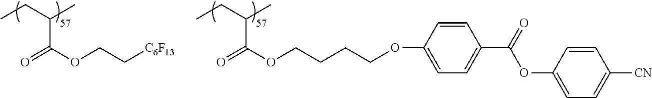

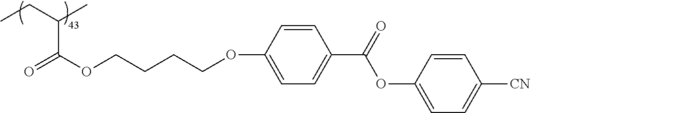

The produced λ/4 plate 1 and the linear polarizer were laminated to obtain a circularly polarizing plate 1. In this case, the λ/4 plate 1 and the light absorption anisotropic layer P1 were laminated such that the slow axis of the λ/4 plate 1 and the absorption axis of the light absorption anisotropic layer P1 formed an angle of 45°.

### [Evaluation]

The circularly polarizing plate 1 and the optical unit produced as described above were arranged to face each other, and evaluation was performed.

The circularly polarizing plate 1 and the optical unit were disposed in the order of the circularly polarizing plate 1 (linear polarizer and λ/4 plate 1) and the optical unit (half mirror, circularly reflective polarizer 1, and liquid crystal diffraction element). In addition, the evaluation was performed by disposing the linear polarizer of the circularly polarizing plate 1 and the liquid crystal diffraction element of the optical unit such that the distance therebetween was 7 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, the circularly reflective polarizer, and the like) from the center of the concentric circle of the liquid crystal diffraction element.

At a position of 3 mm in the circularly polarizing plate 1, a laser (wavelength: 532 nm) was incident at an incidence angle of −2.7°, a photodetector was disposed at a position 15 mm away from the optical unit, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively.

At a position of 3 mm in the circularly polarizing plate 1, light in which a laser (wavelength: 532 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light emitted from the optical unit 1 produced in Comparative Example 1 and the optical unit 2 produced in Example 1 were substantially the same.

On the other hand, in a case where light was incident on the circularly polarizing plate from the position of 13 mm and the position of 16 mm, the amount of light emitted from the optical unit 2 of Example 1 was increased with respect to the optical unit 1 of Comparative Example 1.

### [Production of Virtual Reality Display Device]

A virtual reality display device “Huawei VR Glass” manufactured by Huawei Technologies Co., Ltd., which was a virtual reality display device for which a reciprocating optical system was employed, was disassembled, and all composite lenses were taken out. The circularly polarizing plate 1 produced as described above was bonded to a display of “Huawei VR Glass” (laminated in the order of display, linear polarizer, and λ/4 plate 1).

Next, a virtual reality display device of Comparative Example 1 was produced by installing the optical unit 1 on the front surface (half mirror was disposed on the circularly polarizing plate side). In this case, the linear polarizer of the circularly polarizing plate 1 and the liquid crystal diffraction element of the optical unit are arranged such that the distance therebetween was 7 mm. A virtual reality display device of Example 1 was produced in the same manner as in the production of the virtual reality display device of Comparative Example 1, except that the optical unit 1 was changed to the optical unit 2 produced in Example 1. In the produced virtual reality display device, a green-black checker pattern was displayed on the image display panel, and distribution of the brightness of the display was visually evaluated. In the virtual reality display device of Comparative Example 1, green display of the peripheral portion was dark with respect to the center of the display image. On the other hand, in the virtual reality display device of Example 1, the brightness of green display in the peripheral portion was improved as compared with Comparative Example 1, and the distribution of the brightness of the display image (viewing angle dependence) was improved.

### Comparative Example 2

### [Production of Laminated Optical Body 3]

A wideband dielectric multi-layer film (APF manufactured by 3M Company) was used as a linear polarization-type reflective polarizer. The λ/4 plate 1 produced as described above was bonded to both surfaces of the linear polarization-type reflective polarizer. In this case, the bonding was performed in the order of the positive C-plate 1, the positive A-plate 1, the linear polarization-type reflective polarizer, the positive A-plate 1, and the positive C-plate 1.

Thereafter, the polarization diffraction element 1 produced in Comparative Example 1 was bonded to the positive C-plate 1 with a pressure-sensitive adhesive layer being interposed therebetween. The liquid crystal diffraction element was once transferred to a temporary support having a pressure-sensitive adhesive layer, peeled off from a glass substrate and an alignment film, and bonded to the positive C-plate 1, and then the temporary support was peeled off to expose the liquid crystal diffraction element. Next, the antireflection film was bonded to the surface of the liquid crystal diffraction element to obtain a laminated optical body 3.

### [Production of Optical Unit]

The half mirror produced in Comparative Example 1 was disposed to face the laminated optical body 3. The aluminum vapor-deposited surface of the half mirror was disposed on a side facing the laminated optical body. In addition, the laminated optical body 3 was disposed in the order of the half mirror, the λ/4 plate 1, the linear polarization-type reflective polarizer, λ/4 plate 1, and the liquid crystal diffraction element, and the distance between the aluminum vapor-deposited surface and the liquid crystal diffraction element was set to 4 mm to produce an optical unit 3.

### Example 2

### [Production of Laminated Optical Body 4]

A laminated optical body 4 was produced in the same manner as in the production of the laminated optical body 3 of Comparative Example 2, except that the polarization diffraction element 2 produced in Example 1 was used.

### [Production of Optical Unit]

An optical unit 4 was produced in the same manner as in the production of the optical unit 3 of Comparative Example 2, except that the laminated optical body 4 was used instead of the laminated optical body 3.

### [Evaluation]

The circularly polarizing plate 1 and the optical unit produced as described above were arranged to face each other, and evaluation was performed.

The circularly polarizing plate 1 and the optical unit were disposed in the order of the circularly polarizing plate 1 (linear polarizer and λ/4 plate 1) and the optical unit (half mirror, λ/4 plate 1, linear polarization-type reflective polarizer, λ/4 plate 1, and liquid crystal diffraction element). In addition, the evaluation was performed by disposing the linear polarizer of the circularly polarizing plate 1 and the liquid crystal diffraction element of the optical unit such that the distance therebetween was 7 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, the circularly reflective polarizer, and the like) from the center of the concentric circle of the liquid crystal diffraction element.

At a position of 3 mm in the circularly polarizing plate 1, a laser (wavelength: 532 nm) was incident at an incidence angle of −2.7°, a photodetector was disposed at a position 15 mm away from the optical unit, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light emitted from the optical unit 3 produced in Comparative Example 2 and the optical unit 4 produced in Example 2 were substantially the same.

On the other hand, in a case where light was incident on the circularly polarizing plate from the position of 13 mm and the position of 16 mm, the amount of light emitted from the optical unit 4 of Example 2 was increased with respect to the optical unit 3 of Comparative Example 2.

### [Production of Virtual Reality Display Device]

A virtual reality display device of Comparative Example 2 was produced in the same manner as in the production of the virtual reality display device of Comparative Example 1, except that the optical unit 1 was changed to the optical unit 3 produced in Comparative Example 2. A virtual reality display device of Example 2 was produced using the optical unit 4 in the same manner.

In the produced virtual reality display device, a green-black checker pattern was displayed on the image display panel, and distribution of the brightness of the display was visually evaluated.

In the virtual reality display device of Comparative Example 2, green display of the peripheral portion was dark with respect to the center of the display image. On the other hand, in the virtual reality display device of Example 2, the brightness of green display in the peripheral portion was improved as compared with Comparative Example 2, and the distribution of the brightness of the display image (viewing angle dependence) was improved.

### Example 3

### [Production of Laminated Optical Body 5]

A laminated optical body 5 was obtained in the same manner as in the production of the laminated optical body 2 of Example 1, except that the liquid crystal diffraction element was bonded to the reflective polarizer 1, and then the circularly polarizing plate 1 and the antireflection film were bonded in this order to the exposed surface of the liquid crystal diffraction element. The circularly polarizing plate 1 was laminated in the order of the liquid crystal diffraction element, the λ/4 plate 1, and the linear polarizer.

### [Production of Optical Unit]

An optical unit 5 was produced in the same manner as in the production of the optical unit 2 of Example 1, except that the laminated optical body 5 was used instead of the laminated optical body 2.

### [Evaluation]

The circularly polarizing plate 1 and the optical unit 5 produced as described above were arranged to face each other, and evaluation was performed. The circularly polarizing plate 1 and the optical unit were disposed in the order of the circularly polarizing plate 1 (linear polarizer and λ/4 plate 1) and the optical unit (half mirror, circularly reflective polarizer 1, liquid crystal diffraction element, λ/4 plate 1, and linear polarizer). In addition, the evaluation was performed by disposing the linear polarizer of the circularly polarizing plate 1 and the liquid crystal diffraction element of the optical unit such that the distance therebetween was 7 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, the circularly reflective polarizer, and the like) from the center of the concentric circle of the liquid crystal diffraction element.

At a position of 3 mm in the circularly polarizing plate 1, a laser (wavelength: 532 nm) was incident at an incidence angle of −2.7°, a photodetector was disposed at a position 15 mm away from the optical unit, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light emitted from the optical unit 1 produced in Comparative Example 1 and the optical unit 5 produced in Example 3 were substantially the same. On the other hand, in a case where light was incident on the circularly polarizing plate from the position of 13 mm and the position of 16 mm, the amount of light emitted from the optical unit 5 of Example 3 was increased with respect to the optical unit 1 of Comparative Example 1.

### [Production of Virtual Reality Display Device]

A virtual reality display device of Example 3 was produced in the same manner as in the production of the virtual reality display device of Comparative Example 1, except that the optical unit 1 was changed to the optical unit 5 produced in Example 3. In the produced virtual reality display device, a green-black checker pattern was displayed on the image display panel, and distribution of the brightness of the display was visually evaluated. In the virtual reality display device of Comparative Example 1, green display of the peripheral portion was dark with respect to the center of the display image. On the other hand, in the virtual reality display device of Example 3, the brightness of green display in the peripheral portion was improved as compared with Comparative Example 1, and the distribution of the brightness of the display image (viewing angle dependence) was improved.

In addition, in the produced virtual reality display device, a green-black checker pattern was displayed on the image display panel, and visibility of ghost was visually evaluated. In the virtual reality display device of Example 1, a slight ghost image was visually recognized, but in the virtual reality display device of Example 3, the ghost image was reduced and the visibility of ghost was improved.

### Example 4

### [Production of Positive C-Plate 2]

A positive C-plate 2 was produced by adjusting the film thickness with reference to the method described in paragraphs 0132 to 0134 of JP2016-053709A.

Re of the positive C-plate 2 was 0.2 nm and Rth thereof was −306 nm.

### [Production of Retardation Layer 2]

A retardation layer 2 having reverse dispersibility was produced with reference to the method described in paragraphs 0151 to 0163 of JP2020-084070A.

Re of the retardation layer 2 was 138 nm and Rth thereof was 69 nm. AxoScan OPMF-1 (manufactured by Opto Science, Inc.) was used for the evaluation of the phase difference.

### [Production of Laminated Optical Body 6]

The transfer of the circularly reflective polarizer 1 was carried out by the following procedure. The obtained circularly reflective polarizer 1 was transferred to a support side of the obtained positive C-plate 2. In this case, the circularly reflective polarizer 1 was once transferred to a temporary support having a pressure-sensitive adhesive layer to expose the layer on the temporary support side and then bonded to the positive C-plate 2, such that the layer on the temporary support side (first light reflecting layer) was the positive C-plate 2 side. The temporary support of the circularly reflective polarizer 1 was peeled off and removed after the bonding. The obtained retardation layer 2 was bonded to the obtained positive C-plate 2 on a side opposite to the support. Next, the light absorption anisotropic layer P1 was transferred. In this case, the light absorption anisotropic layer P1 was transferred such that a layer on a side opposite to the temporary support was on the retardation layer 2 side. The temporary support of the light absorption anisotropic layer P1 was peeled off and removed after the transfer. The transfer of the light absorption anisotropic layer P1 was performed by the following procedure.
(1) A UV adhesive Chemi-seal U2084B (manufactured by ChemiTech Inc., refractive index n after curing: 1.60) was applied onto the positive C-plate 2 on the support side using a wire bar coater such that the thickness was set to 2 μm; the light absorption anisotropic layer P1 was laminated thereon with a laminator such that the side opposite to the temporary support was in contact with the UV adhesive.
(2) After nitrogen purging until the oxygen concentration reached 100 ppm or less in a purge box, the light absorption anisotropic layer P1 was cured by being irradiated with ultraviolet rays using a high-pressure mercury lamp from the temporary support side; the illuminance was 25 mW/cm² and the irradiation amount was 1,000 mJ/cm².
(3) Finally, the temporary support of the light absorption anisotropic layer P1 was peeled off.

Here, the retardation layer 2 and the light absorption anisotropic layer P1 were laminated such that the slow axis of the retardation layer 2 and the absorption axis of the light absorption anisotropic layer P1 formed an angle of 45°. Finally, the support of the positive C-plate 2 was peeled off. Next, the λ/4 plate 1 and the polarization diffraction element 2 produced in Example 1 were bonded to the light absorption anisotropic layer P1. The λ/4 plate 1 was laminated in the order of the light absorption anisotropic layer P1, the positive A-plate 1, the positive C-plate 1, and the liquid crystal diffraction element 2. The polarization diffraction element 2 was once transferred to a temporary support having a pressure-sensitive adhesive layer, peeled off from a glass substrate and an alignment film, and bonded to the positive C-plate 1, and then the temporary support was peeled off to expose the liquid crystal diffraction element. Next, the antireflection film was bonded to the surface of the liquid crystal diffraction element 2 to obtain a laminated optical body 6.

### [Production of Optical Unit]

An optical unit 6 was produced in the same manner as in the production of the optical unit 2 of Example 1, except that the laminated optical body 6 was used instead of the laminated optical body 2.

### [Evaluation]

The circularly polarizing plate 1 and the optical unit 6 produced as described above were arranged to face each other, and evaluation was performed.

The circularly polarizing plate 1 and the optical unit were disposed in the order of the circularly polarizing plate 1 (linear polarizer and λ/4 plate 1) and the optical unit (half mirror, circularly reflective polarizer 1, positive C-plate 2, retardation layer 2, linear polarizer, λ/4 plate 1, and liquid crystal diffraction element). In addition, the evaluation was performed by disposing the linear polarizer of the circularly polarizing plate 1 and the liquid crystal diffraction element of the optical unit such that the distance therebetween was 7 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, the circularly reflective polarizer, and the like) from the center of the concentric circle of the liquid crystal diffraction element.

At a position of 3 mm in the circularly polarizing plate 1, a laser (wavelength: 532 nm) was incident at an incidence angle of −2.7°, a photodetector was disposed at a position 15 mm away from the optical unit, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light emitted from the optical unit 1 produced in Comparative Example 1 and the optical unit 6 produced in Example 4 were substantially the same.

On the other hand, in a case where light was incident on the circularly polarizing plate from the position of 13 mm and the position of 16 mm, the amount of light emitted from the optical unit 6 of Example 4 was increased with respect to the optical unit 1 of Comparative Example 1.

### [Production of Virtual Reality Display Device]

A virtual reality display device of Example 4 was produced in the same manner as in the production of the virtual reality display device of Comparative Example 1, except that the optical unit 1 was changed to the optical unit 6 produced in Example 4. In the produced virtual reality display device, a green-black checker pattern was displayed on the image display panel, and distribution of the brightness of the display was visually evaluated. In the virtual reality display device of Comparative Example 1, green display of the peripheral portion was dark with respect to the center of the display image. On the other hand, in the virtual reality display device of Example 4, the brightness of green display in the peripheral portion was improved as compared with Comparative Example 1, and the distribution of the brightness of the display image (viewing angle dependence) was improved.

In addition, in the produced virtual reality display device, a green-black checker pattern was displayed on the image display panel, and visibility of ghost was visually evaluated. In the virtual reality display device of Example 1, a slight ghost image was visually recognized, but in the virtual reality display device of Example 4, the ghost image was reduced and the visibility of ghost was improved.

### Example 5

### [Production of Laminated Optical Body 7]

A laminated optical body 7 was obtained in the same manner as in the production of the laminated optical body 6 of Example 4, except that the liquid crystal diffraction element was bonded to the reflective polarizer 1, and then the circularly polarizing plate 1 and the antireflection film were bonded in this order to the exposed surface of the liquid crystal diffraction element. The circularly polarizing plate 1 was carried out by laminating the liquid crystal diffraction element and the circularly polarizing plate 1 (λ/4 plate 1 and linear polarizer) in this order.

### [Production of Optical Unit]

An optical unit 7 was produced in the same manner as in the production of the optical unit 2 of Example 1, except that the laminated optical body 7 was used instead of the laminated optical body 2.

### [Evaluation]

The circularly polarizing plate 1 and the optical unit 7 produced as described above were arranged to face each other, and evaluation was performed. The circularly polarizing plate 1 and the optical unit were disposed in the order of the circularly polarizing plate 1 (linear polarizer and λ/4 plate 1) and the optical unit (half mirror, circularly reflective polarizer 1, positive C-plate 2, retardation layer 2, linear polarizer, λ/4 plate 1, liquid crystal diffraction element, λ/4 plate 1, and linear polarizer). In addition, the evaluation was performed by disposing the linear polarizer of the circularly polarizing plate 1 and the liquid crystal diffraction element of the optical unit such that the distance therebetween was 7 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, the circularly reflective polarizer, and the like) from the center of the concentric circle of the liquid crystal diffraction element.

At a position of 3 mm in the circularly polarizing plate 1, a laser (wavelength: 532 nm) was incident at an incidence angle of −2.7°, a photodetector was disposed at a position 15 mm away from the optical unit, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light emitted from the optical unit 1 produced in Comparative Example 1 and the optical unit 7 produced in Example 5 were substantially the same.

On the other hand, in a case where light was incident on the circularly polarizing plate from the position of 13 mm and the position of 16 mm, the amount of light emitted from the optical unit 7 of Example 5 was increased with respect to the optical unit 1 of Comparative Example 1.

### [Production of Virtual Reality Display Device]

A virtual reality display device of Example 5 was produced in the same manner as in the production of the virtual reality display device of Comparative Example 1, except that the optical unit 1 was changed to the optical unit 7 produced in Example 5. In the produced virtual reality display device, a green-black checker pattern was displayed on the image display panel, and distribution of the brightness of the display was visually evaluated.

In the virtual reality display device of Comparative Example 1, green display of the peripheral portion was dark with respect to the center of the display image. On the other hand, in the virtual reality display device of Example 5, the brightness of green display in the peripheral portion was improved as compared with Comparative Example 1, and the distribution of the brightness of the display image (viewing angle dependence) was improved.

In addition, in the produced virtual reality display device, a green-black checker pattern was displayed on the image display panel, and visibility of ghost was visually evaluated. In the virtual reality display device of Example 1, a slight ghost image was visually recognized, but in the virtual reality display device of Example 5, the ghost image was reduced and the visibility of ghost was improved. The virtual reality display device of Example 5 had the most reduced visibility of ghost as compared to the virtual reality display devices of Examples 3 and 4.

### Example 6

### [Production of Laminated Optical Body 8]

A laminated optical body 8 was obtained in the same manner as in the production of the laminated optical body 4 of Example 2, except that the liquid crystal diffraction element was bonded to the positive C-plate 1, and then the circularly polarizing plate 1 and the antireflection film were bonded in this order to the exposed surface of the liquid crystal diffraction element. The circularly polarizing plate 1 was laminated in the order of the liquid crystal diffraction element, the λ/4 plate 1, and the linear polarizer.

### [Production of Optical Unit]

An optical unit 8 was produced in the same manner as in the production of the optical unit 4 of Example 2, except that the laminated optical body 8 was used instead of the laminated optical body 4.

### [Evaluation]

The circularly polarizing plate 1 and the optical unit 8 produced as described above were arranged to face each other, and evaluation was performed. The circularly polarizing plate 1 and the optical unit were disposed in the order of the circularly polarizing plate 1 (linear polarizer and λ/4 plate 1) and the optical unit (half mirror, λ/4 plate 1, linear polarization-type reflective polarizer, λ/4 plate 1, liquid crystal diffraction element, λ/4 plate 1, and linear polarizer). In addition, the evaluation was performed by disposing the linear polarizer of the circularly polarizing plate 1 and the liquid crystal diffraction element of the optical unit such that the distance therebetween was 7 mm and allowing light to be incident from the side of the linear polarizer.

In a case where light was incident into the circularly polarizing plate, intensity of light emitted from the optical unit was evaluated. The in-plane position of each element was set to 0 mm in the plane of each element at the intersection of the normal direction and each element (the linear polarizer, the λ/4 plate, the half mirror, the circularly reflective polarizer, and the like) from the center of the concentric circle of the liquid crystal diffraction element.

At a position of 3 mm in the circularly polarizing plate 1, a laser (wavelength: 532 nm) was incident at an incidence angle of −2.7°, a photodetector was disposed at a position 15 mm away from the optical unit, and the intensity of light emitted from the optical unit was measured. Similarly, at a position of 13 mm in the circularly polarizing plate 1 and at a position of 16 mm in the circularly polarizing plate 1, the intensity of light emitted from the optical unit was measured in a case where a laser (wavelength: 532 nm) was incident at an incidence angle of −7.4° and an incidence angle of −8°, respectively. At a position of 3 mm in the circularly polarizing plate 1, light in which a laser (wavelength: 532 nm) was incident at an incidence angle of −2.7° was emitted from the optical unit at a position of 4 mm and an emission angle of 15°. In addition, at a position of 13 mm in the circularly polarizing plate 1, light in which a laser (wavelength: 532 nm) was incident at an incidence angle of −7.4° was emitted from the optical unit at a position of 15 mm and an emission angle of 45°, and light incident at an incidence angle of −8° at a position of 16 mm was emitted from the optical unit at a position of 18 mm and an emission angle of 50°.

In a case where light was incident on the circularly polarizing plate from the position of 3 mm, the amounts of light emitted from the optical unit 3 produced in Comparative Example 2 and the optical unit 8 produced in Example 6 were substantially the same.

On the other hand, in a case where light was incident on the circularly polarizing plate from the position of 13 mm and the position of 16 mm, the amount of light emitted from the optical unit 8 of Example 6 was increased with respect to the optical unit 3 of Comparative Example 2.

### [Production of Virtual Reality Display Device]

A virtual reality display device of Example 6 was produced in the same manner as in the production of the virtual reality display device of Comparative Example 2, except that the optical unit 3 was changed to the optical unit 8 produced in Example 6.

In the produced virtual reality display device, a green-black checker pattern was displayed on the image display panel, and distribution of the brightness of the display was visually evaluated. In the virtual reality display device of Comparative Example 2, green display of the peripheral portion was dark with respect to the center of the display image. On the other hand, in the virtual reality display device of Example 6, the brightness of green display in the peripheral portion was improved as compared with Comparative Example 2, and the distribution of the brightness of the display image (viewing angle dependence) was improved.

In addition, in the produced virtual reality display device, a green-black checker pattern was displayed on the image display panel, and visibility of ghost was visually evaluated. In the virtual reality display device of Example 2, a slight ghost image was visually recognized, but in the virtual reality display device of Example 6, the ghost image was reduced and the visibility of ghost was improved.

### Example 7

### <Production of Polarization Diffraction Element>

### (Exposure of Alignment Film)

An alignment film P-2 having a concentric circular liquid crystal alignment pattern was formed by the same method as that of the exposure of the alignment film using the exposure device shown in FIG. 10 in Comparative Example 1, except that the single period of the liquid crystal alignment pattern in a plane was changed by changing the lens 92.

### (Formation of Liquid Crystal Layer)

Using the alignment film P-2, the first liquid crystal layer to the third liquid crystal layer (the first region to the third region) were formed in the same manner as in Comparative Example 1, except that the film thickness and the addition amount of the chiral agent were adjusted during the formation of the liquid crystal layer, thereby producing a polarization diffraction element 3.

In the formed first liquid crystal layer (first region), Δn₅₅₀×thickness (Re(550)) of the liquid crystals was 160 nm, and it was confirmed using a polarization microscope that periodic alignment occurred on the surface. In addition, in the liquid crystal layer, a twisted angle of the liquid crystal compound in the thickness direction was −80°.

In the formed second liquid crystal layer (second region), Δn₅₅₀×thickness (Re(550)) of the liquid crystals was 330 nm, and it was confirmed using a polarization microscope that periodic alignment occurred on the surface. In addition, in the liquid crystal layer, a twisted angle of the liquid crystal compound in the thickness direction was 0°.

In the formed third liquid crystal layer (third region), Δn₅₅₀×thickness (Re(550)) of the liquid crystals was 160 nm, and it was confirmed using a polarization microscope that periodic alignment occurred on the surface. In addition, in the liquid crystal layer, a twisted angle of the liquid crystal compound in the thickness direction was 80°.

In the liquid crystal alignment pattern of the liquid crystal layer, regarding a single period over which the optical axis of the liquid crystal compound rotated by 180°, a single period of a portion at a distance of 3 mm from the center was 17.8 μm; a single period of a portion at a distance of 13 mm from the center was 4.1 μm; a single period of a portion at a distance of 16 mm from the center was 3.4 μm; and the single period decreased toward the outer direction.

In the production of the circularly polarizing plate 1, a circularly polarizing plate was produced by bonding the linear polarizer and the λ/4 plate 1 with a slow axis rotated by 90°, and the liquid crystal diffraction element 3 was bonded thereto to obtain a laminated optical body CG1. In the laminated optical body CG1, the liquid crystal diffraction element 3 functions as a divergent lens with respect to the incidence light from the λ/4 plate.

### [Evaluation]

In Example 7, the laminated optical body CG1 produced as described above and the optical unit 2 produced in Example 1 were arranged to face each other, and evaluation was performed. The laminated optical body CG1 and the optical unit were disposed in the order of the laminated optical body CG1 (linear polarizer, λ/4 plate 1, liquid crystal diffraction element 3) and the optical unit (half mirror, circularly reflective polarizer 1, and liquid crystal diffraction element 2). In addition, the evaluation was performed by disposing the linear polarizer of the laminated optical body CG1 and the liquid crystal diffraction element of the optical unit such that the distance therebetween was 7 mm and allowing light to be incident from the side of the linear polarizer.

### [Production of Virtual Reality Display Device]

A virtual reality display device “Huawei VR Glass” manufactured by Huawei Technologies Co., Ltd., which was a virtual reality display device for which a reciprocating optical system was employed, was disassembled, and all composite lenses were taken out.

The produced laminated optical body CG1 was bonded to a display of “Huawei VR Glass” (laminated in the order of display, linear polarizer, λ/4 plate 1, and liquid crystal diffraction element 3).

Next, a virtual reality display device of Example 7 was produced by installing the optical unit 2 produced in Example 1 on the front surface (half mirror was disposed on the liquid crystal diffraction element 3 side). In this case, the linear polarizer of the laminated optical body CG1 and the liquid crystal diffraction element of the optical unit 2 are arranged such that the distance therebetween was 7 mm.

In the produced virtual reality display device, a green-black checker pattern was displayed on the image display panel, and distribution of the brightness of the display was visually evaluated. In the virtual reality display device of Comparative Example 1, green display of the peripheral portion was dark with respect to the center of the display image. On the other hand, in the virtual reality display device of Example 7, the brightness of green display in the peripheral portion was improved as compared with Comparative Example 1, and the distribution of the brightness of the display image (viewing angle dependence) was improved. In addition, in the virtual reality display device of Example 7, the brightness of green display in the peripheral portion was further improved as compared with the virtual reality display device of Example 1, and the distribution of the brightness of the display image (viewing angle dependence) was further improved.

From the above results, the effect of the present invention is clear.

The present invention can be suitably used for a VR system or the like.

### EXPLANATION OF REFERENCES

10, 10A, 10B, 50, 100: image display system
12, 102: image display device
14: linear polarizer
16, 52, 108: λ/4 wavelength plate
18, 106: half mirror
20: circularly reflective polarizer
24, 24A: polarization diffraction element
32: substrate
34: alignment film
36, 36A: liquid crystal layer
36C: first liquid crystal layer
36D: second liquid crystal layer
36E: third liquid crystal layer
38: liquid crystal compound
42: bright portion
44: dark portion
46R, 46G: wavelength selective retardation layer
54: reflective polarizer
58: circular polarizer
60: optical element
80: exposure device
82: laser
84: light source
86: polarization beam splitter
90A, 90B: mirror
92: lens
94: beam splitter
96: λ/4 plate

What is claimed is:

1. An optical unit comprising, in the following order:
a first partial reflection element;
a second partial reflection element; and
a polarization diffraction element,
wherein the first partial reflection element and the second partial reflection element reflect a part of incidence light and allow transmission of a part of the incidence light,
the polarization diffraction element includes a liquid crystal layer formed of a liquid crystal composition containing a liquid crystal compound, and the liquid crystal layer has a liquid crystal alignment pattern in which an orientation of an optical axis derived from the liquid crystal compound changes while continuously rotating in at least one in-plane direction,
in the liquid crystal alignment pattern, in a case where a length over which the orientation of the optical axis derived from the liquid crystal compound rotates by 180° in a plane is set as a single period, the liquid crystal layer has regions having different lengths of the single periods in the plane, and
in the plane, the liquid crystal layer further has regions in which the optical axis derived from the liquid crystal compound is twisted and rotates in a thickness direction, and has regions having different total magnitudes of twisted angles in the thickness direction.

2. The optical unit according to claim 1,
wherein, in a region in which a length of the single period in the liquid crystal alignment pattern is shorter, the total magnitude of twisted angles in the thickness direction is larger.

3. The optical unit according to claim 1,
wherein the liquid crystal layer has a region in which a length of the single period in the liquid crystal alignment pattern is 0.6 μm or less.

4. The optical unit according to claim 1,
wherein the polarization diffraction element includes a plurality of the liquid crystal layers, and each of the liquid crystal layers diffracts polarized light in a specific wavelength range and does not diffract polarized light in a wavelength range different from the specific wavelength range.

5. The optical unit according to claim 4,
wherein the liquid crystal layer has regions where directions in which the liquid crystal layer is twisted and rotates in the thickness direction are different from each other.

6. The optical unit according to claim 4,
wherein the liquid crystal layer comprises a plurality of liquid crystal layers having different twisted angles in the thickness direction or different film thicknesses and being alternately laminated.

7. The optical unit according to claim 1,
wherein the polarization diffraction element is a transmissive polarization diffraction element.

8. The optical unit according to claim 4,
wherein the polarization diffraction element is a transmissive polarization diffraction element.

9. The optical unit according to claim 1,
wherein the polarization diffraction element includes a plurality of the liquid crystal layers, and further includes a wavelength selective retardation layer which is disposed between the liquid crystal layers.

10. The optical unit according to claim 1,
wherein at least one of the first partial reflection element or the second partial reflection element is a volume hologram.

11. The optical unit according to claim 1, further comprising:
a circular polarizer,
wherein the first partial reflection element, the second partial reflection element, the polarization diffraction element, and the circular polarizer are provided in this order.

12. The optical unit according to claim 1, further comprising:
an optical element,
wherein the optical element has a function of refracting incidence light and has regions having different refractive indices at different positions in a plane, and
the optical element, the first partial reflection element, the second partial reflection element, and the polarization diffraction element are provided in this order.

13. The optical unit according to claim 12,
wherein the optical element includes a liquid crystal layer formed of a liquid crystal composition containing a liquid crystal compound, and the liquid crystal layer has a liquid crystal alignment pattern in which an orientation of an optical axis derived from the liquid crystal compound changes while continuously rotating in at least one in-plane direction, and
in the liquid crystal alignment pattern, in a case where a length over which the orientation of the optical axis derived from the liquid crystal compound rotates by 180° in a plane is set as a single period, the liquid crystal layer has regions having different lengths of the single periods in the plane.

14. An image display system comprising:
the optical unit according to claim 1; and
an image display device.

15. The optical unit according to claim 2,
wherein the liquid crystal layer has a region in which a length of the single period in the liquid crystal alignment pattern is 0.6 μm or less.

16. The optical unit according to claim 2,
wherein the polarization diffraction element includes a plurality of the liquid crystal layers, and each of the liquid crystal layers diffracts polarized light in a specific wavelength range and does not diffract polarized light in a wavelength range different from the specific wavelength range.

17. The optical unit according to claim 2,
wherein the polarization diffraction element includes a plurality of the liquid crystal layers, and further includes a wavelength selective retardation layer which is disposed between the liquid crystal layers.

18. The optical unit according to claim 2,
wherein at least one of the first partial reflection element or the second partial reflection element is a volume hologram.

19. The optical unit according to claim 2, further comprising:
a circular polarizer,
wherein the first partial reflection element, the second partial reflection element, the polarization diffraction element, and the circular polarizer are provided in this order.

20. The optical unit according to claim 2, further comprising:
an optical element,
wherein the optical element has a function of refracting incidence light and has regions having different refractive indices at different positions in a plane, and
the optical element, the first partial reflection element, the second partial reflection element, and the polarization diffraction element are provided in this order.
